(19) United States
(12) Patent Application Publication
(10) Pub. No.: US 2026/0310574 A1
(43) Pub. Date: Oct. 8, 2026

(54) DEVICE TELEMETRY PROCESSING SYSTEM WITH PROBABILISTIC CLASSIFICATION AND PREDICTIVE HEALTH MODELING

(71) Applicant: Apkudo, Inc., Baltimore, MD (US)

(72) Inventor: Gary Bryan LANDSBERG, Las Vegas, NV (US)

(21) Appl. No.: 19/639,756

(22) Filed: Apr. 6, 2026

Related U.S. Application Data
(60) Provisional application No. 63/784,745, filed on Apr. 7, 2025.

(51) Int. Cl. G06F 11/34; G06N 3/0442; G06N 3/0464

(52) U.S. Cl. CPC G06F 11/3495; G06N 3/0442; G06N 3/0464

(57) ABSTRACT

Systems and methods for managing mobile device lifecycle data by collecting disparate data from external downstream sources and combining it with deep device-level data captured directly from individual devices including telemetry, hardware diagnostics, and physical access data. The combined data trains multiple machine learning models applied to individual and aggregate devices throughout the device lifecycle. A time-series analysis model processes device telemetry data to generate a cumulative stress score representing aggregated device wear, and a survival analysis model generates an estimated remaining life prediction, both stored in a device passport data structure linked to a device identifier. A probabilistic classifier with uncertainty scoring routes devices through bypass or standard processing pathways based on fault prediction confidence. A cross-modal reasoning engine employing multimodal large language models correlates diagnostic logs with device photographs to generate unified device condition assessments.

### CROSS-REFERENCE TO RELATED APPLICATIONS

This application claims priority to U.S. application Ser. No. 63/784,745, titled MACHINE LEARNING (ML) AND DATA ANALYTICS FOR MOBILE DEVICE PROCESSING AND CHANNEL ROUTING, filed Apr. 7, 2025, which is hereby incorporated by reference in its entirety.

### FIELD OF INVENTION

The present disclosure relates to machine learning systems for mobile device lifecycle management, and more particularly to systems and methods for training and utilizing machine learning models to analyze multi-modal device data from downstream sources to make intelligent decisions regarding repair, disposal, insurance eligibility, and channel routing for aftermarket mobile devices.

### BACKGROUND

The aftermarket mobile device industry encompasses the management of mobile devices that are no longer in their original sale condition, including refurbished, pre-owned, and recycled devices. This industry aims to extend the lifecycle of mobile devices, reduce electronic waste, and provide cost-effective alternatives to new devices. The industry relies on accurate assessment and classification of devices to determine their suitability for resale, insurance, recycling, and other downstream channels, so that each device may be utilized in an efficient and sustainable manner.

The lifecycle of a mobile device generates a vast amount of data from multiple downstream sources, presenting technical challenges in identifying, analyzing, and utilizing this information to make informed decisions. Data from repair vendors, trade-in programs, secondary markets, recycling facilities, and other points in the lifecycle are inherently diverse, ranging from structured numerical data, such as repair costs and trade-in values, to unstructured data, such as diagnostic logs and customer reviews, and even to image data, such as photographs of physical damage. The variability in data formats, completeness, and granularity across these sources makes it difficult to consolidate this information into a cohesive and usable framework.

Beyond the challenge of data integration, the technical complexities of analyzing multi-modal data further complicate decision-making. Each of the various types of data may require specialized processing methods, and extracting insights often necessitates advanced machine learning models tailored to specific data characteristics. For instance, identifying patterns in structured datasets may require statistical analysis or regression models, while processing unstructured text or images may involve natural language processing or convolutional neural networks. The presence of incomplete, inconsistent, or noisy data further adds to these challenges, requiring robust preprocessing and error-handling mechanisms.

Another technical hurdle lies in enabling models to learn from this data and adapt to its evolving and expansive nature, including across data domains. Devices change over time, with newer models introducing new features, components, and repair techniques that may not align with historical data. Further, market dynamics, such as shifts in consumer preferences, might introduce additional variability. Machine learning models benefit from being capable of handling large and complex datasets, while also adapting to remain relevant and accurate in their predictions.

Even after analyzing the data, the process of translating model outputs into actionable decisions presents its own set of challenges. Decisions, such as whether a device should be repaired, resold, or recycled, often involve weighing multiple competing factors, such as cost, environmental impact, and device condition. Existing systems frequently lack the sophistication to integrate these factors holistically or to provide interpretable and actionable recommendations, resulting in decisions that may not fully align with strategic or economic goals.

Accordingly, there is a general desire for improved systems and methods that address one or more of these challenges in the aftermarket mobile device industry.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for processing mobile device telemetry data is provided. The system comprises a processor and a memory storing instructions that, when executed by the processor, cause the processor to receive device telemetry data collected over a lifecycle of a mobile device. The processor processes the device telemetry data using a time-series analysis model configured to perform time-series telemetry analysis to generate a cumulative stress score representing an aggregated measure of device wear. The processor processes the device telemetry data using a survival analysis model to generate an estimated remaining life prediction indicating a probability of hardware failure over time. The processor stores the cumulative stress score and the estimated remaining life prediction in a device passport data structure linked to a device identifier of the mobile device.

According to other aspects of the present disclosure, the system may include one or more of the following features. The device identifier may comprise an International Mobile Equipment Identity (IMEI) identifier. The device telemetry data may comprise one or more of flash storage wear-leveling data, thermal cycle data, or battery impedance history. The time-series analysis model may comprise a Long Short-Term Memory (LSTM) network, and the survival analysis model may implement Cox Proportional Hazards modeling. The instructions may further cause the processor to process device photographs of the mobile device using a convolutional neural network (CNN) configured to detect surface defects comprising micro-abrasions and scratches, and to generate a cosmetic condition assessment based on the detected surface defects. The CNN may be configured to predict a probability that cosmetic restoration will elevate a device grade classification from a first grade to a second grade higher than the first grade. The device telemetry data may be received from a remote data collecting agent stored in local memory of the mobile device.

According to another aspect of the present disclosure, a computer-implemented method for predictive routing of mobile devices is provided. The method comprises extracting, upon intake of a mobile device, initial telemetry data from the mobile device, the initial telemetry data comprising low-level telemetry including kernel panic logs and voltage fluctuation data. The method comprises applying a probabilistic classifier to the initial telemetry data, the probabilistic classifier configured to generate uncertainty scores for fault predictions. The method comprises determining, based on the uncertainty scores, whether the mobile device has a high confidence classification of no fault found. Responsive to determining that the mobile device has the high confidence classification of no fault found, the method comprises routing the mobile device to a bypass processing pathway that bypasses a standard testing pipeline. Responsive to determining that the mobile device does not have the high confidence classification of no fault found, the method comprises routing the mobile device to the standard testing pipeline comprising triage, testing, and repair stages.

According to other aspects of the present disclosure, the method may include one or more of the following features. The bypass processing pathway may comprise a data wipe operation followed by a shipping operation, bypassing manual testing operations. Determining whether the mobile device has the high confidence classification may comprise comparing the uncertainty scores against a confidence threshold. The probabilistic classifier may comprise a Bayesian Neural Network that generates the uncertainty scores by performing multiple forward passes with different weight samples to estimate prediction variance. The initial telemetry data may further comprise chipset-level input/output registry data from device subsystem boards. The method may further comprise processing the initial telemetry data using an LSTM network to generate a cumulative stress score, and storing the cumulative stress score in a device passport data structure associated with the mobile device. The standard testing pipeline may comprise sequential stages of triaging the mobile device, wiping data from the mobile device, testing the mobile device, and repairing the mobile device.

According to another aspect of the present disclosure, a computer-implemented method for multi-modal device data analysis is provided. The method comprises receiving multi-modal device data for a mobile device, the multi-modal device data comprising structured telemetry data, diagnostic logs, and device photographs. The method comprises processing the multi-modal device data using an LLM-driven intelligence layer comprising a cross-modal reasoning engine. The method comprises correlating, using a multimodal large language model of the cross-modal reasoning engine, the diagnostic logs with the device photographs to identify relationships between functional issues indicated in the diagnostic logs and physical conditions visible in the device photographs. The method comprises generating a unified device condition assessment based on the correlation.

According to other aspects of the present disclosure, the method may include one or more of the following features. The method may further comprise receiving a natural language query through a natural language interrogation interface, and retrieving, based on the natural language query, a subset of device data from a consolidated device data repository. The LLM-driven intelligence layer may comprise LLM agents implementing a ReAct framework configured to perform autonomous actions based on data insights derived from the multi-modal device data. The autonomous actions may comprise one or more of updating a predictive model based on an identified trend in device failure data, generating a component procurement request based on predicted component failure rates, or modifying a device passport data structure template to adjust presentation of device health metrics for a subset of devices associated with the identified trend. The method may further comprise applying a Gradient Boosted Decision Trees model to device characteristic data and historical outcome data to generate device disposition forecasts for a plurality of downstream processing pathways, and applying a Deep Q-Network to the device disposition forecasts to generate a processing pathway classification for the mobile device. The method may further comprise processing the device photographs using a convolutional neural network to detect cosmetic defects, and generating a cosmetic condition score based on the detected cosmetic defects.

The foregoing general description of the illustrative embodiments and the following detailed description thereof are merely exemplary aspects of the teachings of this disclosure and are not restrictive.

### BRIEF DESCRIPTION OF FIGURES

The present technology is described in detail below with reference to the attached drawing figures, wherein:

FIG. 1 illustrates a block diagram of an example operating environment, according to aspects of the present disclosure;

FIG. 2 illustrates a flowchart of a method for training a device decision model, according to an embodiment;

FIG. 3 illustrates a flowchart of a method for using a trained device decision model, according to aspects of the present disclosure;

FIG. 4 illustrates a flowchart of a method for training a device decision model for insurance determination, according to an embodiment;

FIG. 5 illustrates a flowchart of a method for using a trained device decision model for insurance determination, according to aspects of the present disclosure;

FIG. 6 illustrates a block diagram of a device passport structure for processing mobile device lifecycle telemetry data, according to an embodiment;

FIG. 7 illustrates a flowchart of a method for skip-logic predictive routing of aftermarket mobile devices, according to aspects of the present disclosure;

FIG. 8 illustrates a flowchart of a method for dynamic channel selection for aftermarket mobile devices, according to an embodiment;

FIG. 9 illustrates a block diagram of an LLM intelligence layer structure, according to aspects of the present disclosure; and

FIG. 10 illustrates a block diagram of a computing device, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems and methods for managing and analyzing data collected throughout the lifecycle of mobile devices to support intelligent decision-making for aftermarket devices. Mobile devices, such as smartphones, tablets, smartwatches, laptops, hearables, wearables, personal digital assistants, and other portable consumer electronic devices, generate substantial amounts of data during their operational lifetimes. This data may originate from diverse sources, including trade-in programs, repair vendors, secondary markets, recycling facilities, warranty and insurance providers, enterprise IT services, and other points in the device lifecycle.

The aftermarket mobile device industry encompasses the management of mobile devices that are no longer in their original sale condition. This may include refurbished, pre-owned, and recycled devices. A goal of the aftermarket industry is to extend the lifecycle of mobile devices, reduce electronic waste, and provide cost-effective alternatives to new devices. The industry relies on accurate assessment and classification of devices to determine their suitability for resale, insurance, recycling, or other downstream channels, so that each device may be utilized in an efficient and sustainable manner.

The data collected throughout the mobile device lifecycle may include structured information, such as repair costs and trade-in values; unstructured data, such as diagnostic logs and customer reviews; and image-based data, such as photographs of physical damage. The variability in data formats, completeness, and granularity across these sources presents challenges in consolidating this information into a cohesive and usable framework.

The technology described herein applies artificial intelligence (AI) models to learn from these diverse datasets and extract actionable insights on which decisions may be made. These models may include supervised learning for classification and prediction, unsupervised learning for pattern discovery, reinforcement learning for process optimization, and deep learning for processing complex, multi-modal data. Based on the outputs of these models, the technology facilitates data-driven decisions, such as determining device value, assessing whether to repair or dispose of a device, evaluating insurance eligibility, predicting remaining device life, and optimizing recycling or resale strategies through dynamic channel routing.

The technology may further employ multi-objective optimization frameworks to maximize net recovery value for each device, predictive routing mechanisms to reduce processing time and costs, device health certification systems to increase transparency in secondary markets, and large language model (LLM) integration to enable natural language querying and autonomous agent-driven workflows. These capabilities address the technical challenges associated with identifying, analyzing, and utilizing diverse data collected throughout the lifecycle of mobile devices.

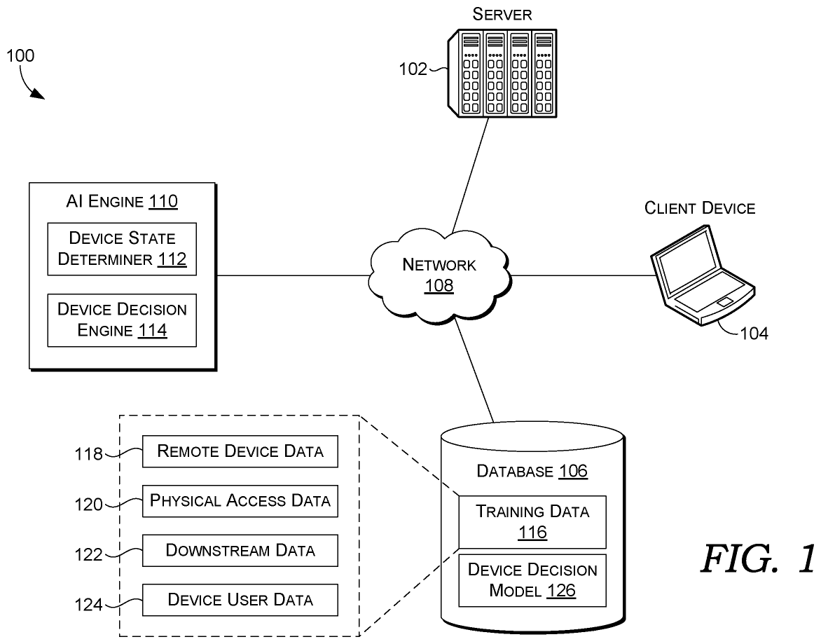

Referring now to FIG. 1, an example operating environment 100 in which aspects of the technology may be employed is illustrated. The operating environment 100 comprises a server 102, a client device 104, a database 106, and a network 108. The server 102, the client device 104, and the database 106 communicate via the network 108.

The server 102 may be a computing device that implements functional aspects of the operating environment 100. The server 102 may host one or more processing engines, models, or services that perform data analysis, machine learning inference, and decision-making operations related to mobile device lifecycle management. In some cases, the server 102 may be embodied as one or more physical or virtual computing devices, and may be deployed in a cloud computing environment or in an on-premises data center.

The client device 104 may be a computing device that interacts with the server 102 to access functionality provided by the operating environment 100. The client device 104 may be a desktop computer, laptop, tablet, smartphone, or other computing device operated by a user such as a warehouse manager, insurance adjuster, repair technician, or other stakeholder in the mobile device aftermarket industry. In some cases, the client device 104 may perform certain functions locally, while in other cases the client device 104 may rely on the server 102 to perform processing operations and return results. The client device 104 may serve as a front-end or client-side device, while the server 102 may serve as a back-end or server-side device.

With continued reference to FIG. 1, the database 106 may store information used in the operating environment 100, including data, computer instructions such as software program instructions, routines, or services, and machine learning models. Although depicted as a single database component in FIG. 1, the database 106 may be embodied as one or more databases, may be distributed across multiple storage systems, or may be hosted in a cloud environment. The database 106 may store training data, device telemetry, inspection results, downstream channel data, and trained machine learning models that are accessed by the server 102 during operation.

The network 108 may include one or more networks that enable communication between the server 102, the client device 104, and the database 106. The network 108 may include, without limitation, one or more local area networks (LANs), wide area networks (WANs), public networks such as the Internet, virtual private networks (VPNs), or any other communication network or method suitable for transmitting data between the components of the operating environment 100.

It is noted that any additional or fewer components, in any arrangement, may be employed to achieve the desired functionality within the scope of the present disclosure. Although the various components of FIG. 1 are shown with lines for the sake of clarity, in reality, delineating various components is not so clear. Some components of FIG. 1 are depicted as single components, but the depictions are intended as examples in nature and in number and are not to be construed as limiting for all implementations of the present disclosure. Other arrangements and elements, such as machines, interfaces, functions, orders, and groupings of functions, may be used in addition to or instead of those shown, and some elements may be omitted altogether.

The server 102 may include an AI engine 110 that performs machine learning and data analysis operations related to mobile device lifecycle management. The AI engine 110 may receive device data from various sources, process the data using trained machine learning models, and generate outputs that inform decisions about mobile devices. The AI engine 110 may be implemented as software executing on one or more processors of the server 102, and may access data and models stored in the database 106.

The AI engine 110 may include a device state determiner 112 and a device decision engine 114. The device state determiner 112 and the device decision engine 114 may work together to analyze device data and generate decisions regarding mobile devices in the aftermarket lifecycle.

The device state determiner 112 may be configured to analyze input device data and generate output information characterizing the state or condition of a mobile device. The device state determiner 112 may employ one or more trained machine learning models to process device data and produce predictions, classifications, or other analytical outputs. For example, the device state determiner 112 may identify patterns in repair histories to predict common device failures, analyze trade-in data to estimate resale values, detect physical damage from device images, or assess battery health based on telemetry data. The device state determiner 112 may process structured data such as numerical diagnostic readings, unstructured data such as text from diagnostic logs or customer reviews, and image data such as photographs of device cosmetic condition.

The device decision engine 114 may receive output information from the device state determiner 112 and generate decisions about a mobile device based on the received output information. The device decision engine 114 may evaluate the analytical outputs produced by the device state determiner 112 and determine an appropriate action or routing for the mobile device. In some cases, the device decision engine 114 may determine a mobile device value, including a value before or after repair. In some cases, the device decision engine 114 may determine a device grade characterizing the overall condition of the mobile device. In some cases, the device decision engine 114 may determine whether to insure a device based on predicted risk factors. In some cases, the device decision engine 114 may determine whether to resell a mobile device as-is or after repair. In some cases, the device decision engine 114 may determine whether to repair or replace a mobile device. In some cases, the device decision engine 114 may determine whether to dispose of a device through recycling, resale, or other disposal pathways.

The device decision engine 114 may weight multiple factors when generating decisions. These factors may include repair costs, environmental impact, device condition, market demand, depreciation rates, and other considerations relevant to the specific decision being made. The device decision engine 114 may balance competing factors to provide actionable recommendations tailored to the specific circumstances of each aftermarket device.

In some cases, a repair decision generated by the device decision engine 114 may identify a specific component of the mobile device that is likely to need repair. Such components may include a display, haptic components, a speaker, a microphone, a port, a functional component, an accelerometer, a magnetometer, a battery, a camera, or another device component. By identifying specific components, the device decision engine 114 may enable targeted repair workflows that reduce processing time and costs.

In some cases, a dispose decision generated by the device decision engine 114 may identify a disposal pathway for the mobile device. The disposal pathway may include recycling, resale through secondary markets, wholesale liquidation, or other channels appropriate for the device condition and market conditions. The device decision engine 114 may select among available disposal pathways based on factors such as expected recovery value, time to sale, and environmental considerations.

The device state determiner 112 and the device decision engine 114 may operate in coordination to provide end-to-end processing of mobile device data. The device state determiner 112 may transform raw device data into structured analytical outputs, and the device decision engine 114 may transform those analytical outputs into actionable decisions. This separation of concerns may enable the AI engine 110 to be configured with different machine learning models for different analytical tasks while maintaining a consistent decision-making framework.

The AI engine 110 may communicate with the client device 104 via the network 108 to receive device data inputs and transmit decision outputs. In some cases, the client device 104 may submit device data to the AI engine 110 through an application programming interface (API), and the AI engine 110 may return a decision or recommendation in response. The decision or recommendation may be displayed to a user of the client device 104, or may be used to trigger automated workflows in downstream systems.

The database 106 may store training data 116 that is used to train machine learning models employed by the AI engine 110. The training data 116 may comprise various data collected during the lifecycle of a mobile device. Mobile devices may include smartphones, tablets, smartwatches, laptops, hearables such as headphones, wearables such as fitness trackers and smart rings, personal digital assistants, MP3 players, satellite location devices, handheld communication devices, gaming devices, handheld entertainment systems, remote controls, and other portable consumer electronic devices. The training data 116 may be collected at various points in the mobile device lifecycle, such as initial distribution, device application collection, web portal submission, trade-in or resale through secondary markets, repair and refurbishment, applications for warranty or insurance or claims related thereto, recycling or disposal at end-of-life, and data decommissioning or secure erasure prior to transfer or disposal.

In some cases, the training data 116 may be collected from a device application, such as a downloadable application installed on the mobile device. The device application may monitor device subsystems, collect telemetry data, and transmit the collected data to the server 102 or the database 106 via the network 108. In some cases, the training data 116 may be collected through a web portal that enables users to submit device information, diagnostic results, or other data relevant to device condition assessment. The web portal may provide a user interface through which device owners, repair technicians, or other stakeholders may enter data about mobile devices.

The training data 116 may include multiple categories of data that capture different aspects of mobile device condition and history. In the operating environment 100, the training data 116 may include remote device data 118, physical access data 120, downstream data 122, and device user data 124. These categories of data may overlap in some cases, and data may be classified into different categories depending on the context in which the data is collected or used. The training data 116 is not limited to these categories, and additional types of data, fewer data points, or different groupings of data may be used where suitable for training machine learning models.

The remote device data 118 may include data remotely accessed by one or more data collecting agents of a mobile device. In some cases, a remote agent may be stored in the local memory of the mobile device and may monitor, receive, identify, determine, or retrieve data corresponding to mobile device subsystems. Such subsystems may include a processing subsystem, a display subsystem, a power management subsystem, a communication subsystem, a camera subsystem, an audio subsystem, a memory subsystem, a sensor subsystem, an input/output subsystem, an antenna subsystem, a thermal management subsystem, an operating system subsystem, or other subsystems. The remote device data 118 may include telemetry data such as CPU usage, battery health metrics, display characteristics, communication signal strength, sensor readings, and other operational parameters that characterize device function and condition.

The physical access data 120 may comprise data that becomes accessible when a mobile device is physically present at a processing facility or inspection station. The physical access data 120 may include data obtained through direct or wireless communication with a present device, such as through a bus connection or near-field communication. The physical access data 120 may include low-level hardware diagnostics data, storage access data, debugging and developer data, detailed application data, network configuration and logs, power and battery data, peripheral and sensor data, system partition access data, and proprietary device data. The physical access data 120 may provide deeper insight into device condition than data that can be collected remotely.

The downstream data 122 may be received from downstream points within the lifecycle of an aftermarket mobile device. Downstream points may include stages where the device interacts with secondary markets, repair vendors, warranty and insurance providers, disposal facilities, trade-in programs, donation programs, leasing service programs, enterprise IT services, primary device users, and other aftermarket channels. In some cases, an application programming interface may be provided to allow computing devices corresponding to the downstream points to enter the downstream data 122 for collection and storage in the database 106. The downstream data 122 may include sales data, condition reports, refurbishment details, repair lifecycle data, claim data, device intake data, trade-in value data, and other information generated at various points in the aftermarket device lifecycle.

The downstream data 122 may also include data about the device determined from inspection of the device. In some cases, an inspection may be autonomously performed using automated inspection systems. The inspection data may include cosmetic data such as display defects including scratches, cracks, and dead pixels, as well as scratches or cracks on the body of the device. The inspection data may also include data determined from functional device testing, such as battery performance data and camera functionality data. In some cases, the inspection data may include a grade for the device, such as Grade A, Grade B, or Grade C. In some cases, the inspection data may comprise a grade for one or more features of a device, such as a grade for functionality, a grade for cosmetics, or a grade for the camera.

The device user data 124 may include data about the owner or user of a device. The device user data 124 may include demographic data. The device user data 124 may be used in conjunction with other categories of training data to inform predictions about device condition, usage patterns, and risk factors relevant to insurance or resale decisions.

The database 106 may also store a device decision model 126 that is trained using the training data 116. The device decision model 126 may include one or more machine learning models configured to analyze various types of data within the training data 116 and generate predictions, classifications, recommendations, or other outputs. The device decision model 126 may be configured to analyze structured data, unstructured data, and semi-structured data. In some cases, the device decision model 126 may utilize supervised learning, unsupervised learning, semi-supervised learning, reinforcement learning, or deep learning techniques, depending on the nature or structure of the data or the desired type of output.

The device decision model 126 may use statistical analysis, pattern recognition, and optimization techniques to derive insights and improve decision-making. For example, the device decision model 126 may identify trends in device failure patterns, detect anomalies in device telemetry, optimize processing workflows, or forecast outcomes based on historical and real-time data. The device state determiner 112 may employ the device decision model 126 to provide output information on which the device decision engine 114 may base a decision about a mobile device.

In some cases, the device decision model 126 may comprise supervised learning models that classify and predict outcomes based on historical data. Supervised learning models may identify patterns in repair logs to forecast common device failures or determine trade-in values based on historical resale prices and device conditions. Examples of supervised learning models that may be employed include linear regression for predictive analysis and support vector machines for classifying devices into categories such as refurbishable, recyclable, or beyond repair. Neural networks may be trained to classify images by learning the relationship between input features and corresponding labels, or to predict trade-in values based on structured input data such as device condition, model type, and age.

In some cases, the device decision model 126 may comprise unsupervised learning models that detect anomalies or uncover hidden patterns within device data. Clustering algorithms, such as k-means or hierarchical clustering, may group devices based on usage patterns, customer demographics, or common repair issues. Dimensionality reduction techniques, such as principal component analysis, may simplify large, complex datasets to enable more efficient analysis.

In some cases, the device decision model 126 may comprise reinforcement learning models that optimize processes over time. A reinforcement learning agent may analyze repair vendor workflows to recommend more efficient labor and parts allocation or to optimize shipping routes for device trade-ins and returns. Reinforcement learning models may be trained using a reward-based system where an agent learns by interacting with an environment and receiving feedback in the form of rewards or penalties.

In some cases, the device decision model 126 may comprise deep learning models such as convolutional neural networks and recurrent neural networks. Convolutional neural networks may process images of devices received in trade-in programs to detect screen cracks or other damage. Recurrent neural networks or transformer-based models may analyze sequential data, such as repair lifecycle logs or network activity patterns, to predict trends or identify unusual behavior indicative of device failures.

In some cases, the device decision model 126 may comprise natural language processing models that analyze textual data such as customer reviews, support tickets, and diagnostic reports to extract insights regarding encountered issues. Sentiment analysis models may assess customer satisfaction within trade-in or warranty processes. Transformer-based architectures may be pre-trained on large corpora of text data and fine-tuned on domain-specific data to perform tasks such as sentiment analysis or summarization.

In some cases, the device decision model 126 may comprise ensemble learning models that combine multiple machine learning techniques to enhance predictive accuracy. Random forest or gradient boosting models may aggregate insights from various subsystems, such as repair data, trade-in evaluations, and recycling statistics, to provide comprehensive predictions or classifications that support decision-making across the device lifecycle.

The device decision model 126 may be trained using labeled datasets where each input is associated with a known output or target value. During training, loss functions may be used to measure the difference between the model predictions and the actual target values in the labeled dataset. Techniques such as gradient descent may be employed to iteratively adjust model parameters to improve prediction accuracy. The device decision model 126 may be periodically retrained or updated as new training data 116 becomes available, enabling the model to adapt to evolving device designs, market conditions, and repair practices.

The remote device data may include data collected from various subsystems of a mobile device via one or more remote data collecting agents. In some cases, a remote agent may be stored in the local memory of the mobile device and may access data corresponding to mobile device subsystems. The remote device data may be transmitted from the mobile device to a server or database via a network connection for storage and subsequent analysis.

Processing subsystem data may include CPU usage, clock speed, number of active cores, power consumption, and task scheduling metrics. Processing subsystem data may also include GPU load, frame rates, memory utilization, and neural processing unit activity for AI workloads. In some cases, processing subsystem data may include error and system logs that record faults, exceptions, and operational events occurring within the processing subsystem. In some cases, processing subsystem data may include on-device diagnostics and original equipment manufacturer (OEM) diagnostics that provide detailed information about processor health and performance characteristics.

Display subsystem data may include information about screen resolution, refresh rates, brightness levels, color calibration, and touch input frequency. In some cases, display subsystem data may include detection of dead pixels or stuck pixels that fail to display correct color values. In some cases, display subsystem data may include detection of screen burn-in where persistent images have caused permanent discoloration or ghosting on the display. In some cases, display subsystem data may include color hue calibration data indicating whether the display accurately reproduces intended colors across the color spectrum. In some cases, display subsystem data may include digitizer functionality data characterizing the responsiveness and accuracy of touch input detection across the display surface.

Power management subsystem data may include power consumption metrics, battery health metrics such as charge cycles, capacity, and degradation, real-time power consumption, voltage levels, current flows, and wireless charging efficiency. The power management subsystem data may provide insight into the remaining useful life of the battery and the overall power delivery characteristics of the device.

Communication subsystem data may include cellular signal strength, bandwidth usage, latency, and connection quality for Wi-Fi and Bluetooth connections. Communication subsystem data may also include near-field communication error logs, GPS error logs, satellite signal strength, and accuracy metrics. The communication subsystem data may characterize the ability of the device to maintain reliable wireless connections across different communication protocols.

Motion subsystem data may include accelerometer data, gyroscope data, and magnetometer data. The accelerometer data may characterize linear acceleration forces acting on the device along multiple axes. The gyroscope data may characterize rotational velocity and orientation changes of the device. The magnetometer data may characterize magnetic field strength and direction relative to the device, which may be used for compass functionality and orientation detection. The motion subsystem data may be used to assess the functionality of motion sensors and to detect anomalies in sensor readings that may indicate hardware degradation or damage.

Camera subsystem data may include resolution settings, shutter speeds, ISO levels, focal lengths, metadata such as geotags and timestamps, image sensor utilization, and flash performance. The camera subsystem data may characterize the operational parameters and performance characteristics of front-facing and rear-facing cameras on the mobile device.

Audio subsystem data may include microphone input levels, ambient noise measurements, speaker output levels, equalization settings, codec performance, and distortion rates. The audio subsystem data may characterize the ability of the device to capture and reproduce audio signals within expected quality parameters.

Memory subsystem data may include RAM usage, memory fragmentation, storage capacity, used space, file types, read/write speeds, storage health, and endurance metrics. The memory subsystem data may provide insight into the available storage capacity and the health of flash storage components.

Sensor subsystem data may include accelerometer readings, gyroscope data, proximity sensor triggers, ambient light levels, and biometric authentication statistics. The sensor subsystem data may characterize the functionality and responsiveness of various sensors integrated into the mobile device.

Input/output subsystem data may include touchscreen interaction patterns, button press counts, data transfer rates through ports, and power delivery metrics such as USB-C performance. The input/output subsystem data may characterize the functionality of physical interfaces and user input mechanisms.

Antenna subsystem data may include signal strength, frequency bands, handover statistics during network switches, satellite positioning system antenna efficiency, and accuracy metrics. The antenna subsystem data may characterize the ability of the device to maintain wireless connections and receive positioning signals.

Thermal management subsystem data may include temperature readings from thermal sensors distributed throughout the device, thermal throttling events, and heat dissipation characteristics. The thermal management subsystem data may provide insight into whether the device operates within expected temperature ranges during various workloads.

Operating system subsystem data may include application usage patterns, system logs, error reports, file access events, network requests, and resource allocation metrics. The operating system subsystem data may characterize software-level behavior and may identify patterns indicative of software faults or malware activity.

Physical access data may comprise data that becomes accessible when a mobile device is physically present at a processing facility, inspection station, or other location where direct access to the device is available. Physical access data may include data obtained through direct communication with the device via a wired bus connection, or through wireless communication mechanisms such as near-field communication when the device is in close proximity to data collection equipment. Physical access data may provide deeper diagnostic information than data that can be collected remotely, as physical access may enable retrieval of low-level hardware information that is not exposed through standard remote interfaces.

Low-level hardware diagnostics data may include chipset level input output registry data on device subsystem boards. The chipset level input output registry data may be collected from subsystem boards including a CPU board, a GPU board, a camera board, a GPS board, an antenna board, and a display board. The input output registry data may include register values, hardware serial numbers, and thermal sensor readings that characterize the operational state of hardware components at a granular level. In some cases, the low-level hardware diagnostics data may include error codes and raw diagnostic data that are not accessible through standard application programming interfaces. The low-level hardware diagnostics data may enable detection of hardware faults that would not be apparent from higher-level telemetry data.

Storage access data may include full disk data that provides a complete view of the storage contents of the mobile device. The storage access data may provide insight into the usage history of the device and may enable detection of storage health issues such as bad sectors or flash memory degradation.

Debugging and developer data may include debug logs that record detailed information about software execution and system events. In some cases, debugging and developer data may include crash reports that document software failures, including stack traces and memory states at the time of failure. In some cases, debugging and developer data may include live process monitoring data obtained using diagnostic tools that observe running processes and system resource utilization in real time. The debugging and developer data may enable identification of software-related issues that affect device stability or performance.

Detailed application data may include app-specific data directories that contain configuration files associated with individual applications. In some cases, detailed application data may include encrypted app data that is stored in protected storage areas. In some cases, detailed application data may include installed app metadata such as application identifiers, version numbers, installation dates, and permission grants. The detailed application data may provide insight into the software environment of the device and may enable detection of potentially problematic applications.

Network configuration and log data may include stored Wi-Fi credentials that record network names and authentication information for previously connected wireless networks. In some cases, network configuration and log data may include network traffic logs that record connection events, data transfer volumes, and communication endpoints. In some cases, network configuration and log data may include VPN or proxy settings that configure secure or anonymized network connections. The network configuration and log data may provide insight into the network usage patterns of the device.

Power and battery data obtained through physical access may include battery cycle counts that record the number of complete charge and discharge cycles the battery has undergone. In some cases, power and battery data may include charging efficiency metrics that characterize how effectively the battery accepts charge from external power sources. In some cases, power and battery data may include historical power consumption logs that record power usage over time. The power and battery data may enable accurate assessment of battery health and remaining useful life.

Peripheral and sensor data may include logs of connected devices that record the history of external peripherals that have been paired or connected to the mobile device. In some cases, peripheral and sensor data may include raw sensor streams that provide unprocessed data from accelerometers, gyroscopes, magnetometers, and other sensors. The peripheral and sensor data may enable assessment of sensor functionality and peripheral compatibility.

Proprietary device data may include manufacturer-specific diagnostic logs that provide detailed information about device subsystem health using proprietary diagnostic protocols. In some cases, proprietary device data may include firmware files that characterize the software configuration of the device at a low level. In some cases, proprietary device data may include OEM-specific health-check tools that execute manufacturer-defined diagnostic routines to assess device functionality against manufacturer specifications. The proprietary device data may enable access to diagnostic information that is not available through standard interfaces and may provide insight into device condition that complements data obtained from open diagnostic protocols.

System partition access data may include bootloader information that describes the boot sequence configuration and bootloader version. In some cases, system partition access data may include custom firmware details that indicate whether the device has been modified from its factory configuration. In some cases, system partition access data may include system configuration files that control operating system behavior and device settings. The system partition access data may enable detection of unauthorized modifications or firmware tampering.

Physical access data may be collected through standardized intake procedures that connect the mobile device to diagnostic equipment at a processing facility. The diagnostic equipment may establish communication with the device through wired interfaces such as USB connections or through wireless interfaces such as near-field communication when the device is in close proximity. The intake procedures may execute automated data extraction routines that retrieve available physical access data from the device in a systematic manner, enabling consistent data collection across devices of different models and configurations.

The physical access data collected through direct device interaction may complement remote device data by providing access to low-level diagnostic information that is not exposed through standard remote monitoring interfaces. In some cases, physical access data may reveal hardware conditions such as component-level faults, storage degradation patterns, or thermal management issues that are not detectable through remote telemetry alone. The combination of remote device data and physical access data may enable more comprehensive device condition assessment than either data source in isolation.

Physical access data may also include usage metrics such as the amount of phone usage. In some cases, usage metrics may include the number of minutes of screen time that the device display has been active. In some cases, usage metrics may include talk time representing the duration of voice calls. In some cases, usage metrics may include the time the device has been in an on-configuration where the device is powered on and operational. In some cases, usage metrics may include the length of time the phone has been connected to a network. The usage metrics may provide insight into the intensity and duration of device usage over its operational lifetime.

Downstream data may be received from various downstream contact points within the lifecycle of an aftermarket mobile device. Downstream contact points may include stages where the device interacts with secondary markets, repair vendors, warranty and insurance providers, disposal facilities, trade-in programs, donation programs, leasing service programs, enterprise IT services, primary device users, and device diagnostics systems. Each downstream contact point may provide data that characterizes the condition, history, or value of the mobile device at that stage of the lifecycle. In some cases, an application programming interface may be provided to allow computing devices corresponding to the downstream contact points to enter downstream data for collection and storage.

In some cases, the downstream contact point may include a device diagnostics system. The device diagnostics system may include on-device diagnostics that execute locally on the mobile device to assess hardware and software functionality. In some cases, the device diagnostics system may include external driven diagnostics methods where diagnostic routines are initiated and controlled by an external computing device connected to the mobile device. The external driven diagnostics methods may enable more comprehensive testing than on-device diagnostics alone, as the external computing device may have access to diagnostic tools and test sequences that are not available on the mobile device itself. The device diagnostics system may generate diagnostic results that characterize the functional state of device subsystems and may identify faults or degradation that affect device value or suitability for resale.

Data received from secondary markets may include sales data such as listing price, final sale price, and time to sell. In some cases, data received from secondary markets may include condition reports that characterize cosmetic damage, battery health, and functional issues observed at the time of resale. In some cases, data received from secondary markets may include refurbishment details such as components replaced, firmware updates applied, or repairs performed before resale. In some cases, data received from secondary markets may include customer demographics such as buyer profiles and geographical trends in resale demand. In some cases, data received from secondary markets may include warranty or extended support options offered at resale. The data received from secondary markets may provide insight into market pricing dynamics and the relationship between device condition and resale value.

Data received from repair vendors may include repair lifecycle data such as dates for receipt, diagnostic, repair completion, and return shipment. In some cases, data received from repair vendors may include repair details such as components replaced, repair type, and diagnostic results. In some cases, data received from repair vendors may include cost breakdown information such as labor costs, part costs, and warranty claims versus out-of-pocket costs. In some cases, data received from repair vendors may include shipping logistics such as carrier details, tracking numbers, shipping costs, and delivery dates. In some cases, data received from repair vendors may include diagnostic insights such as root causes of device issues, common faults, and software or hardware malfunctions. In some cases, data received from repair vendors may include the number of service calls on a device. The data received from repair vendors may enable analysis of repair patterns and costs across device models and failure types.

Data received from warranty or insurance providers may include claim data such as the number and type of claims filed, including accidental damage, theft, or malfunction claims. In some cases, data received from warranty or insurance providers may include repair or replacement history such as details of repairs performed or replacement devices issued. In some cases, data received from warranty or insurance providers may include costs such as payout amounts, deductible amounts, and covered repair or replacement costs. In some cases, data received from warranty or insurance providers may include fraud detection data such as suspicious claim patterns or anomalies. The data received from warranty or insurance providers may enable assessment of risk factors associated with device models and usage patterns.

Data received from recycling and disposal facilities may include device intake data such as model, condition, and number of devices received. In some cases, data received from recycling and disposal facilities may include materials recovered such as quantities of recyclable components including metals, plastics, and batteries. In some cases, data received from recycling and disposal facilities may include disposal methods such as processes including shredding, refurbishment, or secure data destruction. In some cases, data received from recycling and disposal facilities may include environmental impact metrics such as waste reduction, energy usage, and compliance with regulations. In some cases, data received from recycling and disposal facilities may include economic value data such as revenue generated from recycling valuable materials. The data received from recycling and disposal facilities may inform decisions about whether devices should be routed to recycling versus other disposal pathways.

Data received from trade-in programs may include device evaluation data such as condition assessment for screen damage, battery health, and functional tests. In some cases, data received from trade-in programs may include trade-in value data such as offer price and factors influencing valuation. In some cases, data received from trade-in programs may include upgrade trends such as popular models being traded in and purchased. In some cases, data received from trade-in programs may include refurbishment or resale pathways indicating whether devices are refurbished, resold, or recycled. The data received from trade-in programs may provide insight into the condition distribution of devices entering the aftermarket and the relationship between device characteristics and trade-in values.

Data received from donation programs may include device donation records such as the number and types of devices donated. In some cases, data received from donation programs may include recipient information such as details on organizations or individuals receiving devices. In some cases, data received from donation programs may include post-donation usage data such as feedback on device performance or longevity. In some cases, data received from donation programs may include refurbishment needs such as repairs or updates performed prior to donation. The data received from donation programs may inform decisions about which devices are suitable for donation versus other disposal pathways.

Data received from leasing and rental service programs may include usage data such as duration of rental and type of use including personal versus corporate use. In some cases, data received from leasing and rental service programs may include condition tracking data such as wear and tear over time and damage assessments upon return. In some cases, data received from leasing and rental service programs may include maintenance records such as repairs or updates performed during the lease period. In some cases, data received from leasing and rental service programs may include return trends such as reasons for lease termination or upgrades. The data received from leasing and rental service programs may provide insight into device degradation patterns under different usage scenarios.

Data received from enterprise IT services may include device lifecycle management data such as deployment dates, assigned users, and usage history. In some cases, data received from enterprise IT services may include software inventory data such as installed applications, licensing details, and compliance status. In some cases, data received from enterprise IT services may include network activity data such as device connectivity patterns, bandwidth usage, and security event logs. In some cases, data received from enterprise IT services may include device health monitoring data such as hardware diagnostics, performance metrics, and failure predictions. In some cases, data received from enterprise IT services may include user access and authentication data such as login attempts, multi-factor authentication events, and access permissions. In some cases, data received from enterprise IT services may include maintenance records such as system updates, patches applied, and support tickets. The data received from enterprise IT services may provide comprehensive device history for devices that have been deployed in managed enterprise environments.

Data received from primary device users may include user reports on cosmetics or functionality. In some cases, data received from primary device users may include the length of time between acquiring the device and returning the device, where quick returns may indicate regret purchases or devices that did not function as expected or described. In some cases, data received from primary device users may include other reported data characterizing the user experience with the device. The data received from primary device users may provide subjective assessments of device condition that complement objective diagnostic data.

Downstream data may also include data about the device determined from inspection of the device. In some cases, an inspection may be autonomously performed using automated inspection systems that capture images and perform diagnostic tests without manual intervention. The inspection data may include cosmetic data such as display defects including scratches, cracks, and dead pixels, as well as scratches or cracks on the body of the device. The inspection data may also include data determined from functional device testing, such as battery performance data and camera functionality data.

In some cases, the inspection data may include a grade for the device. The grade may characterize the overall condition of the device using a standardized scale such as Grade A, Grade B, or Grade C. In some cases, the inspection data may comprise a grade for one or more features of a device. The feature grades may include a grade for functionality that characterizes the operational state of device hardware and software. The feature grades may include a grade for cosmetics that characterizes the visual appearance and physical condition of the device exterior. The feature grades may include a grade for the camera that characterizes the image quality and functionality of device cameras. The grading data may enable consistent categorization of devices across different inspection facilities and may inform routing decisions based on device condition.

The device decision model may employ various machine learning model architectures to analyze device data and generate predictions, classifications, or recommendations. The selection of model architecture may depend on the nature of the input data, the type of output desired, and the computational resources available. In some cases, multiple model architectures may be combined to leverage the strengths of different approaches for different aspects of device analysis.

Supervised learning models may be employed to classify and predict outcomes based on labeled training data. In supervised learning, each training example is associated with a known output or target value, and the model learns to map inputs to outputs by minimizing the difference between predicted and actual values. Supervised learning models may be used to predict device failure likelihood based on telemetry data, estimate trade-in values based on device condition and market factors, classify devices into condition grades based on inspection data, or determine whether a device should be repaired or disposed. Examples of supervised learning models include linear regression, logistic regression, support vector machines, decision trees, and neural networks trained on labeled datasets.

Unsupervised learning models may be employed to discover patterns or structure in data without labeled outputs. Unsupervised learning models may identify clusters of devices with similar characteristics, detect anomalies that deviate from normal patterns, or reduce the dimensionality of complex datasets to enable more efficient analysis. Clustering algorithms such as k-means clustering and hierarchical clustering may group devices based on usage patterns, failure modes, or condition characteristics. Dimensionality reduction techniques such as principal component analysis may simplify high-dimensional telemetry data while preserving information relevant to device condition assessment.

Reinforcement learning models may be employed to optimize sequential decision-making processes over time. In reinforcement learning, an agent learns by interacting with an environment and receiving feedback in the form of rewards or penalties based on the outcomes of its actions. Reinforcement learning models may be used to optimize device routing decisions, where the agent learns to select processing pathways that maximize recovery value while minimizing processing time and costs. Reinforcement learning models may also be used to optimize repair workflows by learning efficient sequences of diagnostic and repair actions. Training techniques for reinforcement learning may include Q-learning, policy gradient methods, and actor-critic methods.

Deep learning models may be employed to analyze complex or unstructured data that is difficult to process using traditional machine learning approaches. Deep learning models comprise multiple layers of interconnected nodes that learn hierarchical representations of input data. Convolutional neural networks may process image data such as photographs of device cosmetic condition to detect scratches, cracks, screen damage, or other physical defects. Convolutional neural networks learn spatial features from image pixels through convolutional layers that apply learned filters across the image. Recurrent neural networks may process sequential data such as time-series telemetry or repair lifecycle logs to identify temporal patterns and predict future states. Recurrent neural networks maintain internal state that enables them to capture dependencies across time steps in sequential data.

In some cases, Vision Transformers may be employed instead of or in combination with convolutional neural networks for image-based damage detection. Vision Transformers leverage self-attention mechanisms to capture global spatial relationships in device photographs. Unlike convolutional neural networks that process images through local receptive fields, Vision Transformers divide images into patches and process the patches as sequences using transformer architecture. The self-attention mechanism enables Vision Transformers to model relationships between distant regions of an image, which may improve detection of damage patterns that span multiple areas of a device or that require understanding of global device structure. Vision Transformers may be pre-trained on large image datasets and fine-tuned on device damage detection tasks.

In some cases, Graph Neural Networks may be employed to model relationships between device components, repair histories, and failure patterns. Graph Neural Networks operate on graph-structured data where nodes represent entities and edges represent relationships between entities. In the context of device analysis, nodes may represent device subsystems such as the display, battery, processor, or camera, and edges may represent functional dependencies between subsystems. Graph Neural Networks may learn to propagate information across the graph structure to predict how failures in one subsystem may affect other subsystems, or to identify patterns of correlated failures across device components. Graph Neural Networks may also model relationships between devices, repair actions, and outcomes to learn which repair strategies are effective for different failure patterns.

In some cases, attention-based encoder-decoder architectures may be employed to process sequential diagnostic logs and generate human-readable summaries of device conditions. Attention-based encoder-decoder architectures comprise an encoder that processes input sequences and a decoder that generates output sequences. The attention mechanism enables the decoder to focus on relevant portions of the encoded input when generating each element of the output. In the context of device analysis, the encoder may process sequences of diagnostic events, error codes, or telemetry readings, and the decoder may generate natural language summaries that describe the device condition in terms understandable to human operators. Attention-based encoder-decoder architectures may be trained on pairs of diagnostic logs and corresponding human-written summaries.

In some cases, Variational Autoencoders may be employed for anomaly detection in device telemetry data. Variational Autoencoders are generative models that learn latent representations of input data by encoding inputs into a latent space and decoding the latent representations back to reconstructed inputs. Variational Autoencoders may be trained on telemetry data from devices exhibiting normal behavior, learning a latent representation that captures the characteristics of normal device operation. When presented with telemetry data from a device, the Variational Autoencoder may compute a reconstruction error that measures how well the data fits the learned model of normal behavior. Telemetry data that produces high reconstruction error may indicate anomalous device behavior that warrants further investigation or that affects device value or insurability.

In some cases, Mixture-of-Experts architectures may be employed to dynamically route different data modalities to specialized sub-networks. Mixture-of-Experts architectures comprise multiple expert networks, each specialized for processing a particular type of data or handling a particular subset of the input space, along with a gating network that determines which experts should process each input. In the context of device analysis, different expert networks may be specialized for processing image data, structured telemetry data, textual diagnostic logs, or other data modalities. The gating network may learn to route each input to the experts that are most appropriate for that input type, improving computational efficiency by activating only the relevant experts for each input. Mixture-of-Experts architectures may enable efficient processing of heterogeneous device data without requiring all model parameters to be activated for every input.

Natural language processing models may be employed to analyze textual data such as customer reviews, support tickets, diagnostic reports, and repair notes. Natural language processing models may extract information about device issues from unstructured text, classify text into categories such as complaint types or sentiment levels, or generate summaries of textual content. Transformer-based language models may be pre-trained on large corpora of text data and fine-tuned on domain-specific data related to mobile device repair and aftermarket operations. Sentiment analysis models may assess customer satisfaction based on review text, which may inform decisions about device quality or vendor performance.

Ensemble learning methods may combine multiple machine learning models to improve predictive accuracy and robustness. Ensemble methods may aggregate predictions from multiple base models using techniques such as voting, averaging, or stacking. Random forest models comprise multiple decision trees trained on random subsets of the training data, with predictions aggregated across trees. Gradient boosting models train a sequence of models where each subsequent model focuses on correcting the errors of previous models. Ensemble methods may combine models of different types, such as combining neural network predictions with gradient boosting predictions, to leverage the complementary strengths of different model architectures. Ensemble methods may also provide uncertainty estimates by measuring the variance of predictions across ensemble members.

The device decision model may employ various data fusion and integration methods to combine multi-modal device data from different sources and formats. Mobile device lifecycle data may include structured telemetry data such as numerical sensor readings and diagnostic metrics, unstructured text data such as customer reviews and repair notes, and image data such as photographs of device cosmetic condition. Integrating these diverse data modalities may enable more comprehensive device analysis than processing each modality in isolation. The selection of fusion approach may depend on the characteristics of the available data, the computational resources available, and the requirements of the decision task.

In some cases, early fusion techniques may be employed to integrate multi-modal device data. Early fusion techniques may concatenate raw features from structured telemetry, unstructured text, and image data before processing through a unified model. In early fusion, features extracted from each data modality may be combined into a single feature vector that is provided as input to a machine learning model. For example, numerical features from telemetry data such as battery health metrics and sensor readings may be concatenated with text embeddings derived from diagnostic logs and image features extracted from device photographs. The unified model may then learn relationships across all data modalities simultaneously, enabling the model to discover correlations between features from different modalities that may be relevant to device condition assessment or decision-making. Early fusion may be suitable when the relationships between modalities are complex and benefit from joint learning across all features.

In some cases, late fusion approaches may be employed to integrate multi-modal device data. Late fusion approaches may process each data modality through separate specialized models and combine their outputs through weighted averaging, voting mechanisms, or learned attention weights. In late fusion, a separate model may be trained for each data modality, with each model producing predictions or intermediate representations based on its respective input type. For example, a convolutional neural network may process device images to produce a damage assessment score, a recurrent neural network may process telemetry time series to produce a health prediction, and a natural language processing model may process diagnostic text to produce a fault classification. The outputs of these separate models may then be combined to produce a final prediction or decision. Weighted averaging may assign fixed or learned weights to each model output based on the reliability or relevance of each modality. Voting mechanisms may aggregate discrete predictions from multiple models by selecting the most common prediction or by weighted voting. Learned attention weights may enable the fusion mechanism to dynamically adjust the contribution of each modality based on the specific input being processed. Late fusion may be suitable when specialized models for each modality are available or when the modalities have different data characteristics that benefit from separate processing.

In some cases, cross-modal attention mechanisms may be employed to enable the model to dynamically weight the importance of different data sources based on their relevance to specific decision tasks. Cross-modal attention mechanisms may compute attention weights that determine how much each data modality contributes to the final representation or prediction for a given input. The attention weights may be computed based on the content of the data from each modality, enabling the model to focus on the most informative modalities for each specific device or decision context. For example, when assessing a device with extensive cosmetic damage but normal telemetry readings, cross-modal attention may assign higher weight to image-derived features. When assessing a device with abnormal battery telemetry but good cosmetic condition, cross-modal attention may assign higher weight to telemetry-derived features. Cross-modal attention mechanisms may be implemented using transformer-style attention layers that compute query, key, and value representations from each modality and produce attention-weighted combinations of the representations. Cross-modal attention may enable more flexible and context-dependent fusion than fixed weighting schemes.

In some cases, hierarchical fusion architectures may be employed to integrate multi-modal device data. Hierarchical fusion architectures may first combine related data types before integrating with other categories. In hierarchical fusion, data modalities may be organized into groups based on their characteristics or the aspects of device condition they characterize. For example, a first fusion stage may combine all hardware-related data including telemetry from processing, memory, and power subsystems into a hardware health representation. A second fusion stage may combine all cosmetic-related data including images and inspection grades into a cosmetic condition representation. A third fusion stage may combine all market-related data including trade-in values and resale prices into a market value representation. A higher-level fusion stage may then combine the hardware health representation, cosmetic condition representation, and market value representation to produce a comprehensive device assessment. Hierarchical fusion may enable the model to learn meaningful intermediate representations at each level of the hierarchy, which may improve interpretability and enable reuse of intermediate representations for different decision tasks.

In some cases, knowledge distillation techniques may be employed to transfer insights from large multi-modal models to smaller, more efficient models suitable for edge deployment on client devices. Knowledge distillation involves training a smaller student model to mimic the behavior of a larger teacher model. The teacher model may be a large multi-modal model that achieves high accuracy but requires substantial computational resources that may not be available on client devices or edge computing platforms. The student model may be a smaller model with fewer parameters that can execute efficiently on resource-constrained devices. During knowledge distillation, the student model may be trained to match the outputs of the teacher model, including soft probability distributions over classes rather than just hard class labels. The soft probability distributions may contain information about the relationships between classes that is not present in hard labels, enabling the student model to learn from the teacher model more effectively than from the original training data alone. Knowledge distillation may enable deployment of multi-modal device analysis capabilities on client devices such as smartphones or tablets used by repair technicians or warehouse operators, reducing latency and enabling operation without continuous network connectivity to server-based models.

The device decision model may be trained using various labeling methodologies that address the challenges of obtaining labeled training data for mobile device lifecycle analysis. Labeled training data, where each input example is associated with a known output or target value, may be expensive or time-consuming to obtain in the mobile device aftermarket domain. Alternative labeling methodologies may enable effective model training when labeled data is scarce or when labeling resources are limited.

In some cases, semi-supervised learning approaches may be employed to train the device decision model. Semi-supervised learning approaches may leverage large quantities of unlabeled device data alongside smaller labeled datasets. In the mobile device aftermarket domain, unlabeled device data such as telemetry readings, diagnostic logs, and device images may be abundant, while labeled data indicating ground truth outcomes such as repair success, resale value, or failure occurrence may be limited. Semi-supervised learning may enable the model to learn useful representations from the unlabeled data while using the labeled data to guide the learning toward the desired prediction task.

In some cases, semi-supervised learning may employ pseudo-labeling techniques. In pseudo-labeling, a model trained on the available labeled data may be used to generate predicted labels for unlabeled examples. The unlabeled examples with high-confidence predictions may then be added to the training set with their predicted labels treated as ground truth. The model may be retrained on the expanded training set, and the process may be repeated iteratively. Pseudo-labeling may enable the model to leverage patterns in the unlabeled data to improve its predictions, particularly when the unlabeled data contains examples that are similar to the labeled examples but provide additional coverage of the input space.

In some cases, semi-supervised learning may employ consistency regularization techniques. Consistency regularization techniques may encourage the model to produce consistent predictions for different augmented versions of the same input. For example, a device image may be augmented through transformations such as rotation, cropping, or color adjustment, and the model may be trained to produce the same prediction for the original image and the augmented versions. Consistency regularization may encourage the model to learn representations that are robust to input variations and that capture the underlying characteristics of device condition rather than superficial features that vary across augmentations.

In some cases, active learning strategies may be employed to optimize the efficiency of labeling efforts for training the device decision model. Active learning strategies may identify the most informative unlabeled samples for human annotation. Rather than labeling examples randomly or in the order they are received, active learning may select examples that are expected to provide the greatest improvement in model performance when labeled and added to the training set.

Active learning may employ uncertainty sampling to identify informative examples. In uncertainty sampling, the model may be applied to unlabeled examples, and examples for which the model exhibits high uncertainty in its predictions may be selected for labeling. High uncertainty may indicate that the example lies in a region of the input space where the model has not yet learned to make confident predictions, and labeling such examples may provide information that helps the model improve in that region. Uncertainty may be measured using metrics such as prediction entropy, margin between the top two predicted classes, or variance across ensemble members.

Active learning may also employ diversity sampling to select examples that are representative of different regions of the input space. Diversity sampling may select examples that are dissimilar from examples already in the labeled training set, ensuring that the labeled data covers a broad range of device conditions and characteristics. Combining uncertainty sampling with diversity sampling may enable active learning to select examples that are both informative and representative.

In some cases, weak supervision techniques may be employed to generate training labels for the device decision model. Weak supervision techniques may generate probabilistic labels from heuristic rules, domain knowledge, or noisy data sources. Weak supervision may enable training on large datasets without requiring manual labeling of each example, by leveraging sources of information that provide imperfect but useful signals about the correct labels.

Weak supervision may employ labeling functions that encode heuristic rules based on domain knowledge. For example, a labeling function may assign a label of “battery replacement needed” to devices with battery cycle counts exceeding a threshold value, or a label of “cosmetic damage” to devices with inspection grades below a threshold. Each labeling function may provide a noisy signal that is correct for some examples but incorrect for others. Multiple labeling functions may be combined using techniques such as majority voting or probabilistic label models that estimate the accuracy of each labeling function and produce aggregated probabilistic labels.

Weak supervision may also leverage noisy data sources such as automated inspection systems. Automated inspection systems may generate labels based on image analysis or diagnostic tests, but these labels may contain errors due to limitations of the automated systems. Weak supervision techniques may model the noise characteristics of the automated systems and produce corrected probabilistic labels that account for the expected error rates. The probabilistic labels may be used to train the device decision model, with the model learning to weight examples based on the confidence of their labels.

In some cases, multi-task learning frameworks may be employed to train the device decision model. Multi-task learning frameworks may simultaneously train on multiple related objectives, enabling shared representations that improve generalization. In the mobile device aftermarket domain, multiple prediction tasks may be related, such as predicting repair cost, predicting resale value, predicting failure likelihood, and classifying device condition grade. Training a single model to perform multiple related tasks may enable the model to learn representations that capture common underlying factors relevant to all tasks.

In multi-task learning, the model may comprise shared layers that process input data and produce intermediate representations, along with task-specific layers that produce outputs for each prediction task. The shared layers may learn representations that are useful across all tasks, while the task-specific layers may learn to map the shared representations to the specific outputs required for each task. Training may involve optimizing a combined loss function that sums or weights the losses for each individual task. Multi-task learning may improve generalization by providing additional training signal from related tasks, which may be particularly beneficial when labeled data for some tasks is limited.

In some cases, curriculum learning approaches may be employed to train the device decision model. Curriculum learning approaches may structure training data presentation from simple to complex cases. Rather than presenting training examples in random order, curriculum learning may order examples based on their difficulty, presenting easier examples early in training and progressively introducing more difficult examples as training proceeds.

Curriculum learning may improve model convergence by enabling the model to learn basic patterns from simple examples before encountering complex examples that require understanding of those basic patterns. Curriculum learning may also improve performance on edge cases by ensuring that the model has developed robust representations before being exposed to unusual or difficult examples that might otherwise cause the model to learn spurious patterns.

In the mobile device aftermarket domain, example difficulty may be defined based on factors such as the clarity of the correct label, the typicality of the device condition, or the complexity of the input data. For example, devices with clear-cut conditions such as severe physical damage or pristine condition may be considered easier examples, while devices with borderline conditions or mixed characteristics may be considered more difficult. Curriculum learning may present the clear-cut examples early in training and introduce the borderline examples later, enabling the model to first learn the characteristics of extreme conditions before learning to distinguish between intermediate conditions.

The device decision model may employ various methods for quantifying prediction confidence and uncertainty. Uncertainty quantification may enable the system to assess the reliability of model predictions and to identify cases where predictions may be unreliable due to limited training data, unusual input characteristics, or inherent variability in the prediction task. Uncertainty estimates may inform downstream decision-making by indicating when human review may be warranted or when predictions should be treated with caution.

In some cases, Monte Carlo Dropout may be employed to estimate uncertainty in model predictions. Monte Carlo Dropout may estimate uncertainty by performing multiple forward passes with dropout enabled during inference. Dropout is a regularization technique that randomly sets a fraction of neural network activations to zero during training to prevent overfitting. In standard inference, dropout is typically disabled and all activations are used. In Monte Carlo Dropout, dropout remains enabled during inference, and the model is evaluated multiple times on the same input with different random dropout masks applied in each forward pass. Each forward pass produces a different prediction due to the different activations that are zeroed by dropout. The variance of predictions across the multiple forward passes may serve as an estimate of model uncertainty. High variance may indicate that the model is uncertain about the prediction, while low variance may indicate that the model is confident. Monte Carlo Dropout may provide uncertainty estimates without requiring changes to model architecture or training procedure, as dropout is commonly used during training of neural networks.

In some cases, Deep Ensembles may be employed to provide uncertainty estimates and improve prediction robustness. Deep Ensembles may aggregate predictions from multiple independently trained models to provide uncertainty estimates and improve robustness. In a Deep Ensemble, multiple models with the same architecture may be trained independently on the same training data, with each model initialized with different random weights and potentially trained with different random orderings of training examples. The independent training may cause each model to converge to a different solution, capturing different aspects of the relationship between inputs and outputs. During inference, each model in the ensemble may produce a prediction for a given input, and the predictions may be aggregated to produce a final prediction and an uncertainty estimate. The final prediction may be computed as the mean or median of the individual model predictions. The uncertainty estimate may be computed as the variance or standard deviation of the individual model predictions. High variance across ensemble members may indicate that the models disagree about the prediction, suggesting uncertainty. Deep Ensembles may provide well-calibrated uncertainty estimates and may improve prediction accuracy through the aggregation of diverse model predictions.

In some cases, conformal prediction methods may be employed to generate prediction sets with statistical guarantees. Conformal prediction methods may generate prediction sets with guaranteed coverage probabilities, providing statistically valid confidence intervals for device value estimates or failure predictions. Conformal prediction is a framework for constructing prediction sets that contain the true outcome with a specified probability, such as ninety percent or ninety-five percent. Unlike point predictions that provide a single predicted value, conformal prediction produces a set of possible values that is guaranteed to contain the true value with the specified probability, under certain assumptions about the data distribution.

Conformal prediction may operate by computing a nonconformity score for each possible prediction that measures how unusual the prediction would be given the observed data. The nonconformity scores may be calibrated using a held-out calibration dataset to determine a threshold such that predictions with nonconformity scores below the threshold are included in the prediction set. The calibration procedure may ensure that the prediction set achieves the desired coverage probability on future data drawn from the same distribution as the calibration data. For device value estimation, conformal prediction may produce an interval of possible values rather than a single point estimate, with the interval guaranteed to contain the true value with the specified probability. For failure prediction, conformal prediction may produce a set of possible failure modes or a range of possible failure times. The statistical guarantees provided by conformal prediction may enable more informed decision-making by quantifying the range of possible outcomes rather than providing only a point estimate.

In some cases, temperature scaling and other calibration techniques may be employed to improve the reliability of predicted probabilities. Temperature scaling and other calibration techniques may adjust model outputs to ensure that predicted probabilities accurately reflect true likelihoods. Neural network classifiers may produce probability estimates that are poorly calibrated, meaning that the predicted probabilities do not accurately reflect the true frequency of correct predictions. For example, a model may predict a probability of ninety percent for a class, but the true frequency of that class among examples with ninety percent predicted probability may be only seventy percent. Poor calibration may lead to overconfident or underconfident predictions that do not accurately represent the uncertainty in the prediction.

Temperature scaling is a post-hoc calibration technique that adjusts the logits produced by a neural network classifier before applying the softmax function to produce probabilities. Temperature scaling divides the logits by a temperature parameter that is learned on a held-out calibration dataset. A temperature greater than one may soften the probability distribution, reducing overconfidence by spreading probability mass more evenly across classes. A temperature less than one may sharpen the probability distribution, increasing confidence in the predicted class. The temperature parameter may be optimized to minimize a calibration loss such as negative log likelihood on the calibration dataset. Temperature scaling may improve calibration without changing the predicted class labels, as the relative ordering of logits is preserved by the scaling operation.

Other calibration techniques may include Platt scaling, isotonic regression, and histogram binning. Platt scaling fits a logistic regression model to map predicted probabilities to calibrated probabilities. Isotonic regression fits a non-decreasing function to map predicted probabilities to calibrated probabilities. Histogram binning groups predictions into bins based on predicted probability and assigns each bin a calibrated probability equal to the fraction of correct predictions in that bin. These calibration techniques may be applied to the outputs of trained models to improve the reliability of probability estimates without retraining the underlying model.

In some cases, evidential deep learning approaches may be employed to model uncertainty directly within the model architecture. Evidential deep learning approaches may directly model uncertainty by placing distributions over model outputs, distinguishing between aleatoric and epistemic uncertainty. Aleatoric uncertainty refers to uncertainty that arises from inherent variability or noise in the data, such as measurement noise or natural variation in device characteristics. Epistemic uncertainty refers to uncertainty that arises from limited knowledge or training data, such as uncertainty about model parameters or uncertainty in regions of the input space that are not well represented in the training data. Distinguishing between aleatoric and epistemic uncertainty may be valuable because the two types of uncertainty have different implications for decision-making and may be addressed through different means.

Evidential deep learning may model uncertainty by having the neural network output parameters of a probability distribution rather than point predictions. For regression tasks, the network may output parameters of a distribution over possible output values, such as the mean and variance of a Gaussian distribution. For classification tasks, the network may output parameters of a Dirichlet distribution over class probabilities. The Dirichlet distribution is a distribution over probability vectors, and its parameters may be interpreted as evidence for each class. The total evidence may indicate the confidence of the prediction, with higher total evidence indicating greater confidence. The distribution of evidence across classes may indicate the predicted class probabilities.

Evidential deep learning may decompose total uncertainty into aleatoric and epistemic components. Aleatoric uncertainty may be estimated from the expected variance of the predicted distribution, representing the inherent variability in the output given the input. Epistemic uncertainty may be estimated from the variance of the expected prediction across possible model parameters, representing uncertainty about the correct model. In practice, evidential deep learning may estimate epistemic uncertainty from the concentration of the Dirichlet distribution, with lower concentration indicating higher epistemic uncertainty. The decomposition of uncertainty may enable the system to identify cases where uncertainty could be reduced by collecting more training data, which would reduce epistemic uncertainty, versus cases where uncertainty is inherent to the prediction task and cannot be reduced through additional data, which corresponds to aleatoric uncertainty.

The device decision model may employ various temporal analysis approaches for analyzing time-series device telemetry data. Mobile device telemetry data may include sequences of measurements collected over time, such as battery voltage readings, temperature measurements, CPU utilization samples, and sensor outputs. Analyzing temporal patterns in this data may enable prediction of device degradation, detection of anomalous behavior, and estimation of remaining useful life. Different temporal analysis approaches may offer different tradeoffs in terms of computational efficiency, ability to capture long-range dependencies, and interpretability of learned representations.

In some cases, Temporal Convolutional Networks may be employed to process sequential diagnostic data. Temporal Convolutional Networks may process sequential diagnostic data with dilated causal convolutions, offering computational advantages over recurrent architectures. Unlike recurrent neural networks that process sequences one time step at a time and maintain hidden state across time steps, Temporal Convolutional Networks apply convolutional operations across the temporal dimension of the input sequence. The convolutional operations may be parallelized across time steps, enabling more efficient computation on modern hardware accelerators compared to the inherently sequential processing of recurrent architectures.

Temporal Convolutional Networks may employ causal convolutions that ensure the output at each time step depends only on inputs from the current and previous time steps, not on future inputs. Causal convolutions may be implemented by padding the input sequence and shifting the convolutional output so that predictions at each time step are based only on information available up to that time step. This causal structure may be appropriate for real-time processing of device telemetry where predictions must be made based on data available at the current time without access to future observations.

Temporal Convolutional Networks may employ dilated convolutions to increase the receptive field of the network without increasing the number of parameters or computational cost proportionally. In dilated convolutions, the convolutional filter is applied to input elements that are spaced apart by a dilation factor rather than to consecutive elements. By stacking layers with exponentially increasing dilation factors, Temporal Convolutional Networks may achieve large receptive fields that span long sequences while maintaining a manageable number of layers and parameters. The large receptive field may enable Temporal Convolutional Networks to capture long-range temporal dependencies in device telemetry, such as gradual degradation trends that unfold over extended time periods.

In some cases, transformer-based time-series models may be employed to analyze device telemetry data. Transformer-based time-series models may leverage self-attention to capture long-range dependencies in device usage patterns without the sequential processing constraints of recurrent architectures such as Long Short-Term Memory networks. The self-attention mechanism computes attention weights between all pairs of positions in the input sequence, enabling the model to directly relate distant time steps without requiring information to propagate through intermediate time steps as in recurrent architectures.

Transformer-based time-series models may process the entire input sequence in parallel, computing attention weights and producing outputs for all time steps simultaneously. This parallel processing may enable more efficient computation compared to recurrent architectures that must process time steps sequentially. The self-attention mechanism may also enable transformer-based models to capture dependencies between time steps that are far apart in the sequence, which may be relevant for detecting patterns in device telemetry that span extended time periods.

Transformer-based time-series models may employ positional encodings to provide information about the temporal ordering of input elements. Since the self-attention mechanism is permutation-invariant and does not inherently encode position information, positional encodings may be added to the input representations to indicate the position of each element in the sequence. Positional encodings may be fixed functions of position, such as sinusoidal functions, or may be learned parameters. The positional encodings may enable the model to distinguish between patterns that occur at different times and to learn temporal relationships between events.

In some cases, state-space models may be employed to analyze device telemetry data. State-space models may provide interpretable representations of device degradation dynamics. State-space models represent the evolution of a system over time in terms of a latent state that evolves according to a state transition function and observations that are generated from the latent state according to an observation function. The latent state may represent underlying device condition that is not directly observable but that influences the observed telemetry measurements.

State-space models may decompose observed telemetry signals into components such as trend, seasonality, and noise. The trend component may represent gradual changes in device condition over time, such as battery capacity degradation or sensor drift. The seasonality component may represent periodic patterns in device usage, such as daily or weekly usage cycles. The noise component may represent random variation in measurements that does not reflect underlying device condition. By decomposing telemetry signals into these components, state-space models may provide interpretable representations that enable understanding of the factors driving observed measurements.

State-space models may be estimated using techniques such as Kalman filtering, which provides optimal estimates of the latent state given the observed measurements under assumptions of linear dynamics and Gaussian noise. For nonlinear dynamics or non-Gaussian noise, extensions such as extended Kalman filtering or particle filtering may be employed. The estimated latent state may be used to predict future device behavior, detect anomalies when observations deviate from expected values given the estimated state, or estimate remaining useful life based on the trajectory of the latent state.

In some cases, changepoint detection algorithms may be employed to analyze device telemetry data. Changepoint detection algorithms may identify sudden shifts in device behavior indicative of component failures or damage events. A changepoint is a time point at which the statistical properties of a time series change, such as a change in mean, variance, or trend. Changepoints in device telemetry may correspond to events such as component failures, physical damage, software updates, or changes in usage patterns.

Changepoint detection algorithms may operate by comparing the statistical properties of the time series before and after candidate changepoint locations. Algorithms may search for changepoints that maximize a measure of difference between the segments before and after the changepoint, subject to penalties for the number of changepoints to avoid overfitting. Common approaches include binary segmentation, which recursively partitions the time series by identifying the most significant changepoint and then recursively analyzing the resulting segments, and dynamic programming approaches that find the optimal set of changepoints by considering all possible segmentations.

Changepoint detection may be applied to device telemetry to identify events that affect device condition or value. For example, a sudden increase in battery internal resistance may indicate battery degradation or damage. A sudden change in accelerometer baseline readings may indicate physical impact or sensor damage. A sudden change in CPU temperature patterns may indicate thermal management system degradation. Detecting these changepoints may enable timely identification of device issues and may inform decisions about device routing, repair, or value assessment.

In some cases, wavelet transforms may be employed to analyze device telemetry data. Wavelet transforms may decompose telemetry signals into frequency components, enabling detection of periodic patterns or anomalies at multiple time scales. Unlike Fourier transforms that decompose signals into frequency components with global support, wavelet transforms decompose signals into components that are localized in both time and frequency. This localization may enable detection of transient events or patterns that occur at specific times and frequencies.

Wavelet transforms may represent a signal as a sum of wavelet basis functions at different scales and positions. The scale parameter controls the frequency content of the wavelet, with larger scales corresponding to lower frequencies and smaller scales corresponding to higher frequencies. The position parameter controls the location of the wavelet in time. The wavelet coefficients at each scale and position indicate the similarity between the signal and the wavelet basis function at that scale and position.

Wavelet transforms may be applied to device telemetry to detect patterns at multiple time scales. Low-frequency components may capture long-term trends such as gradual battery degradation or sensor drift. High-frequency components may capture short-term variations such as noise, transient events, or periodic patterns related to device usage cycles. Anomalies may be detected by identifying wavelet coefficients that deviate from expected patterns at particular scales and positions. Multi-scale analysis may enable detection of anomalies that manifest at specific time scales, such as periodic faults that occur at particular frequencies or transient events that produce characteristic high-frequency signatures.

In some cases, Hidden Markov Models may be employed to analyze device telemetry data. Hidden Markov Models may model discrete device health states and transition probabilities for prognostic applications. A Hidden Markov Model represents a system as evolving through a sequence of discrete hidden states, where the transitions between states follow a Markov process and the observations at each time step are generated probabilistically from the current hidden state. The hidden states may represent discrete device health conditions, such as healthy, degraded, or failed states, or may represent more granular condition levels.

Hidden Markov Models may be characterized by initial state probabilities that specify the probability of starting in each hidden state, transition probabilities that specify the probability of transitioning from each state to each other state, and emission probabilities that specify the probability of observing each possible observation given each hidden state. Given a sequence of observations, inference algorithms such as the forward-backward algorithm may compute the probability of being in each hidden state at each time step. The Viterbi algorithm may compute the most likely sequence of hidden states given the observations.

Hidden Markov Models may be applied to device telemetry for prognostic applications by modeling the progression of device health through discrete states. The transition probabilities may capture the dynamics of device degradation, including the probability of transitioning from healthy to degraded states or from degraded to failed states. Given observed telemetry data, the model may estimate the current health state of the device and predict the probability of transitioning to failure states in the future. The estimated state probabilities and predicted transition probabilities may inform decisions about device routing, maintenance scheduling, or remaining useful life estimation.

The device decision model may employ various computer vision approaches for analyzing device photographs to assess cosmetic condition, detect damage, and inform routing and valuation decisions. Device photographs may be captured during intake, inspection, or at various points in the aftermarket lifecycle, and may include images of device screens, backs, edges, corners, and other surfaces. Different computer vision approaches may offer different capabilities for extracting information from these images, ranging from detection and localization of damage to pixel-level characterization of affected areas.

In some cases, object detection architectures may be employed to localize and classify multiple damage types within a single device image. Object detection architectures may identify the location and type of damage instances present in an image, producing bounding boxes that indicate the spatial extent of each detected damage instance along with class labels that indicate the type of damage. Object detection may enable automated identification of damage such as screen cracks, scratches, dents, chips, and discoloration within device photographs.

In some cases, YOLO (You Only Look Once) architectures may be employed for object detection in device images. YOLO architectures process the entire image in a single forward pass through the network, dividing the image into a grid and predicting bounding boxes and class probabilities for each grid cell. The single-pass processing may enable real-time detection speeds suitable for high-throughput device inspection workflows. YOLO architectures may detect multiple damage instances of different types within a single image, producing a set of bounding boxes with associated damage type classifications and confidence scores.

In some cases, Faster R-CNN (Region-based Convolutional Neural Network) architectures may be employed for object detection in device images. Faster R-CNN architectures employ a two-stage detection process comprising a region proposal network that identifies candidate regions likely to contain objects of interest, followed by a classification and bounding box regression network that refines the proposals and assigns class labels. The two-stage approach may provide higher detection accuracy compared to single-stage detectors, which may be beneficial when precise localization of damage is required for downstream processing decisions. Faster R-CNN architectures may be trained on labeled datasets of device images with annotated damage locations and types.

In some cases, semantic segmentation models may be employed to provide pixel-level damage maps for device images. Semantic segmentation models may assign a class label to each pixel in an image, producing a dense prediction that indicates the damage type or condition at every location in the image. Unlike object detection that produces bounding boxes around damage regions, semantic segmentation may delineate the precise boundaries of damaged areas, enabling accurate quantification of the affected area as a percentage of the total surface area or in absolute units.

Semantic segmentation models may be implemented using encoder-decoder architectures where an encoder network extracts hierarchical features from the input image and a decoder network upsamples the features to produce a full-resolution segmentation map. Skip connections between encoder and decoder layers may preserve spatial detail that would otherwise be lost during downsampling in the encoder. Semantic segmentation models may be trained on datasets of device images with pixel-level annotations indicating the damage type at each pixel location.

The pixel-level damage maps produced by semantic segmentation may enable precise quantification of affected areas. For example, the segmentation map may indicate that a screen crack affects a certain percentage of the display area, or that scratches cover a certain area of the device back. This quantitative information may inform grading decisions, value estimates, and repair cost predictions by providing objective measurements of damage extent rather than subjective assessments.

In some cases, instance segmentation may be employed to distinguish between multiple separate damage instances of the same type within a device image. Instance segmentation combines the capabilities of object detection and semantic segmentation, producing both a segmentation mask for each detected object and a distinct identity for each object instance. While semantic segmentation assigns the same class label to all pixels belonging to the same damage type regardless of whether they belong to the same or different damage instances, instance segmentation may distinguish between separate instances.

Instance segmentation may be valuable when multiple separate damage instances of the same type are present on a device. For example, a device screen may have multiple separate cracks that do not connect to each other, or a device back may have multiple separate scratches in different locations. Instance segmentation may identify each crack or scratch as a separate instance, enabling counting of damage instances and characterization of each instance individually. The number and characteristics of separate damage instances may inform repair decisions, as multiple separate instances may require different repair approaches than a single larger instance.

In some cases, depth estimation networks may be employed to infer three-dimensional surface characteristics from two-dimensional device images. Depth estimation networks may predict the distance from the camera to each point in the image, producing a depth map that represents the three-dimensional structure of the imaged surface. Depth estimation may improve detection of damage types that involve three-dimensional deformation of the device surface, such as dents, warping, or bending, which may not be readily apparent from two-dimensional image analysis alone.

Depth estimation networks may be trained on datasets that include images paired with ground truth depth information obtained from depth sensors or structured light systems. Alternatively, depth estimation networks may be trained using self-supervised techniques that leverage geometric constraints from stereo image pairs or video sequences to learn depth prediction without explicit depth supervision. Monocular depth estimation networks may predict depth from a single image by learning to recognize visual cues that correlate with depth, such as texture gradients, occlusion patterns, and perspective effects.

The depth maps produced by depth estimation networks may enable detection of surface deformations that affect device condition and value. Dents in the device body may appear as localized depressions in the depth map. Warping or bending of the device may appear as deviations from the expected flat surface profile. Screen lifting or separation may appear as discontinuities in the depth map at the edges of the display. Detecting these three-dimensional defects may enable more comprehensive condition assessment than two-dimensional image analysis alone.

In some cases, super-resolution techniques may be employed to enhance low-quality device images before damage assessment. Super-resolution techniques may increase the effective resolution of images by predicting high-frequency detail that is not present in the original low-resolution input. Device images captured under suboptimal conditions, such as images from low-resolution cameras, images captured at a distance, or images affected by motion blur, may lack the detail required for accurate damage detection. Super-resolution may recover or synthesize this detail to enable more accurate analysis.

Super-resolution networks may be trained on pairs of low-resolution and high-resolution images, learning to predict the high-resolution version given the low-resolution input. The networks may learn to recognize patterns in low-resolution images that correspond to specific high-frequency details in the high-resolution versions. During inference, the trained network may be applied to low-resolution device images to produce enhanced versions with greater detail. The enhanced images may then be processed by damage detection models that may achieve higher accuracy on the enhanced images compared to the original low-resolution inputs.

In some cases, generative adversarial networks may be employed to simulate the appearance of devices after cosmetic restoration. Generative adversarial networks comprise a generator network that produces synthetic images and a discriminator network that distinguishes between real and synthetic images. The generator and discriminator are trained adversarially, with the generator learning to produce increasingly realistic images that fool the discriminator. Generative adversarial networks may be trained to transform images of damaged devices into images showing the predicted appearance after cosmetic restoration such as buffing, polishing, or screen replacement.

The simulated post-restoration images produced by generative adversarial networks may support value-add potential predictions. By visualizing the expected appearance of a device after cosmetic restoration, the system may estimate the improvement in device grade and the corresponding increase in resale value. This information may inform decisions about whether to perform cosmetic restoration on a device, by comparing the expected value increase against the cost of the restoration service. Generative adversarial networks may be trained on paired datasets of device images before and after cosmetic restoration, learning the mapping between damaged and restored appearances.

In some cases, Siamese networks may be employed to compare device images against reference images of pristine devices to quantify deviation from expected condition. Siamese networks comprise two or more identical subnetworks that share weights and process different inputs in parallel, producing embeddings that can be compared to measure similarity or distance between the inputs. In the context of device condition assessment, one subnetwork may process an image of the device being assessed while another subnetwork processes a reference image of a pristine device of the same model.

Siamese networks may be trained using contrastive learning objectives that encourage the network to produce similar embeddings for images of devices in similar condition and dissimilar embeddings for images of devices in different conditions. The distance between embeddings may serve as a measure of how much the assessed device deviates from pristine condition. This deviation measure may inform grading decisions and value estimates by providing a quantitative comparison against a reference standard. Siamese networks may be particularly useful for detecting subtle deviations from expected condition that may not be captured by damage detection models trained to identify specific damage types.

The device decision model may employ various natural language processing approaches for processing textual device data collected throughout the mobile device lifecycle. Textual device data may include customer reviews, support tickets, diagnostic reports, repair notes, warranty claim descriptions, and technical documentation. Different natural language processing approaches may offer different tradeoffs in terms of computational efficiency, domain specificity, and capability for different text processing tasks.

In some cases, smaller, distilled language models may be employed to provide efficient inference for deployment in resource-constrained environments. Distilled language models are compact models that have been trained to approximate the behavior of larger teacher models while requiring fewer parameters and less computational resources. Knowledge distillation for language models may involve training a smaller student model to match the output probability distributions of a larger pre-trained language model across a corpus of text data. The distillation process may transfer the linguistic knowledge captured by the larger model into a more compact representation that can execute efficiently on devices with limited memory, processing power, or energy budgets.

Distilled language models may enable deployment of natural language processing capabilities on client devices such as tablets or smartphones used by repair technicians, warehouse operators, or field service personnel. By executing inference locally on the client device rather than requiring network communication with server-based models, distilled language models may reduce latency and enable operation in environments with limited or intermittent network connectivity. Distilled language models may also reduce the computational cost of processing large volumes of textual device data in server environments by providing faster inference compared to larger models while maintaining acceptable accuracy for many text processing tasks.

In some cases, domain-adapted language models fine-tuned on mobile device repair documentation may be employed to improve extraction of technical insights from diagnostic logs. General-purpose language models pre-trained on broad corpora of text data may lack familiarity with the specialized terminology, abbreviations, and conventions used in mobile device repair and aftermarket operations. Domain adaptation may involve fine-tuning a pre-trained language model on a corpus of domain-specific text data, such as repair manuals, diagnostic log formats, technical specifications, and repair technician notes.

Domain-adapted language models may learn the meanings of technical terms specific to mobile device repair, such as component names, failure mode descriptions, diagnostic codes, and repair procedure terminology. Domain-adapted language models may also learn the typical structure and content of domain-specific documents, such as the format of diagnostic logs produced by particular diagnostic tools or the conventions used in repair technician notes. This domain-specific knowledge may enable more accurate extraction of information from technical documents and more appropriate generation of text in domain-specific contexts.

Fine-tuning for domain adaptation may involve continued training of a pre-trained language model on domain-specific text data using the same or similar training objectives as the original pre-training. The fine-tuning process may adjust the model parameters to better represent the vocabulary, syntax, and semantics of the target domain while retaining the general linguistic knowledge acquired during pre-training. Domain-adapted language models may be fine-tuned for specific downstream tasks such as information extraction, classification, or summarization after the initial domain adaptation phase.

In some cases, named entity recognition models may be employed to automatically extract device components, failure modes, and repair actions from unstructured text. Named entity recognition is a natural language processing task that involves identifying and classifying named entities mentioned in text into predefined categories. In the context of mobile device aftermarket operations, relevant entity categories may include device components such as display, battery, camera, and speaker; failure modes such as cracked screen, battery drain, and boot loop; repair actions such as screen replacement, battery replacement, and firmware update; device models and manufacturers; part numbers; and diagnostic codes.

Named entity recognition models may be trained on annotated text data where entity mentions have been labeled with their corresponding categories. The training data may include diagnostic logs, repair notes, customer reviews, and support tickets with annotations indicating the locations and types of entity mentions. Named entity recognition models may employ sequence labeling architectures that assign a label to each token in the input text, with labels indicating whether each token is part of an entity mention and if so, what type of entity. Common sequence labeling schemes include BIO (Beginning, Inside, Outside) tagging where tokens are labeled as the beginning of an entity, inside an entity, or outside any entity.

Named entity recognition models may be implemented using neural network architectures such as bidirectional recurrent neural networks or transformer-based models that process the input text and produce contextualized representations for each token. A classification layer may then assign entity labels to each token based on its contextualized representation. Pre-trained language models may be fine-tuned for named entity recognition by adding a token classification layer and training on annotated domain-specific data.

The entities extracted by named entity recognition models may be used to populate structured databases, enable structured querying of unstructured text collections, and support downstream analysis tasks. For example, extracted component and failure mode entities may be aggregated to identify common failure patterns across device models. Extracted repair action entities may be linked to cost and outcome data to analyze the effectiveness of different repair approaches. Extracted entities may also be used to automatically route documents to appropriate processing workflows based on the entities mentioned.

In some cases, extractive or abstractive summarization models may be employed to condense lengthy repair histories into concise summaries. Repair histories for mobile devices may accumulate over multiple service events, resulting in lengthy records that are time-consuming for human operators to review. Summarization models may produce condensed versions of these records that capture the most relevant information while omitting redundant or less important details.

Extractive summarization models may produce summaries by selecting and concatenating sentences or passages from the source document that are deemed most relevant or informative. Extractive summarization may involve scoring each sentence in the source document based on features such as position, length, presence of relevant keywords, or similarity to the document as a whole, and then selecting the highest-scoring sentences to form the summary. Neural extractive summarization models may learn to score sentences based on their content and context using neural network architectures that process the document and produce relevance scores for each sentence.

Abstractive summarization models may produce summaries by generating new text that paraphrases or synthesizes information from the source document. Unlike extractive summarization that is limited to selecting existing sentences, abstractive summarization may produce novel phrasings that more concisely express the content of the source document. Abstractive summarization models may be implemented using encoder-decoder architectures where an encoder processes the source document and a decoder generates the summary text. Transformer-based models may be pre-trained on large summarization datasets and fine-tuned on domain-specific repair history data.

Summarization models may be configured to produce summaries of different lengths or levels of detail depending on the use case. Brief summaries may provide a quick overview of device history for initial triage decisions. More detailed summaries may provide comprehensive information for repair planning or customer communication. Summarization models may also be configured to focus on particular aspects of the repair history, such as summarizing only the diagnostic findings, only the repair actions taken, or only the customer-reported issues.

In some cases, question-answering systems may be employed to enable structured querying of device documentation and repair manuals. Question-answering systems may accept natural language questions as input and produce answers extracted from or generated based on a corpus of reference documents. In the context of mobile device aftermarket operations, question-answering systems may enable repair technicians, customer service representatives, or other stakeholders to quickly find information in technical documentation without manually searching through lengthy documents.

Question-answering systems may be implemented using retrieval-based approaches, generative approaches, or hybrid approaches that combine retrieval and generation. Retrieval-based question-answering systems may search a corpus of documents to find passages that are relevant to the input question, and then extract or highlight the answer within the retrieved passages. The retrieval component may use techniques such as dense passage retrieval that encodes questions and passages into vector representations and retrieves passages with representations similar to the question representation.

Generative question-answering systems may generate answer text directly based on the input question and relevant context, without being limited to extracting text verbatim from source documents. Generative systems may synthesize information from multiple sources or produce answers that paraphrase source content in a more direct or accessible form. Generative question-answering may be implemented using large language models that are provided with the question and relevant context as input and generate the answer as output.

Question-answering systems may be applied to various types of device documentation and repair manuals. Repair technicians may query technical manuals to find procedures for specific repair tasks, specifications for replacement parts, or troubleshooting guidance for particular symptoms. Customer service representatives may query knowledge bases to find answers to customer questions about device features, warranty coverage, or repair options. Quality assurance personnel may query documentation to verify that repair procedures comply with manufacturer guidelines or regulatory requirements.

In some cases, multilingual models may be employed to process customer reviews and diagnostic reports in multiple languages, supporting global aftermarket operations. Mobile device aftermarket operations may span multiple countries and regions where different languages are spoken. Customer reviews, support tickets, and diagnostic reports may be written in various languages depending on the geographic origin of the device or the language preferences of the user or technician who created the document.

Multilingual language models may be pre-trained on text data from multiple languages, learning representations that capture linguistic patterns across languages. Multilingual models may enable processing of text in multiple languages using a single model, rather than requiring separate models for each language. This may simplify deployment and maintenance of natural language processing capabilities in global operations by reducing the number of models that must be trained, deployed, and updated.

Multilingual models may support various natural language processing tasks across languages, including text classification, named entity recognition, summarization, and question-answering. For some tasks, multilingual models may be fine-tuned on task-specific data in one or more languages and then applied to text in other languages through cross-lingual transfer. Cross-lingual transfer may enable application of natural language processing capabilities to languages for which limited task-specific training data is available, by leveraging knowledge learned from data in other languages.

Multilingual models may also support translation between languages, enabling consolidation of textual device data from multiple languages into a common language for unified analysis. Translation may enable aggregation of customer feedback, diagnostic findings, and repair outcomes across geographic regions to identify global patterns and trends. Translation may also enable communication of analysis results and recommendations to stakeholders who speak different languages than the language of the source data.

The device decision model may employ various reinforcement learning configurations for channel selection and workflow optimization in mobile device aftermarket operations. Reinforcement learning enables agents to learn decision-making policies through interaction with an environment, receiving feedback in the form of rewards or penalties based on the outcomes of actions. Different reinforcement learning configurations may offer different tradeoffs in terms of sample efficiency, training stability, computational requirements, and suitability for different decision-making contexts. The selection of reinforcement learning configuration may depend on the characteristics of the decision problem, the availability of training data, and the computational resources available.

In some cases, multi-armed bandit algorithms may be employed for channel selection when state complexity is limited. Multi-armed bandit algorithms address the exploration-exploitation tradeoff in sequential decision-making problems where an agent must choose among multiple options, referred to as arms, and receive rewards based on the chosen option. The agent must balance exploration of different options to learn their reward distributions against exploitation of options that have yielded high rewards in the past. Multi-armed bandit algorithms may provide simpler exploration-exploitation tradeoffs compared to full reinforcement learning approaches that model complex state spaces and state transitions.

In the context of channel selection for mobile device aftermarket operations, each available sales channel such as direct-to-consumer platforms, wholesale markets, or specific retail partners may be modeled as an arm of the bandit. The reward for selecting a channel may be based on the realized sale price, time to sale, or a combination of factors that reflect the value recovered from the device through that channel. Multi-armed bandit algorithms may learn which channels tend to yield higher rewards and allocate devices to channels accordingly, while continuing to explore alternative channels to detect changes in channel performance over time.

Multi-armed bandit algorithms may include epsilon-greedy strategies that select the estimated best arm with probability one minus epsilon and select a random arm with probability epsilon, providing a simple mechanism for balancing exploration and exploitation. Upper confidence bound algorithms may select arms based on an optimistic estimate of their value that accounts for uncertainty, naturally exploring arms with high uncertainty while exploiting arms with high estimated value. Thompson sampling may maintain probability distributions over arm values and select arms by sampling from these distributions, providing a Bayesian approach to exploration that adapts to the observed reward history.

Multi-armed bandit algorithms may be extended to contextual bandits that condition arm selection on contextual features describing the current decision situation. In the context of channel selection, contextual features may include device characteristics such as model, condition grade, and age, as well as market conditions such as current prices and inventory levels across channels. Contextual bandit algorithms may learn policies that select different channels for devices with different characteristics, enabling personalized channel routing that accounts for how device characteristics affect performance in different channels.

In some cases, actor-critic methods may be employed for reinforcement learning in mobile device aftermarket operations. Actor-critic methods comprise two components: an actor that learns a policy mapping states to actions, and a critic that learns a value function estimating the expected cumulative reward from each state or state-action pair. The critic provides feedback to the actor about the quality of its actions, enabling the actor to improve its policy based on this feedback. Actor-critic methods may offer more stable training compared to value-based methods such as Deep Q-Networks for problems involving continuous action spaces or high-dimensional state spaces.

Advantage Actor-Critic (A2C) is an actor-critic method that uses the advantage function, which measures how much better an action is compared to the average action in a given state, to reduce variance in policy gradient estimates. A2C may train multiple parallel actors that interact with separate instances of the environment, collecting experience that is used to update a shared policy and value function. The parallel training may improve sample efficiency and training stability by providing diverse experience from multiple environment instances.

Proximal Policy Optimization (PPO) is an actor-critic method that constrains policy updates to prevent large changes that could destabilize training. PPO uses a clipped objective function that limits the ratio between the new policy and the old policy, preventing updates that would change the policy too drastically in a single step. The clipping mechanism may provide more stable training compared to methods that allow unconstrained policy updates, which may be beneficial when training on complex decision problems with high-dimensional state and action spaces.

Actor-critic methods such as A2C and PPO may be applied to workflow optimization in mobile device aftermarket operations. The state may represent the current status of devices in the processing pipeline, including device characteristics, current processing stage, and resource availability. The action may represent decisions about how to route devices through processing steps, allocate resources to different tasks, or schedule processing activities. The reward may reflect processing efficiency, recovery value, or other objectives that the workflow optimization seeks to achieve. Actor-critic methods may learn policies that make effective workflow decisions across the range of situations encountered in device processing operations.

In some cases, model-based reinforcement learning may be employed to learn environment dynamics and enable planning for mobile device aftermarket decision-making. Model-based reinforcement learning approaches learn a model of the environment that predicts how the environment state will change in response to actions, and use this model to plan actions that achieve desired outcomes. By learning environment dynamics, model-based reinforcement learning may reduce sample complexity compared to model-free approaches that learn policies directly from experience without explicitly modeling the environment.

In the context of mobile device aftermarket operations, the environment model may predict how device processing decisions affect outcomes such as processing time, repair costs, and recovery value. The model may capture relationships between device characteristics, processing actions, and outcomes based on historical data from device processing operations. For example, the model may predict how routing a device with particular characteristics through a particular repair workflow will affect the time to complete processing and the expected sale price of the repaired device.

Model-based reinforcement learning may use the learned environment model to perform planning, which involves simulating the effects of different action sequences to identify actions that lead to desirable outcomes. Planning may be performed using techniques such as model predictive control, which optimizes actions over a planning horizon by simulating the predicted effects of candidate action sequences and selecting the sequence with the best predicted outcome. Tree search methods may explore the space of possible action sequences by building a tree of states and actions and evaluating the expected outcomes of different branches.

Model-based reinforcement learning may enable more sample-efficient learning compared to model-free approaches by leveraging the learned model to generate simulated experience for policy improvement. Rather than requiring real interactions with the environment to learn from, the agent may use the model to simulate interactions and learn from the simulated experience. This may be particularly valuable in mobile device aftermarket operations where real interactions involve processing actual devices and incurring real costs, making extensive exploration through real interactions expensive or impractical.

In some cases, hierarchical reinforcement learning may be employed to decompose complex routing decisions into sub-policies for different decision stages. Hierarchical reinforcement learning structures the decision-making process into multiple levels, with higher-level policies selecting goals or sub-tasks and lower-level policies executing actions to achieve those goals or sub-tasks. The hierarchical structure may enable more efficient learning by decomposing complex problems into simpler sub-problems that can be learned independently or with less data.

In the context of mobile device aftermarket operations, hierarchical reinforcement learning may decompose device routing decisions into multiple levels. A high-level policy may make strategic decisions about the overall disposition of a device, such as whether to repair and resell, recycle, or route to wholesale liquidation. Mid-level policies may make tactical decisions within each disposition pathway, such as selecting specific repair workflows or choosing among available sales channels. Low-level policies may make operational decisions about specific processing steps, such as scheduling individual repair tasks or selecting shipping options.

The hierarchical structure may enable temporal abstraction, where high-level policies operate over longer time horizons and make decisions less frequently, while low-level policies operate over shorter time horizons and make decisions more frequently. Temporal abstraction may improve learning efficiency by reducing the effective length of decision sequences that must be learned, as high-level policies need only learn to select among a smaller set of sub-goals rather than learning to select among all possible low-level action sequences.

Hierarchical reinforcement learning may also enable transfer and reuse of learned sub-policies across different contexts. Sub-policies learned for specific sub-tasks, such as policies for selecting repair workflows or policies for selecting sales channels, may be reused across different high-level decision contexts. This reuse may improve learning efficiency when new decision problems share sub-tasks with previously learned problems, as the agent may leverage previously learned sub-policies rather than learning from scratch.

In some cases, offline reinforcement learning techniques may be employed to train policies from historical decision logs without requiring online interaction with the environment. Offline reinforcement learning, also referred to as batch reinforcement learning, learns policies from a fixed dataset of previously collected experience rather than through ongoing interaction with the environment. Offline reinforcement learning may be valuable in mobile device aftermarket operations where historical data from past device processing decisions is available but online experimentation with new policies may be costly, risky, or impractical.

Historical decision logs from mobile device aftermarket operations may include records of past device processing decisions, including the characteristics of devices processed, the routing and processing decisions made, and the outcomes achieved such as processing times, costs, and recovery values. Offline reinforcement learning may learn policies from this historical data that improve upon the policies that generated the data, identifying decision patterns that led to better outcomes and learning to replicate or extend those patterns.

Offline reinforcement learning faces challenges related to distribution shift, where the learned policy may encounter states or take actions that are not well represented in the historical data. When the learned policy deviates from the behavior that generated the historical data, the value estimates used to guide policy learning may become inaccurate because the historical data does not provide information about the outcomes of the new actions. Offline reinforcement learning algorithms may address distribution shift through techniques such as conservative value estimation that penalizes value estimates for actions that are not well supported by the historical data, or through policy constraints that limit how much the learned policy can deviate from the behavior policy that generated the data.

Offline reinforcement learning may enable policy learning without the risks associated with online exploration. In mobile device aftermarket operations, online exploration would involve making experimental decisions about real devices, which could result in suboptimal outcomes such as lower recovery values or longer processing times for the devices used in exploration. Offline reinforcement learning may learn improved policies from historical data without incurring these exploration costs, and the learned policies may be evaluated through simulation or limited pilot deployments before full-scale implementation.

In some cases, multi-agent reinforcement learning may be employed to coordinate decisions across multiple processing facilities or market channels. Multi-agent reinforcement learning addresses decision-making problems involving multiple agents that interact within a shared environment, where the actions of each agent may affect the outcomes experienced by other agents. In mobile device aftermarket operations, multiple processing facilities, sales channels, or organizational units may make decisions that affect shared resources, market conditions, or overall system performance.

Multi-agent reinforcement learning may model each processing facility or market channel as an agent that makes local decisions about device routing, processing, or sales. The agents may interact through shared resources such as inventory of replacement parts, shared market conditions such as prices that depend on aggregate supply across channels, or shared objectives such as overall organizational recovery value. Multi-agent reinforcement learning may learn policies for each agent that account for the interactions between agents and coordinate decisions to achieve better collective outcomes than would be achieved by agents optimizing independently.

Multi-agent reinforcement learning may employ cooperative, competitive, or mixed settings depending on the relationships between agents. In cooperative settings, agents share a common objective and seek to coordinate their actions to maximize the shared objective. In competitive settings, agents have opposing objectives and seek to maximize their own outcomes potentially at the expense of other agents. In mixed settings, agents may have partially aligned and partially conflicting objectives. Mobile device aftermarket operations may involve cooperative settings where multiple facilities within the same organization seek to maximize overall recovery value, or mixed settings where different organizational units have both shared and individual performance objectives.

Multi-agent reinforcement learning may employ centralized training with decentralized execution, where agents are trained using global information about all agents but execute their learned policies using only locally available information. During training, the learning algorithm may have access to the states, actions, and rewards of all agents, enabling learning of coordinated policies that account for agent interactions. During execution, each agent may execute its learned policy based only on its local observations, without requiring real-time communication with other agents. This approach may enable coordination while maintaining the scalability and robustness benefits of decentralized execution.

Multi-agent reinforcement learning may also employ communication mechanisms that enable agents to share information during execution. Agents may learn to communicate relevant information to other agents through learned communication protocols, enabling coordination based on shared information about local conditions, intentions, or predictions. Communication may enable more effective coordination in situations where local observations are insufficient for agents to infer the states or intentions of other agents. The communication protocols may be learned jointly with the decision policies, enabling agents to learn what information is valuable to share and how to use received information in decision-making.

The device decision model and associated AI components may be deployed using various edge and distributed computing architectures that address requirements for latency, bandwidth, privacy, scalability, and computational efficiency. The selection of deployment architecture may depend on the characteristics of the decision tasks, the computational resources available at different locations in the system, the sensitivity of the data being processed, and the variability of processing workloads over time.

In some cases, edge computing approaches may be employed to deploy lightweight models directly on mobile devices or processing facility hardware. Edge computing approaches may reduce latency by performing inference locally rather than requiring network round trips to remote servers. Edge computing approaches may also reduce network bandwidth requirements by processing data locally and transmitting only results or summaries rather than raw data. In the context of mobile device aftermarket operations, edge computing may enable real-time decision support for repair technicians, warehouse operators, or inspection personnel who require immediate feedback without delays introduced by network communication.

Edge deployment on mobile devices may enable device condition assessment applications that execute on smartphones or tablets used by field personnel. The applications may capture device images, collect diagnostic data, and perform inference using locally deployed models to provide immediate assessments of device condition, estimated value, or recommended routing. Local inference may enable operation in environments with limited or intermittent network connectivity, such as remote collection sites or facilities with restricted network access.

Edge deployment on processing facility hardware may enable integration of AI capabilities into inspection stations, diagnostic equipment, or processing line controllers. Lightweight models deployed on facility hardware may process device data as devices move through the processing pipeline, providing real-time routing decisions, quality assessments, or anomaly alerts without requiring communication with centralized servers. Edge deployment on facility hardware may reduce the infrastructure requirements for network connectivity and may improve system reliability by reducing dependence on network availability.

Lightweight models suitable for edge deployment may be developed through model compression techniques or through design of architectures that achieve acceptable accuracy with reduced computational requirements. The tradeoff between model accuracy and computational efficiency may be evaluated based on the requirements of specific edge deployment scenarios, with some scenarios tolerating reduced accuracy in exchange for lower latency or reduced resource consumption.

In some cases, federated learning frameworks may be employed to train models across distributed data sources without centralizing sensitive device data. Federated learning enables collaborative model training where multiple participants contribute to training a shared model while keeping their data local. Each participant trains the model on local data and shares model updates such as gradients or parameter changes with a central coordinator, which aggregates the updates to improve the shared model. The aggregated model improvements are then distributed back to participants for continued local training.

Federated learning may address privacy concerns in mobile device aftermarket operations by enabling model training without requiring device data to be transmitted to a central location. Device data may include sensitive information such as user data remnants, location histories, or usage patterns that participants may be unwilling or unable to share due to privacy regulations, contractual obligations, or competitive concerns. Federated learning may enable participants such as different processing facilities, repair vendors, or aftermarket channel partners to contribute to model training while maintaining control over their local data.

Federated learning may also enable training on data that is distributed across geographic regions or organizational boundaries. Different participants may have access to device data with different characteristics, such as devices from different markets, device models popular in different regions, or devices processed through different channels. Federated learning may enable the model to learn from this diverse data without requiring data consolidation, potentially improving model generalization across the range of devices and conditions encountered in global aftermarket operations.

Federated learning frameworks may employ techniques to address challenges such as non-independent and identically distributed data across participants, communication efficiency, and participant heterogeneity. Aggregation algorithms may weight participant contributions based on the amount or quality of local data. Communication compression techniques may reduce the bandwidth required for transmitting model updates. Asynchronous update protocols may accommodate participants with different computational capabilities or availability patterns.

In some cases, split inference architectures may be employed to partition model computation between edge devices and cloud servers. Split inference architectures may divide a model into portions that execute on different computing platforms, with earlier layers executing on edge devices and later layers executing on cloud servers, or with different model components executing on different platforms based on their computational requirements. Split inference may enable deployment of models that are too large or computationally intensive to execute entirely on edge devices while still providing some benefits of edge computing.

Split inference architectures may partition computation based on computational requirements, with computationally intensive operations such as large matrix multiplications or convolutions executed on cloud servers with greater computational resources, while lighter operations such as preprocessing or postprocessing execute on edge devices. The partitioning may be designed to minimize the data that must be transmitted between edge and cloud, reducing bandwidth requirements and latency compared to transmitting raw input data to the cloud for complete inference.

Split inference architectures may also partition computation based on privacy constraints, with operations that process sensitive data executing on edge devices where the data remains local, while operations that process less sensitive intermediate representations execute on cloud servers. For example, initial layers of an image processing model may execute on an edge device to transform raw device images into abstract feature representations, and the feature representations may be transmitted to cloud servers for further processing. The feature representations may be less sensitive than the raw images and may be designed to preserve information relevant to the inference task while discarding information that could be used to reconstruct sensitive details.

The partitioning of computation in split inference architectures may be determined statically based on analysis of model structure and deployment constraints, or may be determined dynamically based on runtime conditions such as network bandwidth availability, edge device battery level, or cloud server load. Dynamic partitioning may adapt to changing conditions to maintain acceptable latency and accuracy while respecting resource constraints.

In some cases, model compression techniques may be employed to reduce model size and inference latency for deployment on resource-constrained platforms. Model compression techniques may enable deployment of models that would otherwise exceed the memory, storage, or computational capabilities of target platforms. Model compression may involve pruning, quantization, knowledge distillation, or combinations of these techniques.

Pruning may reduce model size by removing parameters that contribute little to model accuracy. Pruning may identify and remove individual weights, neurons, filters, or larger structural components based on criteria such as magnitude, gradient, or contribution to output. Unstructured pruning may remove individual weights, resulting in sparse weight matrices that may require specialized hardware or software support to achieve computational benefits. Structured pruning may remove entire neurons, filters, or layers, resulting in smaller dense models that may execute efficiently on standard hardware without specialized sparse computation support.

Quantization may reduce model size and computational requirements by representing model parameters and activations using lower-precision numerical formats. Models trained using standard floating-point precision such as thirty-two-bit floating point may be quantized to lower-precision formats such as sixteen-bit floating point, eight-bit integers, or even lower bit widths. Quantization may reduce memory requirements for storing model parameters, reduce memory bandwidth requirements for loading parameters during inference, and enable use of specialized low-precision arithmetic units that may provide higher throughput than floating-point units.

Quantization may be performed post-training by converting a trained floating-point model to lower precision, or may be incorporated into training through quantization-aware training that simulates the effects of quantization during training to enable the model to learn parameters that are robust to quantization error. Quantization-aware training may achieve higher accuracy at low bit widths compared to post-training quantization by enabling the model to adapt to the reduced precision during the learning process.

Knowledge distillation may reduce model size by training a smaller student model to approximate the behavior of a larger teacher model. The student model may be trained to match the outputs of the teacher model, including soft probability distributions that contain information about relationships between classes that is not present in hard labels. Knowledge distillation may enable training of compact models that achieve accuracy approaching that of larger models while requiring fewer parameters and less computation. Knowledge distillation may be combined with pruning and quantization to achieve further reductions in model size and computational requirements.

In some cases, containerized microservices architectures may be employed to deploy AI components in mobile device aftermarket operations. Containerized microservices architectures may decompose the AI system into independent services that communicate through well-defined interfaces, with each service packaged in a container that includes the service code and its dependencies. Containerization may enable consistent deployment across different computing environments and may simplify management of dependencies and configurations.

Containerized microservices architectures may enable independent scaling of different AI components based on their respective workloads. Different components of the AI system may experience different load patterns, with some components such as image analysis services experiencing high load during peak inspection periods while other components such as model training services experience load during scheduled training runs. Independent scaling may enable allocation of computational resources to each component based on its current demand, improving resource utilization compared to monolithic architectures where all components must be scaled together.

Containerized microservices architectures may also enable independent updating of different AI components. Individual services may be updated, tested, and deployed without requiring updates to other services, enabling more frequent and lower-risk updates compared to monolithic architectures where updates require coordinated changes across the entire system. Independent updating may enable rapid deployment of model improvements, bug fixes, or new capabilities to individual components while maintaining stability of other components.

Container orchestration platforms may manage deployment, scaling, and operation of containerized services across clusters of computing resources. Container orchestration may automate tasks such as service discovery, load balancing, health monitoring, and automatic restart of failed containers. Container orchestration may enable deployment of AI services across multiple computing nodes with automatic distribution of workload and failover in case of node failures.

In some cases, serverless computing platforms may be employed to provide elastic scaling for variable processing workloads in mobile device aftermarket operations. Serverless computing platforms may execute code in response to events or requests without requiring provisioning or management of server infrastructure. The serverless platform may automatically allocate computational resources to execute the code and may scale the allocation based on the volume of incoming requests, providing elastic scaling that adapts to workload variations.

Serverless computing may be suitable for AI inference workloads that experience variable demand, such as device assessment services that experience high demand during business hours and low demand during off-hours, or services that experience demand spikes during promotional periods or seasonal peaks in device trade-ins. Serverless platforms may scale up to handle demand spikes without requiring pre-provisioning of capacity, and may scale down during low-demand periods to reduce costs compared to continuously running server infrastructure.

Serverless computing platforms may impose constraints on execution time, memory, and other resources that may affect suitability for different AI workloads. Inference tasks with short execution times and moderate memory requirements may be well suited for serverless deployment. Tasks with longer execution times or larger memory requirements may require alternative deployment approaches or may require partitioning into smaller subtasks that fit within serverless constraints.

Serverless computing may be combined with other deployment approaches in hybrid architectures. Lightweight preprocessing or postprocessing tasks may execute on serverless platforms while computationally intensive inference tasks execute on dedicated server infrastructure or specialized accelerator hardware. The hybrid approach may leverage the elastic scaling benefits of serverless computing for variable-demand components while providing the computational capabilities required for intensive AI workloads.

The system may employ various application programming interface (API) and data integration protocols to receive downstream data from diverse sources throughout the mobile device lifecycle. Different integration protocols may offer different tradeoffs in terms of latency, reliability, flexibility, efficiency, and interoperability. The selection of integration protocol may depend on the characteristics of the data source, the volume and frequency of data transmission, the reliability requirements of the integration, and the technical capabilities of the downstream partners.

In some cases, webhook-based push notifications may be employed to enable real-time data ingestion from downstream partners. Webhooks are HTTP callbacks that transmit data to a specified URL when a triggering event occurs at the data source. Rather than requiring the receiving system to periodically poll the data source to check for new data, webhooks enable the data source to push data to the receiving system immediately when relevant events occur. Webhook-based integration may reduce latency between event occurrence and data availability in the receiving system compared to polling-based approaches.

Webhook-based push notifications may be configured by downstream partners such as repair vendors, secondary market platforms, trade-in programs, or insurance providers to transmit data when events relevant to mobile device lifecycle management occur. For example, a repair vendor may configure a webhook to transmit repair completion data when a device repair is completed, including details such as the device identifier, components replaced, repair cost, and diagnostic results. A secondary market platform may configure a webhook to transmit sales data when a device is sold, including the sale price, time to sale, and buyer information. The webhook payload may include structured data in formats such as JSON or XML that can be parsed and processed by the receiving system.

Webhook-based integration may require the receiving system to expose HTTP endpoints that can receive webhook payloads from downstream partners. The endpoints may implement authentication mechanisms to verify that incoming requests originate from authorized partners and have not been tampered with during transmission. Authentication mechanisms may include shared secrets, digital signatures, or mutual TLS authentication. The endpoints may also implement validation logic to verify that incoming payloads conform to expected schemas and contain valid data before processing.

Webhook-based integration may include retry mechanisms to handle transient failures in data transmission. If the receiving system is temporarily unavailable or returns an error response, the sending system may retry the webhook delivery after a delay. Retry policies may specify the number of retry attempts, the delay between attempts, and backoff strategies that increase the delay between successive retries. The receiving system may implement idempotency mechanisms to handle cases where the same webhook payload is delivered multiple times due to retries, ensuring that duplicate deliveries do not result in duplicate processing of the same event.

In some cases, message queue systems may be employed to provide reliable, scalable data streaming with guaranteed delivery for downstream data integration. Message queue systems provide asynchronous communication between data producers and consumers through intermediate message brokers that store and forward messages. Message queue systems may decouple data producers from consumers, enabling each to operate independently and at different rates without direct synchronization.

Message queue systems such as Apache Kafka may provide distributed, fault-tolerant message streaming with high throughput and low latency. Apache Kafka organizes messages into topics, with producers publishing messages to topics and consumers subscribing to topics to receive messages. Kafka may persist messages to disk and replicate messages across multiple broker nodes, providing durability and fault tolerance. Kafka may retain messages for a configurable retention period, enabling consumers to replay historical messages or recover from failures by reprocessing messages from a previous point in time.

Message queue systems such as RabbitMQ may provide message queuing with flexible routing and delivery guarantees. RabbitMQ implements the Advanced Message Queuing Protocol (AMQP) and supports various messaging patterns including point-to-point queues, publish-subscribe topics, and routing based on message attributes. RabbitMQ may provide delivery acknowledgments that enable producers to confirm that messages have been received and persisted by the broker, and may provide consumer acknowledgments that enable the broker to confirm that messages have been successfully processed by consumers before removing them from the queue.

Message queue systems may provide guaranteed delivery semantics that ensure messages are not lost even in the presence of failures. At-least-once delivery guarantees that each message is delivered to consumers at least once, though messages may be delivered multiple times in failure scenarios. Exactly-once delivery guarantees that each message is delivered to consumers exactly once, preventing both message loss and duplicate processing. The selection of delivery guarantee may depend on the requirements of the data integration and the ability of consumers to handle duplicate messages.

Message queue systems may enable scalable data streaming by distributing message processing across multiple consumer instances. Consumer groups may enable parallel processing of messages from a topic, with each message delivered to one consumer within the group. Adding consumer instances to a group may increase processing throughput to handle higher message volumes. Message queue systems may also enable buffering of messages during periods of high volume or consumer unavailability, with messages stored in the queue until consumers are available to process them.

In some cases, GraphQL APIs may be employed to enable flexible, client-specified data queries for downstream data integration. GraphQL is a query language for APIs that enables clients to specify the structure of the data they require, and servers to return data matching the specified structure. Unlike REST APIs where the server determines the structure of responses, GraphQL enables clients to request specific fields and nested relationships, reducing over-fetching of unnecessary data and under-fetching that would require multiple requests.

GraphQL APIs may enable downstream partners or client applications to query device data with flexibility in the data returned. A client may specify a query that requests specific device attributes such as device identifier, model, condition grade, and repair history, and the server may return a response containing the requested attributes. The client may also specify nested relationships, such as requesting a device along with its associated repair records and each repair record's associated cost breakdown. The server may resolve the query by fetching data from underlying data sources and assembling a response that matches the query structure.

GraphQL APIs may reduce over-fetching compared to REST APIs that return fixed response structures. In REST APIs, endpoints may return all attributes of a resource even when the client requires only a subset, resulting in transmission of unnecessary data. GraphQL enables clients to request only the attributes they require, reducing response size and network bandwidth consumption. Reduced over-fetching may be particularly beneficial for mobile clients or clients operating over limited-bandwidth connections.

GraphQL APIs may also reduce under-fetching compared to REST APIs that require multiple requests to fetch related data. In REST APIs, fetching a resource and its related resources may require multiple sequential requests, with each request incurring network latency. GraphQL enables clients to fetch a resource and its related resources in a single request by specifying the relationships in the query. Reduced under-fetching may improve client performance by reducing the number of network round trips required to fetch the data needed for a particular operation.

GraphQL APIs may implement schema definitions that specify the types of data available and the relationships between types. The schema may serve as a contract between the API and its clients, documenting the available data and enabling client tooling to validate queries against the schema. Schema definitions may also enable introspection, where clients can query the schema itself to discover available types and fields, supporting development of client applications that adapt to schema changes.

In some cases, gRPC protocols may be employed to provide efficient binary serialization for high-throughput data transfer in downstream data integration. gRPC is a remote procedure call framework that uses Protocol Buffers for message serialization and HTTP/2 for transport. gRPC may provide higher throughput and lower latency compared to text-based protocols such as REST with JSON serialization, making gRPC suitable for high-volume data integration scenarios.

Protocol Buffers provide binary serialization that encodes structured data into compact binary representations. Binary serialization may produce smaller message sizes compared to text-based formats such as JSON or XML, reducing network bandwidth consumption and transmission time. Binary serialization may also provide faster serialization and deserialization compared to text-based formats, reducing CPU overhead for encoding and decoding messages. Protocol Buffers use schema definitions that specify message structures, enabling code generation for client and server implementations in multiple programming languages.

gRPC uses HTTP/2 as its transport protocol, which provides features such as multiplexing, header compression, and bidirectional streaming. Multiplexing enables multiple concurrent requests and responses over a single TCP connection, reducing connection overhead compared to HTTP/1.1 where each request typically requires a separate connection or sequential processing on a shared connection. Header compression reduces the size of HTTP headers, which may be significant for APIs with many small messages. Bidirectional streaming enables both client and server to send multiple messages over a single connection, supporting streaming data integration patterns.

gRPC may support various communication patterns including unary calls where the client sends a single request and receives a single response, server streaming where the client sends a single request and receives a stream of responses, client streaming where the client sends a stream of requests and receives a single response, and bidirectional streaming where both client and server send streams of messages. Streaming patterns may be suitable for data integration scenarios involving continuous data flows, such as real-time telemetry streaming or batch data transfers.

gRPC may provide built-in support for features such as authentication, load balancing, and deadline propagation. Authentication mechanisms may include TLS for transport security and token-based authentication for request-level authorization. Load balancing may distribute requests across multiple server instances to improve throughput and availability. Deadline propagation may enable clients to specify timeouts that are propagated through chains of service calls, enabling coordinated timeout handling in distributed systems.

In some cases, blockchain-based data sharing may be employed to provide immutable audit trails for device history records. Blockchain technology provides distributed ledger systems where data is stored in blocks that are cryptographically linked to form a chain, with the chain replicated across multiple nodes in a network. The cryptographic linking and distributed replication may provide immutability, where data written to the blockchain cannot be altered or deleted without detection, and transparency, where all participants can verify the contents of the ledger.

Blockchain-based data sharing may provide immutable audit trails for mobile device lifecycle events. Device history records such as ownership transfers, repair events, condition assessments, and certification issuances may be recorded on a blockchain, creating a tamper-evident record of the device history. The immutability of blockchain records may provide assurance that device history has not been altered after the fact, which may increase trust in device provenance and condition claims in secondary market transactions.

Blockchain-based data sharing may enable multiple parties in the mobile device aftermarket ecosystem to contribute to and verify device history records without requiring a central trusted authority. Repair vendors, inspection facilities, secondary market platforms, and other participants may record events to the blockchain, with each participant able to verify the authenticity and integrity of records contributed by other participants. The distributed nature of blockchain may reduce dependence on any single party to maintain accurate records and may enable verification of device history even when the original recording party is no longer available.

Blockchain implementations may include public blockchains that are open to any participant, private blockchains that restrict participation to authorized parties, and consortium blockchains that are governed by a group of organizations. The selection of blockchain type may depend on requirements for openness, privacy, performance, and governance. Private or consortium blockchains may provide higher transaction throughput and lower latency compared to public blockchains, and may enable privacy controls that restrict visibility of certain data to authorized parties.

Blockchain-based data sharing may employ smart contracts to automate verification and enforcement of data sharing rules. Smart contracts are programs stored on the blockchain that execute automatically when specified conditions are met. Smart contracts may validate that submitted device history records conform to required schemas and contain valid data before recording them to the blockchain. Smart contracts may also implement access control rules that determine which parties can read or write particular types of records.

In some cases, standardized data exchange formats may be employed to improve interoperability across diverse downstream systems in mobile device aftermarket operations. Standardized data exchange formats define common structures and vocabularies for representing data, enabling different systems to exchange data without requiring custom integration for each pair of systems. Standardized formats may reduce integration complexity and enable participation of new downstream partners without requiring development of new custom integrations.

JSON-LD (JavaScript Object Notation for Linked Data) may be employed as a standardized data exchange format for mobile device lifecycle data. JSON-LD extends JSON with conventions for expressing linked data, enabling data to be connected across different sources and systems through the use of uniform resource identifiers (URIs) to identify entities and relationships. JSON-LD may be processed as standard JSON by systems that do not require linked data capabilities, while systems that support linked data may leverage the additional semantic information.

JSON-LD may employ schema.org vocabularies to provide standardized terms for describing mobile device data. Schema.org provides a collection of shared vocabularies that define types and properties for describing entities and their attributes. Schema.org vocabularies include types relevant to mobile device aftermarket operations, such as Product for describing devices, Offer for describing sales listings, and Organization for describing parties in the ecosystem. Using schema.org vocabularies may enable interoperability with systems that already support schema.org, including search engines and e-commerce platforms.

JSON-LD with schema.org vocabularies may enable semantic interoperability where different systems can understand the meaning of exchanged data even when using different internal data representations. By mapping internal data representations to shared schema.org terms, systems may exchange data that can be correctly interpreted by receiving systems without requiring bilateral agreement on data formats. Semantic interoperability may reduce the effort required to integrate new downstream partners and may enable aggregation and analysis of data from multiple sources using common vocabularies.

Standardized data exchange formats may be extended with domain-specific vocabularies that define terms specific to mobile device aftermarket operations. Domain-specific vocabularies may define types and properties for concepts such as device condition grades, repair actions, diagnostic results, and certification statuses that are not covered by general-purpose vocabularies such as schema.org. Domain-specific vocabularies may be published and maintained by industry organizations or consortia to enable consistent use across the ecosystem.

Standardized data exchange formats may include mechanisms for versioning and evolution to accommodate changes in vocabulary definitions over time. Versioning mechanisms may enable systems to indicate which version of a vocabulary they support and to handle data encoded using different vocabulary versions. Evolution mechanisms may enable addition of new terms and deprecation of obsolete terms while maintaining backward compatibility with systems using older vocabulary versions.

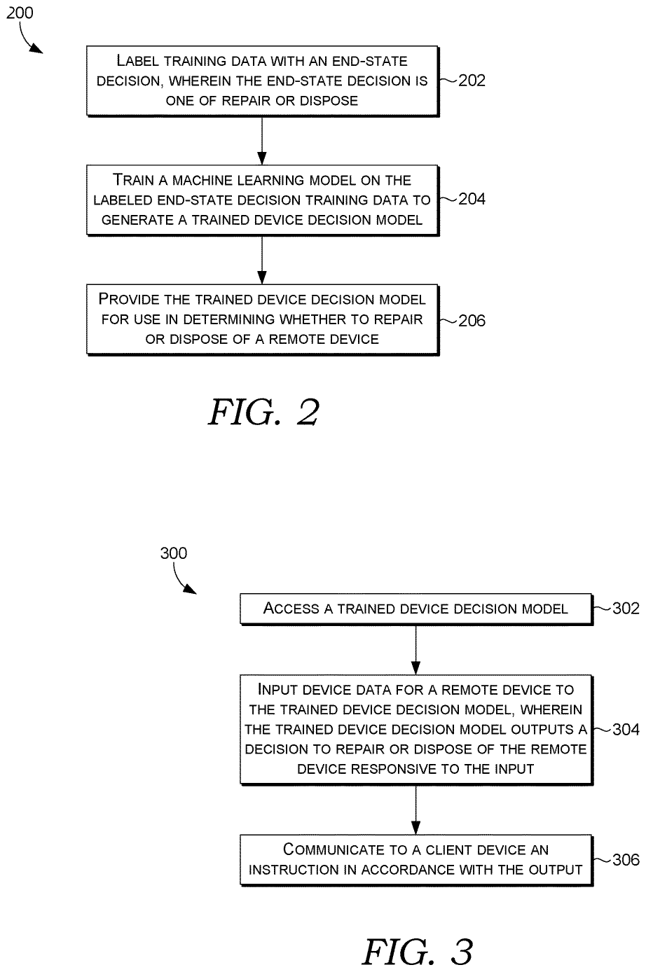

Referring now to FIG. 2, a method 200 for training a device decision model is illustrated. The method 200 may be performed by one or more computing devices, such as the server 102 of the operating environment 100 described with reference to FIG. 1. The method 200 may generate a trained device decision model that can be used to determine whether to repair or dispose of a mobile device based on device data collected throughout the device lifecycle.

The method 200 begins at a step 202 of labeling training data with an end-state decision. In the step 202, the end-state decision may be one of repair or dispose. The training data may include device data collected from one or more points throughout the lifecycle of a mobile device. The training data may include the remote device data 118, the physical access data 120, the downstream data 122, or the device user data 124 as described with reference to FIG. 1. The training data may be stored in the database 106 and accessed by the server 102 for labeling and subsequent model training.

In the step 202, the repair or dispose label may be manually assigned to a device based on review of the device or device data for the device. Human reviewers may examine device characteristics, diagnostic results, inspection findings, repair cost estimates, market value assessments, and other relevant factors to determine whether a device should be repaired or disposed. The dispose label may encompass various disposal pathways, including recycling, resale through secondary markets, wholesale liquidation, or other channels appropriate for devices that are not suitable for repair. The repair label may indicate that the device is a candidate for repair and subsequent resale or return to service.

The labeling process in the step 202 may generate a labeled dataset where each training example comprises device data associated with a corresponding end-state decision label. The labeled dataset may include examples of devices that were labeled for repair and examples of devices that were labeled for disposal, providing the machine learning model with examples of both decision outcomes. The distribution of repair and dispose labels in the labeled dataset may reflect the distribution of decisions encountered in actual device processing operations, or may be balanced to provide equal representation of both decision outcomes.

The method 200 proceeds to a step 204 of training a machine learning model on the labeled end-state decision training data from the step 202 to generate a trained device decision model. In the step 204, the machine learning model may be exposed to the labeled training data during the training process, where the model learns to identify patterns and relationships between the input device data and the end-state decision labels. The training process may employ supervised learning techniques where the model iteratively adjusts its parameters to minimize the error between its predictions and the actual labels in the training data.

In the step 204, the machine learning model may learn to associate device characteristics with repair or dispose decisions based on the patterns present in the labeled training data. For example, the model may learn that devices with certain combinations of diagnostic results, cosmetic condition grades, and estimated repair costs are typically labeled for repair, while devices with other combinations are typically labeled for disposal. The model may learn complex, non-linear relationships between multiple input features and the end-state decision that would be difficult to capture through manual rule-based systems.

The training in the step 204 may employ loss functions that measure the difference between the model predictions and the actual labels in the training data. The loss function may be minimized through optimization techniques such as gradient descent that iteratively adjust model parameters in the direction that reduces the loss. The training process may continue for multiple iterations through the training data, referred to as epochs, until the model achieves acceptable performance on the training data and on held-out validation data that was not used during training.

The trained device decision model generated in the step 204 may be stored in the database 106 for subsequent use by the AI engine 110. The trained device decision model may correspond to the device decision model 126 described with reference to FIG. 1. The device state determiner 112 may employ the trained device decision model to analyze input device data and generate output information characterizing whether a device should be repaired or disposed. The device decision engine 114 may use the output information to generate decisions about mobile devices.

The method 200 proceeds to a step 206 of providing the trained device decision model for use in determining whether to repair or dispose of a remote device. In the step 206, the trained device decision model may be made available for inference operations where new device data is input to the model and the model outputs a decision to repair or dispose of the corresponding device. The trained device decision model may be stored on the server 102 and may receive inputs from a remote client device, such as the client device 104, via the network 108.

In the step 206, the trained device decision model may be deployed in a production environment where the model processes device data for devices entering the aftermarket processing pipeline. The model may receive device data collected from remote devices located at different physical locations than the server 102 hosting the model. The device data may be transmitted from collection points such as trade-in kiosks, repair facilities, inspection stations, or other locations where device data is gathered, to the server 102 for processing by the trained device decision model.

The trained device decision model provided in the step 206 may be accessed through an application programming interface that enables client applications to submit device data and receive repair or dispose decisions in response. The application programming interface may be accessed by the client device 104 or by other computing systems that integrate with the device processing workflow. The repair or dispose decisions output by the trained device decision model may be used to route devices through appropriate processing pathways, with devices labeled for repair routed to repair workflows and devices labeled for disposal routed to recycling, resale, or other disposal channels.

Referring now to FIG. 3, a method 300 for using a trained device decision model is illustrated. The method 300 may be performed by one or more computing devices, such as the server 102 of the operating environment 100 described with reference to FIG. 1. The method 300 may employ a trained device decision model, such as a model trained according to the method 200 described with reference to FIG. 2, to determine whether to repair or dispose of a remote mobile device based on device data collected for that device.

The method 300 begins at a step 302 of accessing a trained device decision model. In the step 302, the trained device decision model may be retrieved from storage, such as the database 106, or may be loaded into memory on the server 102 for inference operations. The trained device decision model accessed in the step 302 may be a model that was trained according to the method 200, where the model learned to predict repair or dispose decisions based on labeled training data comprising device data associated with end-state decision labels.

In the step 302, accessing the trained device decision model may involve loading model parameters, weights, and configuration information that define the trained model. The trained device decision model may be stored in a serialized format that enables the model to be persisted to storage and subsequently loaded for inference. The server 102 may maintain the trained device decision model in memory to enable low-latency inference for incoming device data, or may load the model on demand when inference requests are received.

The method 300 proceeds to a step 304 of inputting device data for a remote device to the trained device decision model. In the step 304, the trained device decision model outputs a decision to repair or dispose of the remote device responsive to the input. A remote device may be a mobile device that is located at a different physical location than a client computing device accessing the trained device decision model to provide the model inputs. The remote device may be located at a trade-in kiosk, repair facility, inspection station, warehouse, or other location where device data is collected for aftermarket processing.

In the step 304, the input device data may include any one or more of the remote device data 118, the physical access data 120, the downstream data 122, or the device user data 124 as described with reference to FIG. 1. The input device data may include telemetry data collected from device subsystems, diagnostic results from hardware and software tests, cosmetic condition assessments from visual inspection, repair history information, market value estimates, and other data relevant to the repair or dispose decision.

With continued reference to FIG. 3, in some cases, the remote device may be accessed remotely, and remote device data may be retrieved from the remote device via a network connection. The retrieved remote device data may be transmitted to the server 102 and input to the trained device decision model. In some cases, the device data may be collected through physical access to the remote device at an inspection station or processing facility, with the collected data subsequently transmitted to the server 102 for processing by the trained device decision model.

In the step 304, the trained device decision model may process the input device data through the model architecture to generate an output prediction. The output prediction may indicate whether the remote device should be repaired or disposed. The output may comprise a discrete classification indicating repair or dispose, or may comprise a probability or confidence score indicating the likelihood of each decision outcome. The trained device decision model may apply the patterns and relationships learned during training to the input device data to generate the output prediction.

Responsive to the input device data, the trained device decision model may output a decision to repair or dispose of the remote device. The repair decision may indicate that the remote device is a candidate for repair and subsequent resale or return to service. In some cases, the repair decision may identify a specific component of the remote device that is likely to need repair. The specific component may include a display, haptic components, a speaker, a microphone, a port, a functional component, an accelerometer, a magnetometer, a battery, a camera, or another device component. Identifying specific components may enable targeted repair workflows that address the identified issues while avoiding unnecessary repair operations on components that do not require attention.

The dispose decision output by the trained device decision model may indicate that the remote device is not suitable for repair and should be routed to a disposal pathway. In some cases, the dispose decision may identify a disposal pathway for the remote device. The disposal pathway may include one of recycle or resale. The recycle pathway may route the device to recycling facilities where materials may be recovered and the device may be processed for environmentally responsible disposal. The resale pathway may route the device to secondary markets, wholesale channels, or other sales channels where the device may be sold in its current condition without repair. The selection of disposal pathway may be based on factors such as device condition, market demand, recovery value potential, and environmental considerations.

The method 300 proceeds to a step 306 of communicating to a client device an instruction in accordance with the output. In the step 306, the server 102 may transmit a communication to the client device 104 via the network 108 that conveys the decision output by the trained device decision model. The communication may include an indication of the repair or dispose decision, enabling operators or automated systems at the client device 104 to take appropriate action based on the decision.

In the step 306, the instruction communicated to the client device 104 may include information that enables routing of the remote device through appropriate processing pathways. For devices where the trained device decision model output a repair decision, the instruction may indicate that the device should be routed to a repair workflow. The instruction may include the specific component identified for repair, enabling repair technicians or automated repair systems to focus on the identified component. For devices where the trained device decision model output a dispose decision, the instruction may indicate that the device should be routed to the identified disposal pathway, such as recycling or resale.

The communication in the step 306 may be transmitted through an application programming interface that enables the client device 104 to receive decision outputs from the server 102. The client device 104 may display the instruction to a human operator, such as a warehouse manager, repair technician, or processing line worker, who may take action based on the instruction. In some cases, the client device 104 may be integrated with automated processing systems that receive the instruction and automatically route the remote device to the appropriate processing pathway without requiring human intervention.

The method 300 may enable efficient processing of mobile devices in aftermarket operations by providing automated decision support for repair or dispose determinations. By employing a trained device decision model to analyze device data and generate decisions, the method 300 may reduce the time and effort required for human operators to evaluate each device individually. The method 300 may also improve consistency of decisions by applying the same learned decision criteria to all devices processed through the system, reducing variability that may arise from different human operators applying different judgment criteria.

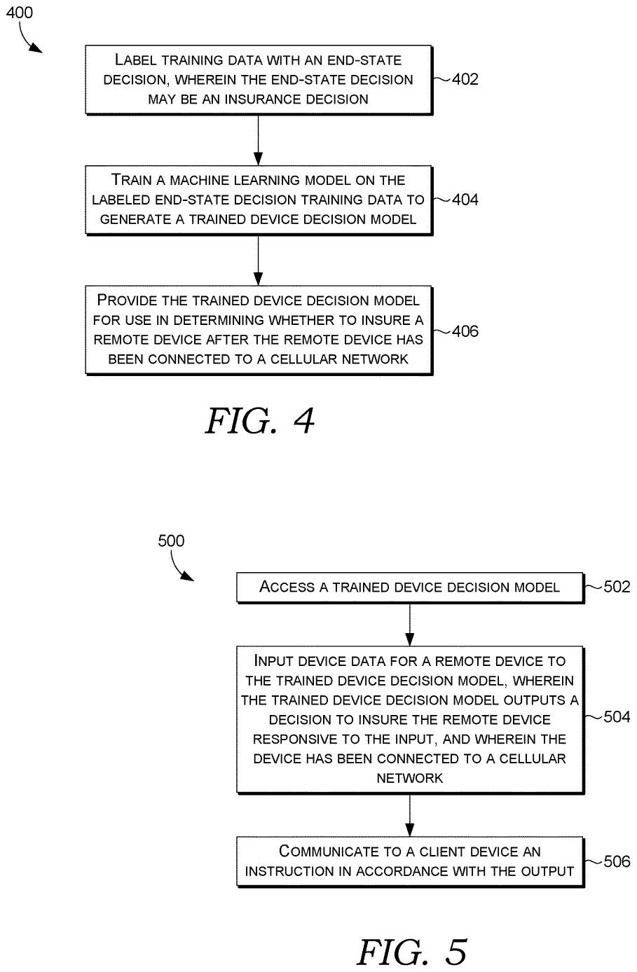

Referring now to FIG. 4, a method 400 for training a device decision model for insurance determination is illustrated. The method 400 may be performed by one or more computing devices, such as the server 102 of the operating environment 100 described with reference to FIG. 1. The method 400 may generate a trained device decision model that can be used to determine whether to insure a mobile device based on device data collected throughout the device lifecycle.

The method 400 begins at a step 402 of labeling training data with an end-state decision. In the step 402, the end-state decision may be an insurance decision. The training data may include device data collected from one or more points throughout the lifecycle of a mobile device. The training data may include the remote device data 118, the physical access data 120, the downstream data 122, or the device user data 124 as described with reference to FIG. 1. The training data may be stored in the database 106 and accessed by the server 102 for labeling and subsequent model training.

In the step 402, the end-state insurance label may be manually assigned to a device based on review of the device or device data for the device. Human reviewers may examine device characteristics, diagnostic results, usage patterns, claim history, risk factors, and other relevant information to determine whether a device should be insured. The insurance label may indicate whether a device is a suitable candidate for insurance coverage, taking into account factors such as device condition, predicted failure likelihood, estimated claim costs, and risk profile of the device or user.

The labeling process in the step 402 may generate a labeled dataset where each training example comprises device data associated with a corresponding end-state insurance decision label. The labeled dataset may include examples of devices that were labeled as suitable for insurance and examples of devices that were labeled as not suitable for insurance, providing the machine learning model with examples of both decision outcomes. The distribution of insurance labels in the labeled dataset may reflect the distribution of insurance decisions encountered in actual insurance underwriting operations, or may be balanced to provide representation of different decision outcomes.

With continued reference to FIG. 4, the method 400 proceeds to a step 404 of training a machine learning model on the labeled end-state decision training data from the step 402 to generate a trained device decision model. In the step 404, the machine learning model may be exposed to the labeled training data during the training process, where the model learns to identify patterns and relationships between the input device data and the end-state insurance decision labels. The training process may employ supervised learning techniques where the model iteratively adjusts its parameters to minimize the error between its predictions and the actual labels in the training data.

In the step 404, the machine learning model may learn to associate device characteristics with insurance decisions based on the patterns present in the labeled training data. For example, the model may learn that devices with certain combinations of battery health metrics, usage intensity indicators, cosmetic condition grades, and historical claim patterns are typically labeled as suitable for insurance, while devices with other combinations are typically labeled as not suitable for insurance. The model may learn complex, non-linear relationships between multiple input features and the insurance decision that would be difficult to capture through manual rule-based underwriting systems.

The training in the step 404 may employ loss functions that measure the difference between the model predictions and the actual labels in the training data. The loss function may be minimized through optimization techniques such as gradient descent that iteratively adjust model parameters in the direction that reduces the loss. The training process may continue for multiple iterations through the training data until the model achieves acceptable performance on the training data and on held-out validation data that was not used during training.

The trained device decision model generated in the step 404 may be stored in the database 106 for subsequent use by the AI engine 110. The trained device decision model may correspond to the device decision model 126 described with reference to FIG. 1. The device state determiner 112 may employ the trained device decision model to analyze input device data and generate output information characterizing whether a device should be insured. The device decision engine 114 may use the output information to generate insurance decisions about mobile devices.

The method 400 proceeds to a step 406 of providing the trained device decision model for use in determining whether to insure a remote device after the remote device has been connected to a cellular network. In the step 406, the trained device decision model may be made available for inference operations where new device data is input to the model and the model outputs a decision to insure or not insure the corresponding device. The trained device decision model may be stored on the server 102 and may receive inputs from a remote client device, such as the client device 104, via the network 108.

In the step 406, a cellular network may be a communication network that uses radio waves to provide wireless connectivity to mobile devices over a geographic area. The cellular network may include multiple interconnected cells that have a base station, and the cells may facilitate communication between mobile devices. The requirement that the remote device has been connected to a cellular network may indicate that the device has been activated and is in operational use, distinguishing the insurance determination from pre-sale or pre-activation assessments.

In some cases, the use of the trained device decision model to make the insurance decision may occur after a predefined time that the device is connected to the cellular network. The predefined time may allow for collection of usage data and telemetry that characterizes how the device is being used in actual operation. The predefined time may range from hours to days to weeks, depending on the amount of usage data desired for the insurance determination. Collecting usage data over a period of time may enable the trained device decision model to assess risk factors that are not apparent from device characteristics alone, such as usage intensity, environmental exposure patterns, and handling behaviors.

In some cases, the insurance decision may occur after the device is connected to a cellular network and after a first sale of the device. The first sale may indicate that the device has been transferred to an end user who will be the insured party. Making the insurance decision after the first sale may enable the insurance determination to account for factors related to the specific user or usage context, such as geographic location, user demographics, or usage patterns observed after the device enters service with the end user.

The trained device decision model provided in the step 406 may be deployed in a production environment where the model processes device data for devices that are candidates for insurance coverage. The model may receive device data collected from remote devices that have been connected to cellular networks and are in active use. The device data may include telemetry collected through device applications, diagnostic results from remote monitoring, usage metrics, and other data that characterizes the device condition and usage patterns after the device has been activated on a cellular network.

The trained device decision model provided in the step 406 may be accessed through an application programming interface that enables client applications to submit device data and receive insurance decisions in response. The application programming interface may be accessed by the client device 104 or by other computing systems operated by insurance providers, device retailers, or other parties involved in offering device insurance. The insurance decisions output by the trained device decision model may be used to determine whether to offer insurance coverage for a device, to set insurance premiums based on predicted risk, or to determine coverage terms based on device characteristics and predicted claim likelihood.

Referring now to FIG. 5, a method 500 for using a trained device decision model for insurance determination is illustrated. The method 500 may be performed by one or more computing devices, such as the server 102 of the operating environment 100 described with reference to FIG. 1. The method 500 may employ a trained device decision model, such as a model trained according to the method 400 described with reference to FIG. 4, to determine whether to insure a remote mobile device based on device data collected for that device after the device has been connected to a cellular network.

The method 500 begins at a step 502 of accessing a trained device decision model. In the step 502, the trained device decision model may be retrieved from storage, such as the database 106, or may be loaded into memory on the server 102 for inference operations. The trained device decision model accessed in the step 502 may be a model that was trained according to the method 400, where the model learned to predict insurance decisions based on labeled training data comprising device data associated with end-state insurance decision labels.

In the step 502, accessing the trained device decision model may involve loading model parameters, weights, and configuration information that define the trained model. The trained device decision model may be stored in a serialized format that enables the model to be persisted to storage and subsequently loaded for inference. The server 102 may maintain the trained device decision model in memory to enable low-latency inference for incoming device data, or may load the model on demand when inference requests are received.

With continued reference to FIG. 5, the method 500 proceeds to a step 504 of inputting device data for a remote device to the trained device decision model. In the step 504, the trained device decision model outputs a decision to insure the remote device responsive to the input, and the device has been connected to a cellular network. A remote device may be a mobile device that is located at a different physical location than a client computing device accessing the trained device decision model to provide the model inputs. The remote device may be located with an end user who has activated the device on a cellular network and is using the device in normal operation.

In the step 504, the input device data may include any one or more of the remote device data 118, the physical access data 120, the downstream data 122, or the device user data 124 as described with reference to FIG. 1. The input device data may include telemetry data collected from device subsystems after the device has been connected to the cellular network, diagnostic results from remote monitoring, usage metrics characterizing how the device is being used, battery health indicators, cosmetic condition assessments, and other data relevant to the insurance decision.

In some cases, the remote device may be accessed remotely, and remote device data may be retrieved from the remote device via a network connection after the device has been connected to the cellular network. The retrieved remote device data may be transmitted to the server 102 and input to the trained device decision model. The remote device data may include telemetry collected through a device application installed on the remote device that monitors device subsystems and transmits collected data to the server 102 for processing.

In the step 504, the trained device decision model may process the input device data through the model architecture to generate an output prediction. The output prediction may indicate whether the remote device should be insured. The output may comprise a discrete classification indicating whether to insure or not insure the device, or may comprise a probability or confidence score indicating the likelihood that the device is a suitable candidate for insurance coverage. The trained device decision model may apply the patterns and relationships learned during training to the input device data to generate the output prediction.

In some cases, the trained device decision model may be used to make the insurance decision after a predefined time that the device is connected to the cellular network. The predefined time may allow for collection of usage data and telemetry that characterizes how the device is being used in actual operation. Collecting usage data over a period of time may enable the trained device decision model to assess risk factors based on observed usage patterns, environmental exposure, and handling behaviors that are not apparent from device characteristics alone.

In some cases, the insurance decision may occur after the device is connected to the cellular network and after a first sale of the device. Making the insurance decision after the first sale may enable the insurance determination to account for factors related to the specific user or usage context, such as geographic location where the device is being used, usage intensity patterns observed after the device enters service with the end user, or other factors that become observable after the device is in active use.

Responsive to the input device data, the trained device decision model may output a decision to insure the remote device. The insurance decision may indicate that the remote device is a suitable candidate for insurance coverage based on the device characteristics, condition, usage patterns, and predicted risk factors assessed by the trained device decision model. The insurance decision may be used by insurance providers, device retailers, or other parties to determine whether to offer insurance coverage for the device.

The method 500 proceeds to a step 506 of communicating to a client device an instruction in accordance with the output. In the step 506, the server 102 may transmit a communication to the client device 104 via the network 108 that conveys the decision output by the trained device decision model. The communication may include an indication of the insurance decision, enabling operators or automated systems at the client device 104 to take appropriate action based on the decision.

In some cases, the communication in the step 506 may include an insured value. The insured value may indicate the monetary value for which the device may be insured, based on factors such as device model, condition, age, and market value. The insured value may be used to determine coverage limits for insurance policies offered for the device.

In some cases, the communication in the step 506 may include an insurance payment amount. The insurance payment amount may indicate the premium or payment required for insurance coverage of the device. The insurance payment amount may be determined based on the predicted risk associated with the device, as assessed by the trained device decision model, along with factors such as coverage terms, deductible amounts, and coverage duration. Devices with higher predicted risk may be associated with higher insurance payment amounts, while devices with lower predicted risk may be associated with lower insurance payment amounts.

The instruction communicated to the client device 104 in the step 506 may enable insurance providers, device retailers, or other parties to make informed decisions about offering insurance coverage for the remote device. The client device 104 may display the instruction to a human operator, such as an insurance underwriter or customer service representative, who may use the information to communicate insurance options to the device owner. In some cases, the client device 104 may be integrated with automated insurance enrollment systems that receive the instruction and automatically generate insurance offers or enrollment confirmations based on the insurance decision output by the trained device decision model.

The method 500 may enable efficient insurance underwriting for mobile devices by providing automated decision support for insurance determinations. By employing a trained device decision model to analyze device data collected after the device has been connected to a cellular network, the method 500 may assess risk factors based on actual device condition and usage patterns rather than relying solely on device specifications or user-reported information. The method 500 may also improve consistency of insurance decisions by applying the same learned decision criteria to all devices processed through the system, reducing variability that may arise from different human underwriters applying different judgment criteria.

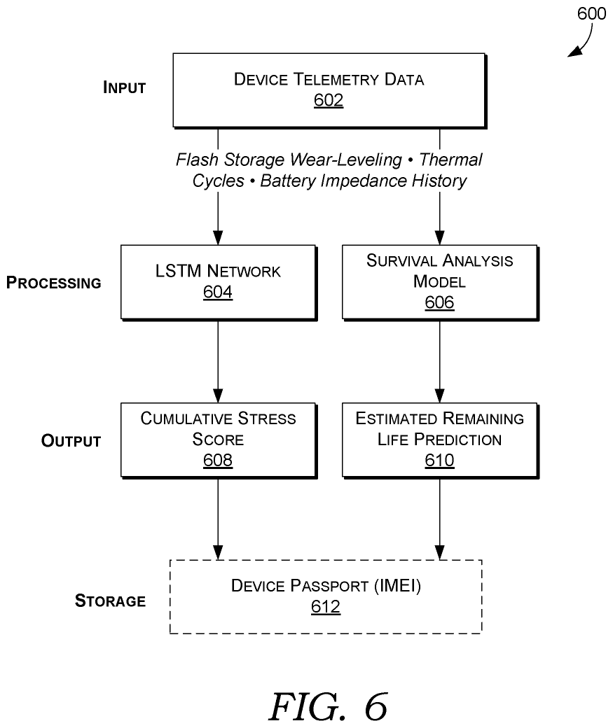

Referring now to FIG. 6, a device passport structure 600 for processing mobile device lifecycle telemetry data and generating predictive device health metrics is illustrated. The device passport structure 600 may be implemented by the AI engine 110 of the operating environment 100 described with reference to FIG. 1, or may be implemented as a separate processing pipeline that generates device health certifications for mobile devices in the aftermarket lifecycle. The device passport structure 600 may receive telemetry data collected over the operational lifetime of a mobile device and generate predictive metrics that characterize device health and expected remaining useful life.

The device passport structure 600 receives device telemetry data 602 as input. The device telemetry data 602 may include data collected from various subsystems of a mobile device over the operational lifetime of the device. The device telemetry data 602 may be collected through remote monitoring agents installed on the mobile device, through physical access diagnostics performed at inspection stations, or through a combination of remote and physical access data collection methods. The device telemetry data 602 may correspond to portions of the remote device data 118 or the physical access data 120 described with reference to FIG. 1.

With continued reference to FIG. 6, the device telemetry data 602 may include flash storage wear-leveling data that characterizes the usage and degradation of flash memory storage components in the mobile device. Flash storage wear-leveling data may include metrics such as the number of program/erase cycles performed on storage blocks, the distribution of wear across storage blocks, the number of bad blocks that have been retired, and the remaining spare block capacity available for wear leveling. Flash memory has a finite number of program/erase cycles that each storage cell can endure before the cell becomes unreliable, and wear-leveling algorithms distribute writes across storage cells to extend the overall lifetime of the storage device. The flash storage wear-leveling data may provide insight into how much of the storage lifetime has been consumed and how much useful life remains.

The device telemetry data 602 may include thermal cycle data that characterizes the temperature history of the mobile device. Thermal cycle data may include records of temperature measurements from thermal sensors distributed throughout the device, counts of thermal cycles where the device temperature transitioned between different temperature ranges, peak temperatures reached during operation, and duration of exposure to elevated temperatures. Thermal cycling may cause mechanical stress on device components due to differential thermal expansion of materials, and exposure to elevated temperatures may accelerate degradation of electronic components and battery chemistry. The thermal cycle data may provide insight into the thermal stress that the device has experienced over its operational lifetime.

The device telemetry data 602 may include battery impedance history that characterizes the degradation of the battery over time. Battery impedance history may include measurements of battery internal resistance taken at various points during the device lifetime, along with associated state of charge and temperature conditions at the time of measurement. Battery internal resistance tends to increase as the battery ages and degrades, and elevated internal resistance may reduce the power delivery capability of the battery and may indicate reduced capacity and cycle life. The battery impedance history may provide insight into the health and remaining useful life of the battery component.

The device telemetry data 602 may be provided to processing components of the device passport structure 600 that analyze the telemetry data and generate predictive metrics. The device passport structure 600 may include an LSTM network 604 that performs time-series telemetry analysis on the device telemetry data 602. LSTM (Long Short-Term Memory) networks are a type of recurrent neural network architecture that may capture long-range temporal dependencies in sequential data through the use of gating mechanisms that control the flow of information through the network.

The LSTM network 604 may process the device telemetry data 602 as time-series sequences, analyzing patterns in how telemetry metrics have evolved over the operational lifetime of the device. The LSTM network 604 may learn to recognize patterns in the temporal evolution of flash storage wear-leveling data, thermal cycle data, and battery impedance history that are indicative of device degradation trajectories. The LSTM network 604 may capture relationships between telemetry metrics at different points in time, identifying trends, acceleration of degradation, and other temporal patterns that inform predictions about device health.

The LSTM network 604 may output a cumulative stress score 608 that represents an aggregated measure of device wear based on the analysis of the device telemetry data 602. The cumulative stress score 608 may quantify the total stress that the device has experienced over its operational lifetime, analogous to an odometer reading in a vehicle that indicates total distance traveled. The cumulative stress score 608 may be calculated by analyzing the flash storage wear-leveling data, the thermal cycle data, and the battery impedance history to produce a single metric that characterizes overall device wear.

The cumulative stress score 608 may integrate contributions from multiple stress factors that affect device longevity. The flash storage wear-leveling data may contribute to the cumulative stress score 608 based on the proportion of storage lifetime that has been consumed. The thermal cycle data may contribute to the cumulative stress score 608 based on the number and severity of thermal cycles and the cumulative exposure to elevated temperatures. The battery impedance history may contribute to the cumulative stress score 608 based on the increase in battery internal resistance relative to the initial resistance of a new battery. The LSTM network 604 may learn appropriate weightings for these contributions based on training data that associates telemetry patterns with observed device outcomes.

With continued reference to FIG. 6, the device passport structure 600 may include a survival analysis model 606 that estimates the probability of hardware failure over time based on the device telemetry data 602. The survival analysis model 606 may implement Cox Proportional Hazards modeling, which is a statistical technique for analyzing time-to-event data that models the hazard rate as a function of covariates. In the context of device health prediction, the event of interest may be hardware failure, and the covariates may include features derived from the device telemetry data 602.

Cox Proportional Hazards modeling may estimate the probability of hardware failure over time by modeling the hazard function, which represents the instantaneous rate of failure at each point in time given that the device has survived up to that point. The Cox Proportional Hazards model may express the hazard function as a baseline hazard multiplied by an exponential function of the covariates, where the covariates may include features derived from the flash storage wear-leveling data, thermal cycle data, and battery impedance history. The model may learn coefficients for each covariate that indicate how that covariate affects the hazard rate, with positive coefficients indicating increased hazard and negative coefficients indicating decreased hazard.

The survival analysis model 606 may output an estimated remaining life prediction 610 that indicates the projected remaining useful life of the device. The estimated remaining life prediction 610 may provide a timestamped prediction of how many months of peak performance remain before a hardware failure is likely to occur. The estimated remaining life prediction 610 may be derived from the survival function estimated by the Cox Proportional Hazards model, which gives the probability that the device will survive beyond each future time point. The estimated remaining life prediction 610 may be expressed as a point estimate such as the median remaining life, or may include a range or confidence interval that characterizes uncertainty in the prediction.

The estimated remaining life prediction 610 may enable informed decision-making about device routing, valuation, and suitability for different downstream channels. Devices with longer estimated remaining life may be suitable for resale to end users who expect extended use of the device. Devices with shorter estimated remaining life may be more suitable for wholesale channels, parts harvesting, or recycling. The estimated remaining life prediction 610 may also inform insurance decisions by providing an estimate of the expected time until failure, which may affect the risk profile of insuring the device.

The cumulative stress score 608 and the estimated remaining life prediction 610 may be stored in a device passport 612. The device passport 612 may be a persistent data structure that maintains a comprehensive record of device health metrics and predictions for a mobile device. The device passport 612 may be linked to the device via an IMEI (International Mobile Equipment Identity) identifier, which is a unique identifier assigned to mobile devices that enables tracking of the device throughout its lifecycle. The IMEI identifier may provide a persistent link between the device passport 612 and the physical device, enabling the device passport 612 to be retrieved and updated as the device moves through different stages of the aftermarket lifecycle.

The device passport 612 may serve as a standardized health certificate for the mobile device, providing transparency about device condition and predicted longevity in secondary market transactions. The device passport 612 may include the cumulative stress score 608 that characterizes the total wear the device has experienced, enabling comparison of devices based on their usage history. The device passport 612 may include the estimated remaining life prediction 610 that provides a forward-looking assessment of expected device longevity, enabling buyers to make informed decisions about the expected useful life of the device.

The device passport 612 may be updated as new device telemetry data 602 becomes available. As the device continues to operate and generate telemetry data, the LSTM network 604 and the survival analysis model 606 may process the updated telemetry data to generate updated values for the cumulative stress score 608 and the estimated remaining life prediction 610. The updated values may be stored in the device passport 612, maintaining a current assessment of device health that reflects the most recent telemetry data. The device passport 612 may also maintain a history of previous assessments, enabling tracking of how device health metrics have evolved over time.

The device passport 612 may reduce customer returns in secondary market transactions by preventing the sale of devices with latent defects that would lead to early failure. By providing the estimated remaining life prediction 610, the device passport 612 may enable identification of devices that appear functional but have degraded components that are likely to fail in the near future. Such devices may be routed to appropriate channels such as parts harvesting or recycling rather than being sold to end users who would experience early failure and seek returns or warranty claims. The transparency provided by the device passport 612 may increase trust in secondary market transactions by providing objective, data-driven assessments of device health.

The device passport 612 may be stored in the database 106 of the operating environment 100 and may be accessed by the AI engine 110 when making decisions about device routing, valuation, or insurance. The device decision engine 114 may retrieve the device passport 612 for a device and use the cumulative stress score 608 and the estimated remaining life prediction 610 as inputs to decision-making processes. The device passport 612 may also be made available to downstream partners, secondary market platforms, or end users through application programming interfaces that enable retrieval of device health information based on the IMEI identifier.

The device passport may be stored and distributed using various mechanisms that address requirements for tamper-evidence, offline accessibility, authenticity verification, access control, historical tracking, and decentralized identity management. The selection of storage and distribution mechanisms may depend on the requirements of specific use cases, the technical capabilities of participants in the mobile device aftermarket ecosystem, and the sensitivity of the device health information being managed.

In some cases, blockchain or distributed ledger technologies may be employed to provide tamper-evident storage of device health records linked to device identifiers. Blockchain technology may store device passport data in blocks that are cryptographically linked to form a chain, with the chain replicated across multiple nodes in a distributed network. The cryptographic linking may ensure that any modification to previously recorded data would be detectable, as the modification would invalidate the cryptographic hashes that link subsequent blocks to the modified block. The distributed replication may ensure that no single party can unilaterally alter the stored records, as modifications would need to be accepted by the consensus mechanism governing the distributed network.

Device passport records stored on a blockchain may include the cumulative stress score, the estimated remaining life prediction, timestamps indicating when assessments were performed, and identifiers linking the records to the corresponding physical device. Each update to the device passport may be recorded as a new transaction on the blockchain, creating an append-only log of device health assessments over time. The immutability of blockchain records may provide assurance that device health history has not been altered after the fact, which may increase trust in device provenance and condition claims in secondary market transactions.

Blockchain-based storage may enable multiple parties in the mobile device aftermarket ecosystem to contribute to and verify device passport records without requiring a central trusted authority. Inspection facilities, repair vendors, diagnostic service providers, and other participants may record device health assessments to the blockchain, with each participant able to verify the authenticity and integrity of records contributed by other participants. The distributed nature of blockchain may reduce dependence on any single party to maintain accurate records and may enable verification of device health history even when the original recording party is no longer available or accessible.

In some cases, QR codes or NFC tags physically attached to devices may be employed to provide offline access to device passport information. A QR code may encode a URL or data payload that enables retrieval of device passport information when scanned by a camera-equipped device such as a smartphone or tablet. An NFC (Near Field Communication) tag may store data that can be read by NFC-enabled devices when brought into close proximity with the tag. Physical attachment of QR codes or NFC tags to mobile devices may enable access to device passport information without requiring network connectivity at the time of access.

QR codes physically attached to devices may encode a unique identifier that can be used to retrieve the full device passport from a network-accessible repository when network connectivity is available. In some cases, QR codes may encode a compact representation of device passport information directly, enabling access to basic device health metrics without requiring network connectivity. The compact representation may include the cumulative stress score, the estimated remaining life prediction, and a timestamp indicating when the assessment was performed. QR codes may be printed on labels that are affixed to the device body, device packaging, or accompanying documentation.

NFC tags physically attached to devices may store device passport information in the tag memory, enabling retrieval of device health metrics by touching an NFC-enabled device to the tag. NFC tags may store more data than can be practically encoded in a QR code, enabling storage of more detailed device passport information including historical assessments and component-level health metrics. NFC tags may be embedded in device cases, affixed to device bodies using adhesive, or integrated into device packaging. NFC tags may support read-only or read-write configurations, with read-only configurations preventing modification of stored data after initial programming and read-write configurations enabling updates to stored data as new device health assessments become available.

Physical attachment of QR codes or NFC tags may enable device passport access in scenarios where network connectivity is limited or unavailable, such as at remote collection sites, during field inspections, or in facilities with restricted network access. Physical attachment may also enable rapid access to device passport information without requiring lookup of device identifiers in network-accessible databases, reducing the time required to retrieve device health information during high-throughput processing operations.

In some cases, digital certificate authorities may be employed to cryptographically sign device passport data to ensure authenticity. A digital certificate authority may issue digital certificates that bind public keys to the identities of entities that generate device passport data, such as inspection facilities, diagnostic service providers, or the device passport generation system itself. The digital certificates may be used to verify that device passport data was generated by an authorized entity and has not been modified since generation.

Cryptographic signing of device passport data may involve generating a digital signature using a private key held by the entity that generated the data. The digital signature may be computed over the device passport data using a cryptographic hash function and a signature algorithm. Recipients of the signed device passport data may verify the signature using the corresponding public key, which may be obtained from a digital certificate issued by the certificate authority. Successful signature verification may confirm that the data was generated by the entity holding the private key and that the data has not been modified since the signature was generated.

Digital certificate authorities may maintain certificate revocation lists or provide online certificate status checking services that enable verification that certificates have not been revoked due to key compromise or other security events. Certificate revocation checking may ensure that device passport data signed with compromised keys is not accepted as authentic. The certificate authority infrastructure may follow established standards for certificate issuance, management, and revocation, enabling interoperability with existing public key infrastructure implementations.

Cryptographic signing may be combined with blockchain-based storage to provide both tamper-evidence and authenticity verification. Device passport data may be signed by the generating entity before being recorded to the blockchain, enabling verification of both the integrity of the blockchain record and the authenticity of the original data. The combination of blockchain storage and cryptographic signing may provide defense in depth against different types of attacks on device passport integrity.

In some cases, progressive disclosure mechanisms may be employed to reveal different levels of detail to different stakeholders based on authorization. Progressive disclosure may enable the device passport to contain detailed device health information while restricting access to sensitive details based on the role or authorization level of the requesting party. Different stakeholders in the mobile device aftermarket ecosystem may have different information needs and different authorization levels for accessing device health information.

Progressive disclosure mechanisms may define multiple tiers of device passport information with different access requirements. A first tier may include basic device health metrics such as the cumulative stress score and the estimated remaining life prediction, which may be accessible to any party with physical access to the device or knowledge of the device identifier. A second tier may include more detailed component-level health metrics and historical assessment data, which may be accessible to authorized parties such as repair vendors, inspection facilities, or insurance providers. A third tier may include raw telemetry data and detailed diagnostic results, which may be accessible only to parties with elevated authorization such as the device manufacturer or authorized service providers.

Progressive disclosure may be implemented through access control mechanisms that verify the authorization of requesting parties before releasing device passport information. Authorization may be verified through authentication credentials, digital certificates, or tokens issued by authorization servers. The access control mechanisms may evaluate the authorization level of the requesting party and return only the device passport information that the party is authorized to access. Progressive disclosure may enable broad availability of basic device health information while protecting sensitive details that may have privacy implications or competitive value.

In some cases, version control systems may be employed to maintain a complete history of device passport updates throughout the device lifecycle. Version control systems may track changes to device passport data over time, maintaining a record of each update along with metadata such as the timestamp of the update, the identity of the entity that performed the update, and the reason for the update. The version history may enable reconstruction of the device passport state at any point in the device lifecycle and may enable auditing of changes to device health assessments.

Version control for device passports may record each update to the cumulative stress score, the estimated remaining life prediction, and other device health metrics as a new version in the version history. The version history may include the complete device passport data at each version, or may include incremental changes that can be applied to reconstruct the device passport state at each version. The version history may be stored alongside the current device passport data in the database or may be stored in a separate version control repository.

Version control may enable tracking of how device health metrics have evolved over the device lifecycle. The version history may reveal trends in device degradation, such as acceleration of battery impedance increase or accumulation of thermal stress over time. The version history may also reveal events that affected device health, such as repairs that improved device condition or incidents that caused degradation. Access to the complete version history may enable more informed decision-making about device routing and valuation by providing context about how the device reached its current condition.

Version control may also support rollback or correction of device passport data in cases where errors are discovered in previous assessments. If a device health assessment is later determined to have been incorrect due to sensor malfunction, software error, or other causes, the version control system may enable correction of the affected data while maintaining a record of the original incorrect data and the correction. The correction record may include metadata explaining the reason for the correction and the identity of the entity that performed the correction.

In some cases, decentralized identifiers may be employed to enable device-centric identity management independent of centralized authorities. Decentralized identifiers (DIDs) are a type of identifier that enables verifiable, decentralized digital identity. DIDs may be created, owned, and controlled by the entity they identify, without requiring registration with a centralized authority. In the context of device passports, DIDs may enable mobile devices to have persistent identities that are not dependent on any single organization or system.

A DID for a mobile device may be generated based on cryptographic key material associated with the device. The DID may be resolvable to a DID document that contains information about the device, including public keys that can be used to verify signatures generated by the device or on behalf of the device. The DID document may also contain service endpoints that indicate where device passport information can be retrieved. The DID and DID document may be registered on a distributed ledger or other decentralized storage system that enables resolution of the DID to the DID document without relying on a centralized registry.

Decentralized identifiers may enable device passport information to be linked to a device identity that persists across changes in device ownership, processing facility, or aftermarket channel. The DID may serve as a stable identifier for the device that can be used to retrieve device passport information regardless of which organization currently possesses the device or which system originally generated the device passport. Decentralized identifiers may reduce dependence on centralized identifier registries and may enable interoperability across different device passport systems that recognize the same DID standards.

Decentralized identifiers may be combined with verifiable credentials to enable portable, verifiable device health attestations. A verifiable credential may be a cryptographically signed statement about a device, such as an attestation that the device has a particular cumulative stress score or estimated remaining life. Verifiable credentials may be issued by inspection facilities, diagnostic service providers, or other authorized entities, and may be verified by any party that trusts the issuing entity. The combination of decentralized identifiers and verifiable credentials may enable a decentralized ecosystem for device health certification where multiple parties can contribute and verify device health information without requiring a central coordinating authority.

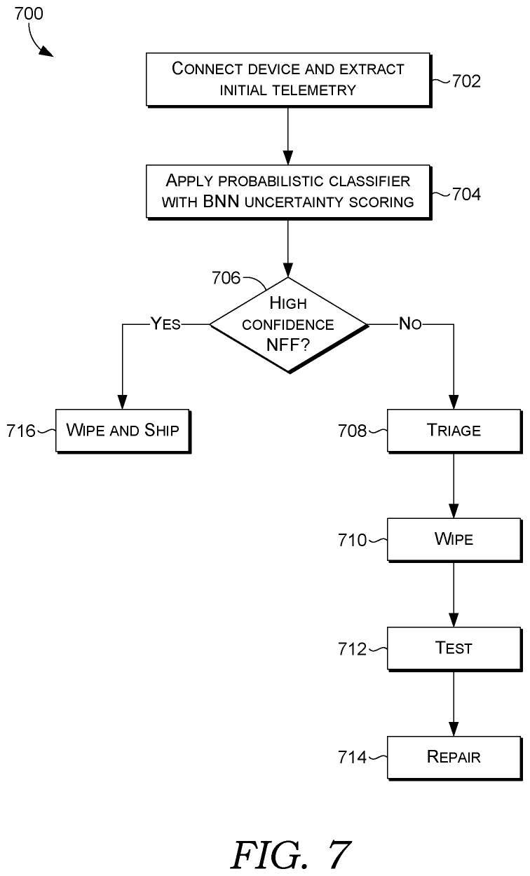

Referring now to FIG. 7, a method 700 for skip-logic predictive routing of aftermarket mobile devices is illustrated. The method 700 may be performed by one or more computing devices, such as the server 102 of the operating environment 100 described with reference to FIG. 1. The method 700 may implement skip-logic routing based on early-stage diagnostics to minimize processing costs and depreciation by identifying devices that can bypass portions of the standard processing pipeline.

The method 700 begins at a step 702 of connecting a device and extracting initial telemetry data from the device upon intake. In the step 702, a mobile device entering the aftermarket processing pipeline may be connected to diagnostic equipment at an intake station. The connection may be established through a wired interface such as a USB connection, or through a wireless interface such as near-field communication or Bluetooth. Upon connection, the system may extract initial telemetry data from the device, including low-level telemetry such as kernel panic logs and voltage fluctuations that characterize the operational state of device subsystems.

The initial telemetry data extracted in the step 702 may include data from various device subsystems that provide insight into device health and functionality. The initial telemetry data may include error logs that record software faults, hardware exceptions, and system crashes that have occurred during device operation. The initial telemetry data may include power subsystem data such as voltage readings, current measurements, and battery health indicators. The initial telemetry data may include sensor readings from accelerometers, gyroscopes, and other sensors that may indicate physical damage or sensor malfunction. The extraction of initial telemetry data in the step 702 may be performed rapidly to enable efficient processing of devices through the intake stage.

With continued reference to FIG. 7, the method 700 proceeds to a step 704 of applying a probabilistic classifier with Bayesian Neural Network uncertainty scoring to the extracted telemetry data. In the step 704, the initial telemetry data extracted in the step 702 may be provided as input to a probabilistic classifier that generates predictions about device fault status along with uncertainty scores that characterize the confidence of the predictions. The probabilistic classifier may be implemented using Bayesian Neural Networks that provide uncertainty quantification as part of the prediction process.

Bayesian Neural Networks may model uncertainty in neural network predictions by placing probability distributions over network weights rather than using fixed point estimates for the weights. During inference, Bayesian Neural Networks may sample from the weight distributions to generate multiple predictions for each input, with the variance of predictions across samples providing an estimate of model uncertainty. The uncertainty scores generated by Bayesian Neural Networks may distinguish between cases where the model is confident in its predictions and cases where the model is uncertain due to limited training data, unusual input characteristics, or inherent ambiguity in the prediction task.

In the step 704, the probabilistic classifier may generate fault predictions that indicate whether the device is likely to have hardware or software faults that would require repair. The probabilistic classifier may also generate uncertainty scores that indicate the confidence of the fault predictions. The uncertainty scores may be computed based on the variance of predictions across samples from the Bayesian Neural Network weight distributions, or may be computed using other uncertainty quantification techniques such as Monte Carlo Dropout or ensemble methods. The uncertainty scores may enable the system to identify devices for which the fault predictions are reliable and devices for which the fault predictions are uncertain and may require additional verification.

The method 700 proceeds to a decision 706 where the system determines whether the device has a high confidence of being classified as No Fault Found based on the uncertainty scores from the probabilistic classifier. In the decision 706, the system may evaluate the fault prediction and the associated uncertainty score to determine whether the device meets criteria for high confidence No Fault Found classification. A device may be classified as No Fault Found when the probabilistic classifier predicts that the device does not have faults that would require repair. The classification may be considered high confidence when the uncertainty score indicates that the model is confident in the No Fault Found prediction.

The decision 706 may apply threshold criteria to the fault prediction and uncertainty score to determine whether the device qualifies for high confidence No Fault Found classification. The threshold criteria may require that the predicted probability of faults is below a fault probability threshold and that the uncertainty score is below an uncertainty threshold indicating high confidence. The threshold values may be configured based on the desired tradeoff between processing efficiency and risk of incorrectly bypassing devices that have faults. Lower thresholds may result in fewer devices qualifying for bypass, reducing the risk of incorrect bypass but also reducing the processing efficiency gains. Higher thresholds may result in more devices qualifying for bypass, increasing processing efficiency but also increasing the risk of incorrect bypass.

If the decision 706 determines that the device has high confidence of being classified as No Fault Found, the method 700 proceeds along a bypass path to a step 716 of performing a wipe and ship operation. The bypass path enables devices with high confidence No Fault Found classifications to be routed directly to data wiping and shipping, bypassing the standard linear processing pipeline that includes triage, testing, and repair stages. By bypassing these stages for devices that are unlikely to have faults, the method 700 may reduce processing time and costs while minimizing depreciation that occurs while devices remain in the processing pipeline.

In the step 716, the device may undergo data wiping to remove user data and restore the device to a factory or certified pre-owned configuration. The data wiping may include secure erasure of storage contents, removal of user accounts and credentials, and restoration of default device settings. Following data wiping, the device may be prepared for shipping to downstream channels such as secondary markets, wholesale buyers, or retail partners. The step 716 may be performed without the manual testing and inspection that would be performed in the standard processing pipeline, reducing the labor and time required to process the device.

The bypass path through the step 716 may reduce processing time by up to sixty percent compared to the standard linear processing pipeline for devices that qualify for high confidence No Fault Found classification. The reduction in processing time may result from bypassing the triage, testing, and repair stages that would otherwise be performed. The reduced processing time may decrease the depreciation that devices experience while in the processing pipeline, as device values tend to decline over time due to market factors and the introduction of newer device models. The reduced processing time may also increase throughput capacity of the processing facility by enabling faster turnover of devices through the pipeline.

With continued reference to FIG. 7, if the decision 706 determines that the device does not have high confidence of being classified as No Fault Found, the method 700 proceeds along a standard pipeline path through multiple processing stages. The standard pipeline path may be followed for devices where the probabilistic classifier predicts that faults are likely, or for devices where the uncertainty score indicates that the fault prediction is not sufficiently confident to support bypass of manual inspection. The standard pipeline path provides comprehensive fault diagnosis and remediation for devices that do not meet the high confidence No Fault Found threshold.

The standard pipeline path begins with a step 708 of triaging the device. In the step 708, the device may undergo initial assessment to categorize the device and determine appropriate processing workflows. The triage process may include visual inspection of device cosmetic condition, verification of device identity and model information, and preliminary assessment of device functionality. The triage process may assign the device to processing queues based on device characteristics, identified issues, and available processing resources.

The standard pipeline path proceeds to a step 710 of wiping the device. In the step 710, the device may undergo data wiping to remove user data prior to further testing and processing. The data wiping in the step 710 may be similar to the data wiping performed in the step 716, including secure erasure of storage contents and removal of user accounts and credentials. Performing data wiping before testing may protect user privacy during subsequent handling of the device and may enable testing procedures that require access to device storage or system functions.

The standard pipeline path proceeds to a step 712 of testing the device. In the step 712, the device may undergo comprehensive functional testing to identify hardware and software faults that require repair. The testing may include automated diagnostic routines that exercise device subsystems and verify correct operation. The testing may include manual inspection by technicians who evaluate device functionality and identify issues that may not be detected by automated diagnostics. The testing in the step 712 may generate detailed diagnostic results that inform repair decisions and guide repair technicians to specific faults that require attention.

The standard pipeline path proceeds to a step 714 of repairing the device. In the step 714, faults identified during testing may be addressed through repair procedures that restore device functionality. The repair procedures may include replacement of failed components such as displays, batteries, cameras, or other hardware components. The repair procedures may include software remediation such as firmware updates, operating system reinstallation, or removal of problematic software. Following repair, the device may undergo verification testing to confirm that the repairs were successful and that the device meets quality standards for downstream channels.

The standard pipeline path through the step 708, the step 710, the step 712, and the step 714 provides comprehensive processing for devices that require fault diagnosis and remediation. The standard pipeline path may be more time-consuming and costly than the bypass path through the step 716, but may be appropriate for devices where faults are likely or where the confidence of No Fault Found classification is insufficient to support bypass of manual inspection. The method 700 may optimize overall processing efficiency by routing devices to the appropriate path based on the probabilistic classifier predictions and uncertainty scores, directing high confidence No Fault Found devices to the efficient bypass path while directing other devices to the comprehensive standard pipeline.

The Bayesian Neural Network uncertainty scoring employed in the step 704 may ensure that only high-confidence units bypass human inspection. By requiring that the uncertainty score indicate high confidence before allowing bypass, the method 700 may reduce the risk of incorrectly bypassing devices that have faults that would be detected through manual testing. Devices with uncertain fault predictions may be routed to the standard pipeline where human inspection can verify device condition and identify faults that the probabilistic classifier was unable to confidently rule out. The uncertainty-aware routing may balance processing efficiency against quality assurance by adapting the processing path based on the reliability of automated predictions for each individual device.

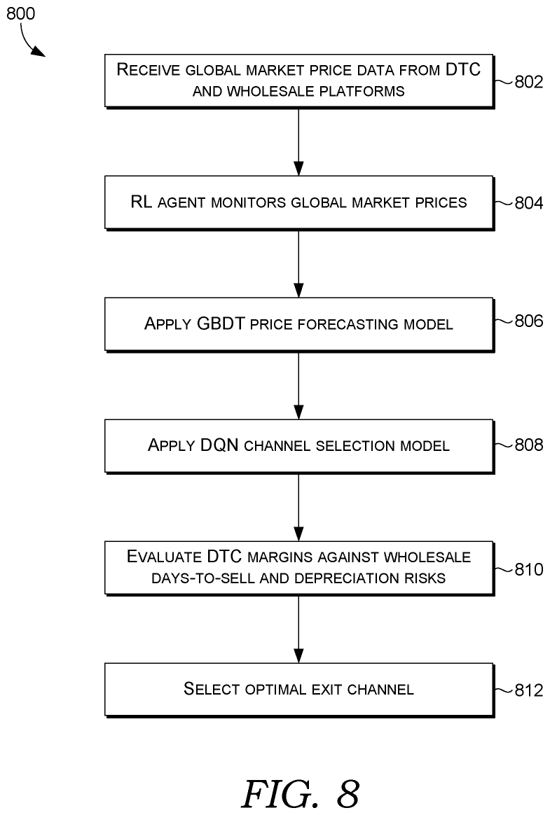

Referring now to FIG. 8, a method 800 for dynamic channel selection for aftermarket mobile devices based on global market conditions is illustrated. The method 800 may be performed by one or more computing devices, such as the server 102 of the operating environment 100 described with reference to FIG. 1. The method 800 may implement dynamic channel selection that optimizes the exit channel for aftermarket mobile devices by analyzing market conditions across multiple sales channels and selecting channels that maximize recovery value while accounting for time-to-sale and depreciation factors.

The method 800 begins at a step 802 of receiving global market price data from direct-to-consumer and wholesale platforms. In the step 802, the system may receive real-time pricing information from multiple sales channels that are available for aftermarket mobile device sales. The direct-to-consumer platforms may include online marketplaces, retail storefronts, and other channels where devices are sold directly to end users. The wholesale platforms may include bulk purchasing channels, liquidation markets, and business-to-business sales channels where devices are sold to resellers or other intermediaries. The market price data received in the step 802 may include current listing prices, recent sale prices, inventory levels, demand indicators, and other metrics that characterize market conditions across the available channels.

The market price data received in the step 802 may be collected from application programming interfaces provided by the sales platforms, from web scraping of publicly available pricing information, from data feeds provided by market data aggregators, or from internal sales records of the organization operating the aftermarket processing facility. The market price data may be received on a continuous or periodic basis to maintain current information about market conditions. The market price data may be stored in the database 106 and made available to the AI engine 110 for analysis and channel selection decisions.

With continued reference to FIG. 8, the method 800 proceeds to a step 804 in which a reinforcement learning agent continuously monitors global market prices. In the step 804, the reinforcement learning agent may observe market conditions and price trends across the direct-to-consumer and wholesale channels to inform channel selection decisions. The reinforcement learning agent may track changes in market prices over time, identifying trends such as price increases or decreases for particular device models, seasonal variations in demand, and shifts in the relative attractiveness of different channels.

The reinforcement learning agent in the step 804 may maintain a representation of the current market state that captures relevant features of the pricing environment across channels. The market state representation may include current prices for devices of different models, conditions, and ages across the available channels. The market state representation may also include derived features such as price trends, price volatility, inventory levels, and demand indicators that characterize the dynamics of the market. The reinforcement learning agent may use the market state representation to inform decisions about which channel to select for each device entering the channel selection process.

The reinforcement learning agent may continuously monitor global market prices across direct-to-consumer and wholesale platforms for dynamic channel selection. The continuous monitoring may enable the reinforcement learning agent to adapt channel selection decisions to changing market conditions in real time or near real time. As market prices shift due to supply and demand dynamics, competitive actions, or other market factors, the reinforcement learning agent may adjust channel selection to route devices to channels that offer favorable conditions given the current market state.

The method 800 proceeds to a step 806 of applying a Gradient Boosted Decision Trees price forecasting model to the market data. In the step 806, Gradient Boosted Decision Trees may be deployed for price forecasting to generate predictions of future prices across the available channels. Gradient Boosted Decision Trees are an ensemble learning method that combines multiple decision trees trained sequentially, with each subsequent tree trained to correct the errors of the previous trees. Gradient Boosted Decision Trees may capture complex, non-linear relationships between input features and price outcomes, enabling accurate price forecasting based on device characteristics and market conditions.

The Gradient Boosted Decision Trees price forecasting model in the step 806 may receive input features that characterize the device being processed and the current market conditions. The input features may include device characteristics such as model, storage capacity, cosmetic condition grade, functional condition, and age. The input features may also include market features derived from the market price data received in the step 802, such as current prices, recent price trends, and inventory levels across channels. The Gradient Boosted Decision Trees model may generate price forecasts for each available channel, predicting the expected sale price that would be achieved if the device were routed to that channel.

The price forecasts generated in the step 806 may account for factors that affect realized sale prices in different channels. Direct-to-consumer channels may achieve higher sale prices due to the absence of intermediary margins, but may also exhibit greater price variability depending on buyer demand and competitive listings. Wholesale channels may achieve lower sale prices due to bulk purchasing discounts and intermediary margins, but may offer more predictable pricing and faster sales. The Gradient Boosted Decision Trees model may learn these channel-specific pricing dynamics from historical sales data and incorporate them into the price forecasts.

With continued reference to FIG. 8, the method 800 proceeds to a step 808 of applying a Deep Q-Network channel selection model. In the step 808, Deep Q-Networks may be deployed for channel selection to identify candidate exit channels for the device based on the forecasted prices and market conditions. Deep Q-Networks are a reinforcement learning approach that uses deep neural networks to approximate the Q-function, which estimates the expected cumulative reward for taking each possible action in a given state. The Deep Q-Network may learn to select channels that maximize expected recovery value over time based on experience from previous channel selection decisions and their outcomes.

The Deep Q-Network in the step 808 may receive as input a state representation that includes the device characteristics, the price forecasts generated by the Gradient Boosted Decision Trees model in the step 806, and the current market state observed by the reinforcement learning agent in the step 804. The Deep Q-Network may output Q-values for each available channel, representing the estimated expected cumulative reward for routing the device to that channel. The Q-values may account for both the immediate reward from the sale of the current device and the long-term effects of the channel selection decision on future opportunities and market conditions.

The Deep Q-Network may be trained using experience replay, where past channel selection decisions and their outcomes are stored in a replay buffer and sampled during training to update the network parameters. The training process may use temporal difference learning to update Q-value estimates based on observed rewards and estimated future values. The Deep Q-Network may be periodically updated as new experience is collected from channel selection decisions, enabling the model to adapt to changing market dynamics and improve channel selection performance over time.

The method 800 proceeds to a step 810 of evaluating direct-to-consumer margins against wholesale days-to-sell and depreciation risks. In the step 810, the system may balance the higher margins of direct-to-consumer channels against the lower days-to-sell and depreciation risks of wholesale liquidation. Direct-to-consumer channels may offer higher sale prices and margins compared to wholesale channels, but may also involve longer time periods between listing and sale. Wholesale channels may offer lower sale prices but may enable faster sales with more predictable timing.

The evaluation in the step 810 may account for depreciation that occurs while devices remain unsold. Mobile device values tend to decline over time due to the introduction of newer device models, changes in market demand, and general market depreciation trends. Devices that remain unsold for extended periods in direct-to-consumer channels may experience value decline that offsets the higher margins available in those channels. The evaluation may compare the expected net recovery value from direct-to-consumer channels, accounting for expected time to sale and depreciation, against the expected net recovery value from wholesale channels with faster but lower-priced sales.

The evaluation in the step 810 may also account for inventory carrying costs and opportunity costs associated with different channel selections. Devices held in inventory while awaiting sale in direct-to-consumer channels may incur storage costs, insurance costs, and capital costs that reduce net recovery value. The opportunity cost of capital tied up in unsold inventory may also factor into the evaluation. Wholesale channels that enable faster inventory turnover may reduce these carrying costs and opportunity costs, partially offsetting the lower sale prices achieved in wholesale channels.

The system may balance the higher margins of direct-to-consumer channels against the lower days-to-sell and depreciation risks of wholesale liquidation by computing expected net recovery values that incorporate all relevant factors. The expected net recovery value for each channel may be computed based on the forecasted sale price, the expected time to sale, the expected depreciation during the time to sale, and the carrying costs incurred during the time to sale. The channel with the highest expected net recovery value may be identified as the optimal channel for the device.

The method 800 concludes with a step 812 of selecting the optimal exit channel based on the evaluation. In the step 812, the system may select the channel that maximizes the expected return while accounting for time-to-sale and depreciation factors. The selected channel may represent the routing decision that is expected to achieve the highest net recovery value for the device given the current market conditions, device characteristics, and the tradeoffs between margin, time to sale, and depreciation risk evaluated in the step 810.

The channel selection in the step 812 may be informed by the Q-values output by the Deep Q-Network in the step 808 and the evaluation performed in the step 810. The Deep Q-Network Q-values may capture learned patterns about which channels tend to yield better outcomes for devices with particular characteristics under particular market conditions. The evaluation in the step 810 may provide explicit computation of expected net recovery values based on the price forecasts and market factors. The channel selection may combine these inputs to identify the optimal exit channel for the device.

The selected channel in the step 812 may be communicated to downstream systems that execute the routing decision. The device may be routed to the selected channel for listing, sale, or transfer to channel partners. The outcome of the channel selection decision, including the actual sale price achieved and the time to sale, may be recorded and used to update the reinforcement learning agent and the Deep Q-Network, enabling continuous improvement of channel selection performance based on observed outcomes.

The method 800 may enable dynamic channel selection that adapts to changing market conditions and optimizes recovery value across the portfolio of devices processed through the aftermarket facility. By continuously monitoring market prices, forecasting prices using Gradient Boosted Decision Trees, and selecting channels using Deep Q-Networks, the method 800 may identify channel routing decisions that balance the competing factors of margin, time to sale, and depreciation risk. The reinforcement learning approach may enable the system to learn effective channel selection strategies from experience and adapt to market dynamics that may be difficult to capture through static rule-based routing systems.

The system may employ cosmetic enhancement modeling to assess the potential for improving device condition through cosmetic restoration services, enabling identification of devices where targeted restoration may increase recovery value. Cosmetic enhancement modeling may analyze device images to detect surface defects that may be amenable to restoration, and may predict the improvement in device grade that would result from performing cosmetic restoration services. By identifying devices where cosmetic restoration would yield favorable returns, the system may trigger value-add workflows that increase net recovery value for devices in the aftermarket processing pipeline.

Convolutional neural networks may be employed for high-resolution image analysis to detect micro-abrasions and surface scratches on mobile device surfaces. Micro-abrasions are fine surface scratches that may not be readily visible under normal viewing conditions but may affect the perceived quality and grade of a device under close inspection or under particular lighting conditions. Surface scratches may include visible marks on device screens, backs, or edges that result from contact with abrasive materials, keys, or other objects during normal device use. Convolutional neural networks may learn to recognize the visual signatures of micro-abrasions and surface scratches from training data comprising device images with annotated defect locations and types.

The convolutional neural networks employed for cosmetic enhancement modeling may process high-resolution device images captured during intake or inspection stages of the aftermarket processing pipeline. High-resolution images may capture fine surface details that would not be visible in lower-resolution images, enabling detection of micro-abrasions and subtle scratches that affect device grade assessments. The convolutional neural networks may apply learned convolutional filters across the image to detect local patterns indicative of surface defects, and may aggregate local detections to produce an overall assessment of cosmetic condition and defect distribution across the device surface.

The convolutional neural networks may be trained on datasets of device images with annotations indicating the locations and types of cosmetic defects present. The training data may include images of devices with varying levels of cosmetic wear, from pristine devices with no visible defects to devices with extensive scratching and surface damage. The training data may also include annotations indicating the device grade assigned by human inspectors, enabling the convolutional neural networks to learn the relationship between detected defects and grade assignments. The convolutional neural networks may learn to detect defects that are relevant to grade determination while ignoring visual features that do not affect grading.

The cosmetic enhancement modeling may predict the improvement in device grade that would result from performing cosmetic restoration services such as buffing and polishing. Buffing and polishing services may remove or reduce the visibility of micro-abrasions and surface scratches through mechanical abrasion that smooths the device surface. The effectiveness of buffing and polishing may depend on the depth and severity of the scratches, with shallow scratches being more amenable to removal than deep scratches that penetrate below the surface layer. The cosmetic enhancement modeling may assess the characteristics of detected defects and predict whether buffing and polishing would successfully improve device appearance.

The system may trigger a value-add workflow when the cosmetic enhancement model predicts a high probability that a buff and polish service will elevate the device grade from a lower grade to a higher grade. In some cases, the system may trigger the value-add workflow when the model predicts high probability that buff and polish service will elevate device grade from Grade B to Grade A. Grade A devices may command higher prices in secondary markets compared to Grade B devices due to their superior cosmetic condition. The value-add workflow may route the device to cosmetic restoration services where buffing and polishing may be performed to improve device appearance and achieve the higher grade.

The decision to trigger the value-add workflow may be based on an economic analysis that compares the expected increase in recovery value from achieving the higher grade against the cost of performing the cosmetic restoration service. The expected increase in recovery value may be computed based on the price differential between Grade A and Grade B devices in the target sales channel, multiplied by the predicted probability that the cosmetic restoration will successfully achieve the grade improvement. The cost of the cosmetic restoration service may include labor costs, materials costs, and the time cost of the additional processing step. The value-add workflow may be triggered when the expected increase in recovery value exceeds the cost of the cosmetic restoration service by a threshold margin.

The cosmetic enhancement modeling may support multi-objective optimization that balances competing criteria in device processing decisions. Multi-objective optimization may balance competing criteria such as processing speed, recovery value, and environmental impact when determining whether to perform cosmetic restoration services. Processing speed may be affected by the additional time required to perform buffing and polishing, which may delay device availability for sale and increase depreciation exposure. Recovery value may be increased by achieving a higher device grade through cosmetic restoration. Environmental impact may be affected by the materials and energy consumed in the cosmetic restoration process.

The multi-objective optimization may evaluate tradeoffs between the competing criteria to identify processing decisions that achieve acceptable performance across all criteria. In some cases, the multi-objective optimization may identify Pareto-optimal solutions where no criterion can be improved without degrading another criterion. In some cases, the multi-objective optimization may apply weighting factors to the criteria to compute a single objective function that reflects the relative importance of each criterion. The weighting factors may be configured based on organizational priorities, market conditions, or regulatory requirements that affect the relative importance of processing speed, recovery value, and environmental impact.

The cosmetic enhancement modeling may be integrated with the device decision engine to inform routing decisions for devices in the aftermarket processing pipeline. When a device is assessed and the cosmetic enhancement model predicts that cosmetic restoration would yield favorable returns, the device decision engine may route the device to the value-add workflow for buffing and polishing. When the cosmetic enhancement model predicts that cosmetic restoration would not yield favorable returns, such as when defects are too severe to be addressed by buffing and polishing or when the cost of restoration exceeds the expected value increase, the device decision engine may route the device to other processing pathways appropriate for its current condition.

The cosmetic enhancement modeling may generate confidence scores that indicate the reliability of grade improvement predictions. The confidence scores may reflect uncertainty in the prediction due to factors such as image quality, unusual defect patterns, or limited training data for devices with similar characteristics. The confidence scores may be used to determine whether to proceed with the value-add workflow or to request additional inspection or assessment before making the routing decision. Devices with high-confidence predictions of successful grade improvement may be routed directly to the value-add workflow, while devices with lower-confidence predictions may be flagged for human review or additional diagnostic assessment.

The cosmetic enhancement modeling may be updated over time based on observed outcomes of cosmetic restoration services. When devices undergo buffing and polishing, the actual grade achieved after restoration may be compared to the predicted grade improvement. Discrepancies between predicted and actual outcomes may be used to refine the cosmetic enhancement model, improving prediction accuracy for future devices. The feedback loop between predictions and outcomes may enable continuous improvement of the cosmetic enhancement modeling as the system accumulates experience with different device types, defect patterns, and restoration outcomes.

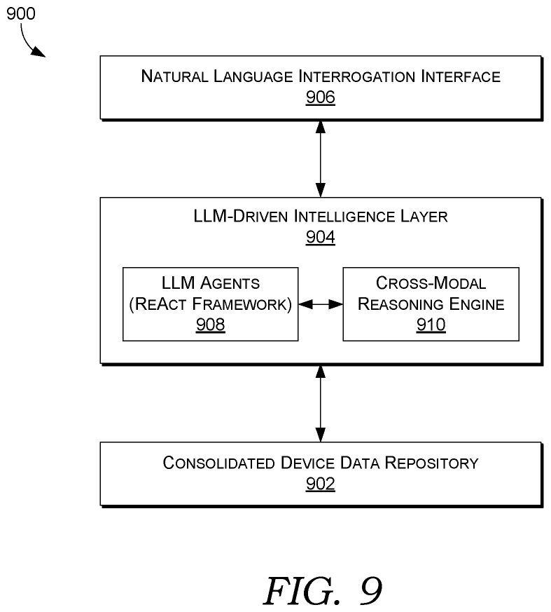

Referring now to FIG. 9, an LLM intelligence layer structure 900 for providing natural language access to consolidated device data and enabling autonomous agent-driven actions is illustrated. The LLM intelligence layer structure 900 may be implemented as a component of the AI engine 110 of the operating environment 100 described with reference to FIG. 1, or may be implemented as a separate processing layer that interfaces with the device data repository and provides intelligence capabilities to stakeholders in the mobile device aftermarket ecosystem. The LLM intelligence layer structure 900 may enable stakeholders to interact with device data using natural language and may enable autonomous execution of actions based on insights derived from the device data.

The LLM intelligence layer structure 900 includes a consolidated device data repository 902 at the base layer. The consolidated device data repository 902 may store aggregated device data from multiple sources across the device lifecycle, providing the underlying data foundation for the intelligence layer operations. The consolidated device data repository 902 may include the remote device data 118, the physical access data 120, the downstream data 122, and the device user data 124 described with reference to FIG. 1. The consolidated device data repository 902 may also include device passport data, diagnostic results, inspection findings, repair histories, market data, and other information collected throughout the aftermarket processing pipeline.

The consolidated device data repository 902 may aggregate data from diverse sources into a unified data store that enables comprehensive analysis and querying across the full scope of available device information. The aggregation may involve data transformation, normalization, and indexing to enable efficient retrieval and analysis of data from different sources with different formats and schemas. The consolidated device data repository 902 may maintain relationships between data elements, enabling queries that traverse relationships such as retrieving all repair records associated with devices of a particular model or retrieving all devices processed through a particular inspection facility.

With continued reference to FIG. 9, the LLM intelligence layer structure 900 includes an LLM-driven intelligence layer 904 that serves as the central processing tier of the LLM intelligence layer structure 900. The LLM-driven intelligence layer 904 may communicate bidirectionally with the consolidated device data repository 902, retrieving data from the repository to support intelligence operations and storing results or derived data back to the repository. The LLM-driven intelligence layer 904 may employ large language models to process natural language inputs, reason over device data, and generate natural language outputs that convey insights and recommendations to stakeholders.

The LLM-driven intelligence layer 904 may include LLM agents 908 that implement a ReAct (Reasoning and Acting) framework to perform autonomous actions based on data insights. The ReAct framework combines reasoning and acting in an interleaved manner, where the LLM agents 908 may generate reasoning traces that explain the thought process leading to actions, and may execute actions that interact with external systems or data sources. The reasoning traces may provide transparency into the decision-making process of the LLM agents 908, enabling stakeholders to understand why particular actions were taken.

The LLM agents 908 may reason over device data stored in the consolidated device data repository 902 and execute actions such as generating reports, triggering alerts, or initiating downstream processing decisions. In some cases, the LLM agents 908 may identify trends or patterns in the device data that warrant action. For example, if a predictive model identifies a trend of battery failures in a specific model year, the LLM agents 908 may autonomously update a pricing model to account for mandatory battery replacements. The LLM agents 908 may also draft a bulk purchase order for replacement batteries from a pre-approved vendor based on the identified trend. The LLM agents 908 may further adjust a device passport template to highlight battery health for the specific batch of devices affected by the identified trend.

The LLM agents 908 utilizing the ReAct framework may perform autonomous actions based on data insights by iterating through cycles of observation, reasoning, and action. In each cycle, the LLM agents 908 may observe the current state of the device data and any relevant context, generate reasoning about what actions may be appropriate given the observations, and execute actions that affect external systems or data. The actions executed by the LLM agents 908 may include querying the consolidated device data repository 902 for additional information, invoking external services or APIs, updating records in the repository, or generating communications to stakeholders.

The LLM-driven intelligence layer 904 may include a cross-modal reasoning engine 910 that employs multimodal large language models to perform reasoning across heterogeneous data types. The cross-modal reasoning engine 910 may process both structured data such as diagnostic logs and telemetry readings, and unstructured data such as device photographs and textual descriptions. By reasoning across multiple data modalities, the cross-modal reasoning engine 910 may correlate information from different sources to produce comprehensive assessments of device condition.

Multimodal large language models employed by the cross-modal reasoning engine 910 may reason across both diagnostic logs, which comprise structured data, and physical photos of the device, which comprise unstructured data, to provide a unified summary of device condition. The multimodal large language models may process diagnostic logs to understand the functional state of device subsystems, including any faults, anomalies, or degradation indicated by the diagnostic data. The multimodal large language models may process device photographs to understand the cosmetic condition of the device, including any visible damage, wear, or defects apparent in the images. By reasoning across both data types, the multimodal large language models may produce unified summaries that integrate functional and cosmetic assessments into coherent descriptions of overall device condition.

The cross-modal reasoning engine 910 may enable the system to identify relationships between functional issues indicated in diagnostic logs and physical damage visible in device photographs. For example, the cross-modal reasoning engine 910 may correlate a diagnostic indication of display malfunction with visible screen damage in a device photograph, providing a unified assessment that the display requires replacement due to physical damage. The cross-modal reasoning engine 910 may also identify cases where diagnostic data and photographic evidence provide complementary information, such as when diagnostic data indicates battery degradation while photographs show no external damage, suggesting internal wear rather than physical impact.

The LLM agents 908 and the cross-modal reasoning engine 910 may communicate bidirectionally to coordinate reasoning and action execution. The cross-modal reasoning engine 910 may provide the LLM agents 908 with unified device condition assessments that inform action decisions. The LLM agents 908 may request specific analyses from the cross-modal reasoning engine 910 when additional cross-modal reasoning is needed to support action planning. The coordination between the LLM agents 908 and the cross-modal reasoning engine 910 may enable sophisticated workflows that combine cross-modal analysis with autonomous action execution.

With continued reference to FIG. 9, the LLM intelligence layer structure 900 includes a natural language interrogation interface 906 at the top layer. The natural language interrogation interface 906 may provide stakeholders with the ability to query and interact with device data using natural language. The natural language interrogation interface 906 may communicate bidirectionally with the LLM-driven intelligence layer 904, transmitting natural language queries from stakeholders to the intelligence layer and receiving natural language responses that convey query results and insights.

The natural language interrogation interface 906 may enable stakeholders such as warehouse managers, insurance adjusters, repair technicians, and other personnel to query the device data using natural language without requiring knowledge of database query languages or data schemas. Stakeholders may formulate queries in natural language that describe the information they seek, and the natural language interrogation interface 906 may interpret the queries and retrieve relevant information from the consolidated device data repository 902 through the LLM-driven intelligence layer 904.

In some cases, stakeholders may query the dataset using natural language to retrieve specific subsets of device data based on multiple criteria. For example, a stakeholder may submit a query such as requesting all devices of a particular model in a recent batch that have a high probability of screen failure but low cosmetic wear. The natural language interrogation interface 906 may interpret this query, identify the relevant data fields and filtering criteria, and retrieve matching device records from the consolidated device data repository 902. The query results may be returned to the stakeholder in a natural language response that summarizes the matching devices and their characteristics.

The natural language interrogation interface 906 may support various types of queries including retrieval queries that request specific device records or data fields, aggregation queries that request summary statistics or counts across device populations, trend queries that request analysis of how metrics have changed over time, and comparison queries that request analysis of differences between device groups or time periods. The LLM-driven intelligence layer 904 may interpret the query type and formulate appropriate data retrieval and analysis operations to satisfy the query.

The natural language interrogation interface 906 may also support conversational interactions where stakeholders may ask follow-up questions or request clarification based on previous query results. The LLM-driven intelligence layer 904 may maintain context from previous queries in a conversation, enabling stakeholders to refine their queries or explore related information without restating the full context of their inquiry. Conversational interactions may enable more natural and efficient exploration of device data compared to isolated single-query interactions.

The natural language interrogation interface 906 may be accessed through various client interfaces including web-based dashboards, mobile applications, chat interfaces, or voice-based interfaces. The client device 104 may provide a user interface through which stakeholders submit natural language queries and receive responses from the natural language interrogation interface 906. The natural language interrogation interface 906 may format responses appropriately for the client interface, such as providing text responses for chat interfaces or structured data for dashboard visualizations.

The LLM intelligence layer structure 900 may enable more accessible and efficient interaction with device data compared to traditional database query interfaces. By accepting natural language queries, the natural language interrogation interface 906 may reduce the technical expertise required to retrieve and analyze device data, enabling a broader range of stakeholders to access insights from the consolidated device data repository 902. By employing the LLM agents 908 to perform autonomous actions, the LLM intelligence layer structure 900 may reduce the manual effort required to respond to identified trends and patterns, enabling faster and more consistent execution of data-driven workflows.

The LLM agents may perform autonomous actions based on data insights derived from analysis of device data stored in the consolidated device data repository. The autonomous actions may include updating pricing models, drafting purchase orders, and adjusting device passport templates in response to identified trends or patterns in device data. The autonomous actions may reduce the manual effort required to respond to data insights and may enable faster execution of data-driven workflows compared to manual processes that require human review and action for each identified insight.

In some cases, the LLM agents may autonomously update a pricing model to account for mandatory battery replacements when predictive models identify battery failure trends. The predictive models may analyze device telemetry data, repair histories, and failure records to identify trends indicating elevated battery failure rates for devices of particular models, model years, or batches. When the predictive models identify a battery failure trend, the LLM agents may receive notification of the identified trend and may initiate autonomous action to update pricing models that are affected by the trend.

The autonomous pricing model update may adjust device valuations to account for the expected cost of mandatory battery replacements for devices affected by the identified battery failure trend. The LLM agents may retrieve current pricing model parameters from the consolidated device data repository or from pricing systems that maintain device valuation models. The LLM agents may compute adjusted valuations that subtract the expected cost of battery replacement from the baseline device value, reflecting the anticipated expense that will be incurred to address the battery failure issue before the device can be sold or returned to service.

The expected cost of battery replacement used in the pricing model update may include the cost of replacement battery components, labor costs for performing the battery replacement procedure, and any associated costs such as diagnostic testing before and after replacement. The LLM agents may retrieve cost information from vendor catalogs, historical repair cost records, or cost estimation models maintained in the consolidated device data repository. The LLM agents may apply the cost adjustment to all devices matching the criteria associated with the identified battery failure trend, such as devices of a particular model manufactured within a particular date range or devices from a particular batch that exhibited the failure pattern.

The autonomous pricing model update may be executed through integration with pricing systems that maintain device valuation models. The LLM agents may invoke application programming interfaces provided by the pricing systems to submit updated valuation parameters. In some cases, the LLM agents may generate configuration files or data records that specify the pricing adjustments, and may store the configuration files or data records in locations where the pricing systems will retrieve and apply them. The LLM agents may generate audit records documenting the pricing model update, including the identified trend that triggered the update, the devices affected by the update, and the magnitude of the valuation adjustment applied.

In some cases, the LLM agents may autonomously draft a bulk purchase order for replacement batteries from a pre-approved vendor. When predictive models identify battery failure trends affecting a population of devices, the LLM agents may estimate the quantity of replacement batteries that will be required to address the anticipated failures. The quantity estimate may be based on the number of devices affected by the identified trend, the predicted failure rate for those devices, and the expected timing of when the devices will require battery replacement.

The LLM agents may retrieve vendor information from the consolidated device data repository or from vendor management systems that maintain records of pre-approved vendors for replacement components. Pre-approved vendors may be vendors that have been qualified through vendor assessment processes and have established agreements for supplying replacement components at negotiated prices and terms. The LLM agents may select an appropriate pre-approved vendor based on factors such as component availability, pricing, lead time, and historical performance metrics for the vendor.

The LLM agents may draft a bulk purchase order that specifies the replacement battery component, the quantity required, the requested delivery date, and other terms relevant to the purchase. The draft purchase order may be formatted according to templates or standards used by the organization for procurement documents. The LLM agents may populate the purchase order with vendor contact information, component specifications, pricing from negotiated agreements, and shipping instructions retrieved from the consolidated device data repository or procurement systems.

The draft purchase order generated by the LLM agents may be routed for review and approval before submission to the vendor, or may be submitted directly to the vendor depending on the authorization level configured for autonomous procurement actions. In some cases, purchase orders below a threshold value may be submitted autonomously without human review, while purchase orders above the threshold value may be routed to procurement personnel for approval. The LLM agents may generate notifications to relevant personnel informing them of the draft purchase order and the data insights that triggered the procurement action.

In some cases, the LLM agents may autonomously adjust a device passport template to highlight battery health for specific batches of devices. When predictive models identify battery failure trends affecting devices from particular batches, the LLM agents may update the device passport template used for those batches to include enhanced presentation of battery health information. The enhanced presentation may draw attention to battery health metrics that are relevant to the identified failure trend, enabling downstream recipients of the device passport to be aware of the battery-related concerns associated with devices from the affected batches.

The device passport template adjustment may add or modify sections of the device passport that present battery health information. The adjustment may include adding warning indicators or flags that highlight elevated battery failure risk for devices from the affected batches. The adjustment may include adding explanatory text that describes the identified battery failure trend and its implications for device longevity and value. The adjustment may include modifying the visual presentation of battery health metrics to increase their prominence within the device passport layout.

The LLM agents may identify the specific batches affected by the identified battery failure trend based on criteria such as device model, manufacturing date range, or batch identifiers associated with the devices that exhibited the failure pattern. The LLM agents may retrieve batch information from the consolidated device data repository and may determine which device passport template or templates are used for devices from the affected batches. The LLM agents may generate updated versions of the affected templates that incorporate the battery health highlighting modifications.

The updated device passport templates may be stored in template repositories where they will be used for generating device passports for devices from the affected batches. The LLM agents may update template selection rules or configuration settings to ensure that devices from the affected batches receive device passports generated using the updated templates with battery health highlighting. The LLM agents may generate audit records documenting the template adjustment, including the identified trend that triggered the adjustment, the batches affected by the adjustment, and the specific modifications made to the template.

The autonomous actions performed by the LLM agents may be configured with guardrails and constraints that limit the scope and impact of autonomous actions. The guardrails may include approval requirements for actions that exceed threshold values or affect large numbers of devices. The guardrails may include validation checks that verify the reasonableness of proposed actions before execution. The guardrails may include rollback capabilities that enable reversal of autonomous actions if subsequent review identifies errors or unintended consequences. The guardrails may enable autonomous execution of routine actions while maintaining human oversight for actions with larger scope or impact.

The autonomous actions performed by the LLM agents may be logged and monitored to enable review of agent behavior and identification of opportunities for improvement. The logs may record the data insights that triggered each autonomous action, the reasoning process followed by the LLM agents in determining the appropriate action, and the specific actions executed. The logs may enable auditing of autonomous actions for compliance with organizational policies and regulatory requirements. The logs may also provide training data for improving the LLM agents over time based on feedback about the appropriateness and effectiveness of autonomous actions.

The system may employ various approaches for determining when to trigger maintenance recommendations or routing decisions for mobile devices in the aftermarket processing pipeline. The determination of when to trigger maintenance actions may involve evaluation of device condition metrics against threshold criteria, with the threshold criteria configured to balance competing factors such as processing efficiency, recovery value, and quality assurance. Different approaches for threshold determination and trigger logic may offer different tradeoffs in terms of adaptability, economic optimization, robustness, and human oversight.

Adaptive thresholds may be employed to adjust trigger criteria based on device model, usage patterns, or market conditions rather than using fixed threshold values for maintenance recommendations. Fixed thresholds may apply the same trigger criteria to all devices regardless of device-specific characteristics or contextual factors, which may result in suboptimal decisions when device populations are heterogeneous or when market conditions vary over time. Adaptive thresholds may adjust the trigger criteria based on factors that affect the appropriateness of maintenance actions for specific devices or under specific conditions.

Adaptive thresholds may adjust based on device model to account for differences in reliability characteristics, component costs, and market values across device models. Different device models may have different expected lifespans, different failure modes, and different repair cost structures. A threshold that is appropriate for triggering battery replacement recommendations for one device model may be too aggressive or too conservative for another device model with different battery characteristics or different battery replacement costs. Adaptive thresholds may be configured with model-specific threshold values that reflect the characteristics of each device model, or may be computed dynamically based on model-specific parameters retrieved from device specification databases.

Adaptive thresholds may adjust based on usage patterns to account for differences in how devices have been used and the implications of usage patterns for device condition and remaining useful life. Devices with intensive usage patterns, such as high screen-on time, frequent charging cycles, or exposure to extreme temperatures, may experience accelerated degradation compared to devices with lighter usage patterns. Adaptive thresholds may lower maintenance trigger thresholds for devices with intensive usage patterns, triggering maintenance recommendations earlier to address degradation that may be progressing more rapidly. Adaptive thresholds may raise maintenance trigger thresholds for devices with lighter usage patterns, avoiding unnecessary maintenance recommendations for devices that may have substantial remaining useful life despite reaching nominal threshold values.

Adaptive thresholds may adjust based on market conditions to account for changes in the economic context that affect the value of maintenance actions. Market conditions may include factors such as current resale prices for devices of different models and conditions, availability and cost of replacement components, demand levels in different sales channels, and depreciation rates. When market conditions favor higher device values, adaptive thresholds may lower maintenance trigger thresholds to capture value through maintenance actions that improve device condition and enable higher sale prices. When market conditions result in lower device values, adaptive thresholds may raise maintenance trigger thresholds to avoid maintenance costs that may not be recovered through improved sale prices.

Adaptive thresholds may be implemented through parameterized threshold functions that compute threshold values based on input parameters characterizing device model, usage patterns, and market conditions. The parameterized threshold functions may be defined based on domain expertise, historical analysis of maintenance outcomes, or machine learning models trained to predict optimal threshold values. The parameterized threshold functions may be updated over time as new data becomes available about the relationship between threshold settings and maintenance outcomes under different conditions.

Cost-sensitive decision boundaries may be employed to incorporate economic factors into maintenance trigger decisions. Cost-sensitive decision boundaries may evaluate the expected economic impact of maintenance actions and may trigger maintenance recommendations when the expected economic benefit exceeds the expected economic cost. The economic factors incorporated into cost-sensitive decision boundaries may include repair costs, market values, and depreciation rates that affect the net economic outcome of maintenance decisions.

Cost-sensitive decision boundaries may incorporate repair costs that represent the expense of performing maintenance actions. Repair costs may include component costs for replacement parts, labor costs for technician time, equipment costs for diagnostic and repair tools, and overhead costs allocated to repair operations. The repair costs may vary based on the type of maintenance action, the device model, the availability of replacement components, and the labor rates at the processing facility. Cost-sensitive decision boundaries may compare the repair costs against the expected value improvement from the maintenance action to determine whether the maintenance action is economically justified.

Cost-sensitive decision boundaries may incorporate market values that represent the prices at which devices may be sold in downstream channels. Market values may vary based on device model, condition grade, age, and current market demand. Cost-sensitive decision boundaries may estimate the market value of a device in its current condition and the market value of the device after the proposed maintenance action. The difference between the post-maintenance market value and the pre-maintenance market value may represent the value improvement attributable to the maintenance action. Cost-sensitive decision boundaries may trigger maintenance recommendations when the value improvement exceeds the repair costs by a threshold margin.

Cost-sensitive decision boundaries may incorporate depreciation rates that represent the rate at which device values decline over time. Depreciation may occur due to the introduction of newer device models, changes in market demand, and general market trends that reduce the value of older devices. Depreciation rates may affect maintenance decisions because maintenance actions require time to complete, during which the device may depreciate. Cost-sensitive decision boundaries may account for expected depreciation during the maintenance period when evaluating whether maintenance actions are economically justified. Maintenance actions with longer completion times may need to provide larger value improvements to offset the depreciation that occurs during the maintenance period.

Cost-sensitive decision boundaries may be implemented through economic optimization models that compute the expected net economic value of maintenance actions. The economic optimization models may compute expected net value as the expected post-maintenance market value minus the pre-maintenance market value minus the repair costs minus the expected depreciation during the maintenance period. The economic optimization models may trigger maintenance recommendations when the expected net value exceeds a threshold that accounts for uncertainty and risk preferences. The threshold may be set to zero to trigger maintenance whenever expected net value is positive, or may be set to a positive value to require a margin of expected benefit before triggering maintenance.

Multi-objective optimization may be employed to balance competing criteria when determining maintenance triggers. Maintenance decisions may involve multiple objectives that may conflict with each other, such as maximizing recovery value, minimizing processing time, minimizing environmental impact, and maintaining quality standards. Multi-objective optimization may evaluate tradeoffs between competing objectives and may identify maintenance trigger decisions that achieve acceptable performance across multiple objectives.

Multi-objective optimization may balance processing speed against recovery value when determining maintenance triggers. Maintenance actions may increase recovery value by improving device condition, but may also increase processing time by adding steps to the processing pipeline. Multi-objective optimization may evaluate the tradeoff between the value improvement from maintenance and the time cost of performing maintenance, identifying trigger decisions that achieve an appropriate balance based on organizational priorities and market conditions.

Multi-objective optimization may balance recovery value against environmental impact when determining maintenance triggers. Maintenance actions may have environmental implications through the consumption of replacement components, energy usage during repair processes, and waste generation from replaced components. Multi-objective optimization may evaluate the environmental costs of maintenance actions alongside the economic benefits, identifying trigger decisions that achieve acceptable environmental performance while maintaining economic viability.

Multi-objective optimization may be implemented through weighted objective functions that combine multiple objectives into a single optimization target. The weighted objective function may assign weights to each objective that reflect the relative importance of the objective. The weights may be configured based on organizational priorities, regulatory requirements, or stakeholder preferences. Multi-objective optimization may also be implemented through Pareto optimization that identifies solutions where no objective can be improved without degrading another objective, enabling decision-makers to select among Pareto-optimal solutions based on their preferences.

Probabilistic decision rules may be employed to account for prediction uncertainty when determining routing decisions. Predictions about device condition, maintenance outcomes, and market values may be uncertain due to limitations in available data, model accuracy, and inherent variability in device behavior and market dynamics. Probabilistic decision rules may incorporate uncertainty estimates into trigger decisions, adjusting trigger behavior based on the confidence of underlying predictions.

Probabilistic decision rules may account for prediction uncertainty by requiring higher confidence for trigger decisions with larger consequences. Maintenance actions with higher costs or longer processing times may require higher confidence that the maintenance action will yield positive outcomes before triggering. Maintenance actions with lower costs or shorter processing times may be triggered with lower confidence because the downside of incorrect triggers is smaller. Probabilistic decision rules may implement confidence thresholds that vary based on the magnitude of the proposed action.

Probabilistic decision rules may account for prediction uncertainty by adjusting expected value calculations to reflect risk. Rather than using point estimates of maintenance outcomes, probabilistic decision rules may use probability distributions that characterize the range of possible outcomes and their likelihoods. The expected value calculations may incorporate the full distribution of possible outcomes, and may apply risk adjustments that penalize high-variance outcomes or that weight downside outcomes more heavily than upside outcomes. Risk-adjusted expected value calculations may result in more conservative trigger decisions that account for the possibility of unfavorable outcomes.

Probabilistic decision rules may be implemented through Bayesian decision frameworks that combine prior beliefs about maintenance outcomes with observed evidence to compute posterior probabilities. The posterior probabilities may be used to compute expected utilities of different trigger decisions, and the decision with the highest expected utility may be selected. Bayesian decision frameworks may naturally incorporate uncertainty by representing beliefs as probability distributions and updating beliefs as new evidence becomes available.

Ensemble voting across multiple models may be employed to provide more robust trigger decisions. Individual predictive models may have different strengths and weaknesses, and may produce different predictions for the same device due to differences in model architecture, training data, or feature representations. Ensemble voting may aggregate predictions from multiple models to produce trigger decisions that are more robust to the limitations of any individual model.

Ensemble voting may aggregate predictions from multiple models using majority voting, where the trigger decision is determined by the prediction that receives the most votes across the ensemble members. Majority voting may reduce the impact of individual model errors by requiring agreement among multiple models before triggering maintenance actions. Majority voting may be appropriate when the ensemble members produce discrete predictions such as binary trigger or no-trigger recommendations.

Ensemble voting may aggregate predictions from multiple models using weighted averaging, where the predictions of ensemble members are combined using weights that reflect the reliability or accuracy of each member. Weighted averaging may assign higher weights to models that have demonstrated better predictive performance on validation data or that have characteristics that make them more suitable for the current prediction context. Weighted averaging may be appropriate when the ensemble members produce continuous predictions such as probability estimates or value predictions.

Ensemble voting may provide uncertainty estimates based on the agreement or disagreement among ensemble members. When ensemble members produce similar predictions, the ensemble may be considered confident in the prediction. When ensemble members produce divergent predictions, the ensemble may be considered uncertain. The degree of agreement among ensemble members may be quantified through metrics such as the variance of predictions across members or the entropy of the vote distribution. Uncertainty estimates from ensemble voting may be used in conjunction with probabilistic decision rules to adjust trigger behavior based on ensemble confidence.

Human-in-the-loop configurations may be employed to require operator confirmation for decisions below confidence thresholds. While automated trigger decisions may provide efficiency benefits for routine cases where predictions are confident, cases with lower confidence may benefit from human review to verify the appropriateness of proposed actions. Human-in-the-loop configurations may route low-confidence decisions to human operators for review and confirmation before executing maintenance actions.

Human-in-the-loop configurations may define confidence thresholds that determine which decisions are executed automatically and which decisions require human confirmation. Decisions with confidence scores above the threshold may be executed automatically without human review, enabling efficient processing of routine cases. Decisions with confidence scores below the threshold may be flagged for human review, with the proposed action presented to a human operator along with relevant device information and the reasoning behind the proposed action. The human operator may confirm the proposed action, modify the proposed action, or reject the proposed action based on their assessment of the situation.

Human-in-the-loop configurations may present relevant information to human operators to support informed decision-making. The information presented may include device characteristics, diagnostic results, condition assessments, predicted outcomes of proposed actions, confidence scores, and factors that contributed to the low confidence. The information presentation may highlight areas of uncertainty or factors that differ from typical cases, enabling human operators to focus their attention on the aspects of the decision that may benefit from human judgment.

Human-in-the-loop configurations may capture feedback from human operators to improve automated decision-making over time. When human operators confirm, modify, or reject proposed actions, the feedback may be recorded and used to refine the predictive models and trigger logic. Cases where human operators consistently modify or reject proposed actions may indicate systematic errors in the automated decision-making that can be addressed through model retraining or threshold adjustment. The feedback loop between automated decisions and human review may enable continuous improvement of the trigger decision system.

Human-in-the-loop configurations may be configured with different levels of human involvement based on the type of decision, the magnitude of the proposed action, or organizational policies. Some decisions may always require human confirmation regardless of confidence level, such as decisions involving high-value devices or decisions with regulatory implications. Other decisions may be fully automated regardless of confidence level when the consequences of incorrect decisions are limited. The configuration of human involvement levels may be adjusted based on operational experience and organizational risk tolerance.

The system may incorporate additional environmental and contextual data sources to improve predictions about device condition, value, and optimal processing decisions. Environmental and contextual data may provide information about factors external to the device itself that affect device condition, market dynamics, and the timing of processing decisions. By correlating device data with environmental and contextual information, the system may generate more accurate predictions and more informed recommendations for device routing, valuation, and maintenance.

Weather and climate data correlated with device location history may inform predictions of moisture or temperature-related damage. Mobile devices may be exposed to environmental conditions that affect device condition and longevity, including humidity, precipitation, temperature extremes, and temperature cycling. Weather and climate data may be obtained from meteorological services, weather APIs, or climate databases that provide historical and current weather information for geographic locations. Device location history may be obtained from satellite positioning data, cellular network location data, or Wi-Fi network connection records that indicate where a device has been used over its operational lifetime.

The system may correlate device location history with weather and climate data to estimate the environmental exposure that a device has experienced. For devices that have spent significant time in humid areas, the system may predict elevated risk of moisture-related damage such as corrosion of electrical contacts, degradation of adhesives, or malfunction of moisture-sensitive components. For devices that have spent significant time in coastal areas or beach environments, the system may predict elevated risk of salt corrosion or sand ingress that may affect device functionality. For devices that have spent significant time in cold climates, the system may predict elevated risk of battery degradation due to cold temperature exposure or thermal stress from temperature cycling between cold outdoor environments and heated indoor environments. For devices that have spent significant time in hot climates, the system may predict elevated risk of battery degradation, display degradation, or adhesive failure due to sustained high temperature exposure.

The correlation between device location history and weather data may be performed by mapping device location records to geographic coordinates and retrieving weather data for those coordinates during the time periods when the device was present at each location. The weather data may include temperature readings, humidity levels, precipitation amounts, and other meteorological variables that characterize the environmental conditions at each location. The system may aggregate the weather data across the device location history to compute cumulative exposure metrics such as total hours of exposure to high humidity, total hours of exposure to temperatures above or below threshold values, or total number of temperature cycles between specified temperature ranges.

The cumulative exposure metrics derived from weather and climate data correlation may be provided as input features to predictive models that assess device condition and predict failure likelihood. The predictive models may learn relationships between environmental exposure patterns and device outcomes based on training data that includes both environmental exposure metrics and observed device conditions or failure events. The predictive models may generate predictions that account for environmental factors that would not be apparent from device telemetry or diagnostic data alone, enabling more accurate assessment of devices that have experienced unusual environmental exposure.

Regional market data may adjust value predictions based on local supply and demand dynamics. Secondary market prices for mobile devices may vary across geographic regions due to differences in local supply, local demand, consumer preferences, economic conditions, and competitive dynamics. Regional market data may be obtained from secondary market platforms, price aggregation services, or internal sales records that provide pricing information segmented by geographic region. The regional market data may include current listing prices, recent sale prices, inventory levels, and demand indicators for devices of different models and conditions in different regions.

The system may adjust device value predictions based on regional market data to account for geographic variation in market conditions. When a device is being processed for sale in a particular region, the system may retrieve regional market data for that region and adjust the value prediction to reflect local market conditions. Regions with higher demand or lower supply for devices of a particular model may support higher sale prices, while regions with lower demand or higher supply may result in lower sale prices. The regional adjustment may be computed as a multiplier or offset applied to a baseline value prediction, or may be incorporated directly into value prediction models that include regional features as inputs.

Regional market data may also inform channel selection decisions by identifying regions where particular devices may achieve higher recovery values. The system may compare regional market data across available sales channels and regions to identify opportunities for geographic arbitrage, where devices may be routed to regions with more favorable market conditions. The channel selection process may balance the potential value improvement from regional routing against the costs of shipping devices to different regions and the time delays associated with regional distribution.

Seasonal patterns may inform optimal timing for device sales or refurbishment. Secondary market demand for mobile devices may exhibit seasonal variation due to factors such as holiday shopping periods, back-to-school seasons, new device release cycles, and general consumer spending patterns. Seasonal patterns may be identified through analysis of historical sales data that reveals recurring patterns in demand, pricing, and time-to-sale across different times of year. The seasonal patterns may vary by device model, device condition, geographic region, and sales channel.

The system may incorporate seasonal patterns into timing decisions for device sales and refurbishment. When seasonal patterns indicate that demand and prices are expected to increase in an upcoming period, the system may recommend holding devices in inventory to capture the higher prices during the favorable period. When seasonal patterns indicate that demand and prices are expected to decrease, the system may recommend accelerating sales to avoid the lower prices during the unfavorable period. The timing recommendations may balance the expected price improvement from optimal timing against the depreciation and carrying costs incurred while holding devices in inventory.

Seasonal patterns may also inform refurbishment scheduling by identifying periods when refurbishment capacity may be allocated to different device types. During periods preceding high-demand seasons, refurbishment capacity may be prioritized for device models that are expected to experience strong demand during the upcoming season. During lower-demand periods, refurbishment capacity may be allocated to devices with longer expected time-to-sale or to building inventory in anticipation of future demand periods. The seasonal scheduling may improve overall recovery value by aligning refurbishment activities with market demand patterns.

Carrier network quality data may contextualize communication subsystem diagnostics. Mobile devices communicate through cellular networks operated by carriers, and the quality of the carrier network may affect the communication performance observed during device diagnostics. Carrier network quality data may be obtained from carrier network monitoring services, crowdsourced network quality databases, or internal records of network performance metrics collected from devices operating on different carrier networks. The carrier network quality data may include metrics such as signal strength distributions, data throughput measurements, latency measurements, call quality scores, and coverage maps for different carriers and geographic areas.

The system may use carrier network quality data to contextualize communication subsystem diagnostics and distinguish between device-related issues and network-related issues. When diagnostic tests indicate communication performance below expected levels, the system may compare the observed performance against carrier network quality data for the network and location where the diagnostic was performed. If the carrier network quality data indicates that the network itself exhibits poor performance in that area, the diagnostic results may be attributed to network conditions rather than device malfunction. If the carrier network quality data indicates that the network normally provides good performance in that area, the diagnostic results may indicate a device-related issue that warrants further investigation or repair.

Carrier network quality data may also inform predictions about how devices will perform when deployed on different carrier networks. Devices that exhibited communication issues on one carrier network may perform acceptably on a different carrier network with better coverage or signal quality in the areas where the device is used. The system may incorporate carrier network quality data into device assessments to provide more nuanced evaluations that account for the interaction between device capabilities and network conditions.

Social media sentiment analysis may provide early indicators of model-specific issues or market trends. Social media platforms may contain discussions, reviews, and complaints about mobile devices that provide insight into device quality issues, user satisfaction, and market perception. Social media sentiment analysis may be performed by collecting social media posts that mention specific device models and analyzing the sentiment expressed in those posts using natural language processing techniques. The sentiment analysis may classify posts as positive, negative, or neutral, and may identify specific topics or issues mentioned in negative posts.

The system may use social media sentiment analysis to identify emerging issues with specific device models before those issues are reflected in formal diagnostic data or repair records. When social media sentiment analysis detects an increase in negative sentiment or complaints about a particular issue for a specific device model, the system may flag devices of that model for enhanced inspection or may adjust value predictions to account for the emerging issue. Early detection of model-specific issues through social media monitoring may enable proactive response before the issues result in increased returns, warranty claims, or customer dissatisfaction.

Social media sentiment analysis may also provide indicators of market trends that affect device demand and pricing. Positive sentiment and buzz about a device model may indicate strong market demand that supports higher prices. Negative sentiment or declining interest may indicate weakening demand that may result in lower prices or longer time-to-sale. The system may incorporate social media sentiment indicators into market forecasting models that predict future demand and pricing for different device models.

Economic indicators may inform predictions of secondary market demand and pricing. Secondary market demand for mobile devices may be influenced by broader economic conditions that affect consumer spending, disposable income, and willingness to purchase pre-owned devices versus new devices. Economic indicators may be obtained from government statistical agencies, economic research organizations, or financial data services that publish metrics characterizing economic conditions. The economic indicators may include measures such as consumer confidence indices, unemployment rates, inflation rates, gross domestic product growth, and retail sales figures.

The system may incorporate economic indicators into demand forecasting models that predict secondary market conditions. During periods of economic expansion with high consumer confidence and strong employment, consumers may have greater disposable income and may be more willing to purchase new devices, potentially reducing demand for pre-owned devices. During periods of economic contraction or uncertainty, consumers may seek cost savings by purchasing pre-owned devices rather than new devices, potentially increasing demand in the secondary market. The demand forecasting models may learn relationships between economic indicators and secondary market demand based on historical data that correlates economic conditions with market outcomes.

Economic indicators may also inform pricing predictions by capturing macroeconomic factors that affect the overall price level in secondary markets. Inflation may affect the nominal prices at which devices are sold, while changes in consumer purchasing power may affect the real prices that consumers are willing to pay. The system may adjust pricing predictions based on economic indicators to account for macroeconomic trends that affect market-wide pricing dynamics. The economic adjustments may be applied in combination with device-specific and regional factors to generate comprehensive value predictions that account for multiple levels of market influence.

The integration of environmental and contextual data sources may enable more accurate and comprehensive predictions by incorporating information that is not available from device data alone. Weather and climate data may reveal environmental exposure that affects device condition. Regional market data may capture geographic variation in market dynamics. Seasonal patterns may identify temporal variation in demand and pricing. Carrier network quality data may contextualize communication diagnostics. Social media sentiment may provide early indicators of emerging issues and trends. Economic indicators may capture macroeconomic influences on market conditions. By combining these contextual data sources with device-specific data, the system may generate predictions that account for the full range of factors affecting device condition, value, and optimal processing decisions.

The system may employ various user interface and interaction modalities to enable stakeholder interaction with device data, analytical outputs, and decision support capabilities. Different stakeholders in the mobile device aftermarket ecosystem may have different interaction requirements based on their roles, work environments, and information needs. Alternative interfaces may address these varying requirements by providing multiple modalities through which stakeholders may access system capabilities, submit data, receive insights, and execute actions.

Voice-based interfaces may enable hands-free querying during device processing operations. In processing environments where operators handle physical devices, voice-based interfaces may enable interaction with the system without requiring operators to set down devices or remove protective equipment to use keyboard or touch interfaces. Voice-based interfaces may accept spoken natural language queries and commands, process the speech input using speech recognition, and return spoken responses using text-to-speech synthesis.

Voice-based interfaces may be implemented through integration with speech recognition services that convert spoken audio to text transcriptions. The text transcriptions may be processed by the natural language interrogation interface to interpret query intent and retrieve relevant information from the consolidated device data repository. The query results may be converted to spoken responses using text-to-speech synthesis and delivered through speakers, headsets, or earpieces worn by operators. The voice-based interface may support conversational interactions where operators may ask follow-up questions or request clarification based on previous responses.

Voice-based interfaces may support various types of interactions relevant to device processing operations. Operators may query device information by speaking device identifiers and requesting specific data such as condition assessments, repair histories, or routing recommendations. Operators may submit observations or data by speaking descriptions of device condition, damage observations, or test results that are transcribed and recorded in the device data repository. Operators may request guidance by asking questions about processing procedures, repair techniques, or routing decisions for devices with particular characteristics.

Voice-based interfaces may incorporate noise cancellation and acoustic processing to enable reliable speech recognition in processing environments that may have ambient noise from equipment, ventilation systems, or other sources. The voice-based interfaces may be configured with wake words or activation phrases that initiate listening for queries, enabling operators to interact with the system when needed without continuous listening that may result in false activations. The voice-based interfaces may also support speaker identification to associate queries and data submissions with specific operators for audit and accountability purposes.

Augmented reality overlays may display device health information and routing recommendations during physical inspection. Augmented reality interfaces may superimpose digital information onto the operator's view of physical devices, enabling operators to see device data and recommendations while examining the physical device. Augmented reality overlays may be delivered through head-mounted displays, smart glasses, or mobile device cameras that capture the physical environment and render augmented content on the display.

Augmented reality overlays may recognize devices in the operator's field of view using computer vision techniques such as object detection, barcode scanning, or optical character recognition of device identifiers. When a device is recognized, the augmented reality interface may retrieve device data from the consolidated device data repository and render relevant information as overlays positioned relative to the physical device. The overlays may include device health metrics such as the cumulative stress score and estimated remaining life, condition assessments, repair recommendations, and routing decisions.

Augmented reality overlays may highlight specific areas of devices that require attention during inspection. When device data indicates known issues or areas of concern, the augmented reality interface may render visual indicators such as colored outlines, arrows, or icons that direct the operator's attention to the relevant areas of the physical device. For example, if diagnostic data indicates a display issue, the augmented reality overlay may highlight the display area of the device. If cosmetic assessment data indicates damage on a particular surface, the augmented reality overlay may highlight that surface for closer inspection.

Augmented reality overlays may display routing recommendations that guide operators in processing decisions. The overlays may indicate the recommended processing pathway for each device, such as repair, refurbishment, resale, or recycling, along with confidence scores or supporting information that explains the recommendation. Operators may confirm or override the recommendations through gesture controls, voice commands, or physical buttons on the augmented reality device. The augmented reality interface may update the device data repository with the operator's decision and any observations recorded during the inspection.

Augmented reality interfaces may support comparison views that display reference images or specifications alongside the physical device being inspected. Operators may view images of pristine devices of the same model to facilitate identification of cosmetic defects or deviations from expected appearance. Operators may view technical specifications, disassembly diagrams, or repair procedures relevant to the device being inspected. The comparison views may be positioned in the operator's peripheral vision or may be displayed on demand when the operator requests additional reference information.

Dashboard visualizations may provide aggregate insights across device portfolios. Dashboard interfaces may present summary statistics, charts, graphs, and other visual representations of device data aggregated across populations of devices. Dashboard visualizations may enable managers, analysts, and other stakeholders to monitor overall processing performance, identify trends, and make strategic decisions based on portfolio-level insights rather than individual device data.

Dashboard visualizations may include metrics that characterize the current state of device processing operations. The metrics may include counts of devices at each stage of the processing pipeline, average processing times, throughput rates, and capacity utilization. The metrics may include quality indicators such as the distribution of device condition grades, failure rates, and return rates. The metrics may include financial indicators such as average recovery values, repair costs, and margins across different device categories and sales channels.

Dashboard visualizations may include trend charts that display how metrics have changed over time. Trend charts may reveal patterns such as seasonal variations in device intake volumes, gradual changes in the condition distribution of incoming devices, or shifts in market pricing that affect recovery values. Trend charts may enable identification of emerging issues or opportunities that warrant attention or action. The time range displayed in trend charts may be configurable to enable analysis of short-term fluctuations or long-term trends.

Dashboard visualizations may include comparative views that display metrics across different segments or categories. Comparative views may compare performance across different device models, processing facilities, sales channels, or time periods. The comparative views may highlight segments that are performing above or below expectations, enabling focused attention on areas that may benefit from intervention or that may offer opportunities for improvement. Comparative views may be presented as bar charts, heat maps, or tabular displays depending on the nature of the comparison and the preferences of the user.

Dashboard visualizations may include drill-down capabilities that enable users to navigate from aggregate views to more detailed views. Users may select a segment or metric in an aggregate view to display a more detailed breakdown of that segment or metric. The drill-down navigation may continue through multiple levels of detail, enabling users to trace aggregate patterns to their underlying causes at the individual device level. The drill-down capabilities may enable efficient investigation of anomalies or trends identified in aggregate views.

Dashboard visualizations may be configured with filters that enable users to focus on specific subsets of the device portfolio. Filters may select devices based on criteria such as device model, condition grade, processing stage, intake date, or sales channel. The dashboard visualizations may update dynamically as filters are applied, displaying metrics and charts that reflect only the filtered subset of devices. Filter configurations may be saved and shared to enable consistent analysis across users or sessions.

Mobile applications may enable field-based data collection and decision support. Mobile applications may be installed on smartphones or tablets carried by field personnel such as collection agents, repair technicians, or inspection staff who work at locations away from fixed workstations. Mobile applications may provide access to system capabilities in field environments where desktop or web-based interfaces may not be practical.

Mobile applications may enable field-based data collection by providing interfaces for capturing device information, diagnostic results, and condition assessments. Field personnel may use mobile application interfaces to enter device identifiers, capture photographs of device condition, record diagnostic test results, and submit observations about device characteristics. The mobile applications may include form interfaces optimized for mobile input, with features such as barcode scanning, camera integration, and dropdown selections that reduce the need for text entry on mobile keyboards.

Mobile applications may provide decision support by displaying device information and recommendations to field personnel. When a device identifier is entered or scanned, the mobile application may retrieve device data from the consolidated device data repository and display relevant information such as device history, condition assessments, and processing recommendations. Field personnel may use the displayed information to make informed decisions about device acceptance, preliminary routing, or on-site repair actions.

Mobile applications may operate in offline modes when network connectivity is unavailable or unreliable in field environments. In offline mode, mobile applications may store collected data locally on the mobile device and synchronize the data with the central system when network connectivity is restored. Mobile applications may also cache device data and reference information locally to enable lookup and decision support functionality when offline. The offline capabilities may enable field operations to continue without interruption during periods of network unavailability.

Mobile applications may include location services that automatically capture geographic coordinates when data is collected. The location data may be associated with device records to indicate where devices were collected, inspected, or processed. The location data may also be used to provide location-relevant information to field personnel, such as nearby collection points, service facilities, or market conditions specific to the current geographic area.

Mobile applications may provide notifications and alerts to field personnel about devices requiring attention, schedule changes, or other time-sensitive information. Push notifications may be delivered to mobile devices to alert field personnel about new assignments, priority devices, or updates to processing guidelines. The notifications may enable timely response to changing conditions and may improve coordination between field operations and central processing facilities.

Chatbot interfaces may provide conversational access to system capabilities. Chatbot interfaces may enable stakeholders to interact with the system through text-based conversational exchanges, submitting queries and receiving responses in a chat format. Chatbot interfaces may be integrated into messaging platforms, web-based chat widgets, or dedicated chat applications, enabling access through interfaces that stakeholders may already use for other communication purposes.

Chatbot interfaces may interpret natural language queries submitted by users and generate appropriate responses based on device data and system capabilities. The chatbot may employ natural language understanding to identify the intent of user queries and extract relevant parameters such as device identifiers, date ranges, or metric types. The chatbot may retrieve information from the consolidated device data repository, perform requested analyses, and generate natural language responses that convey the results to the user.

Chatbot interfaces may support multi-turn conversations where users may ask follow-up questions, request clarification, or refine their queries based on previous responses. The chatbot may maintain conversation context across multiple exchanges, enabling users to refer to previously mentioned devices, metrics, or topics without restating the full context. Multi-turn conversation support may enable more natural and efficient interactions compared to single-query interfaces that require users to specify complete queries in each exchange.

Chatbot interfaces may provide guided interactions that help users accomplish common tasks through structured conversation flows. When users express intent to perform a task such as looking up device information, generating a report, or submitting a data update, the chatbot may guide the user through the required steps by asking clarifying questions and confirming inputs before executing the requested action. Guided interactions may help users who are unfamiliar with system capabilities to accomplish tasks without requiring detailed knowledge of available features or query syntax.

Chatbot interfaces may support rich message formats that include structured data, images, charts, or interactive elements in addition to text responses. When query results include tabular data, the chatbot may format the data as tables within the chat interface. When results include visual information such as device images or trend charts, the chatbot may embed the visual content in the response. Interactive elements such as buttons or quick reply options may enable users to select from predefined options or trigger follow-up actions without typing additional queries.

Chatbot interfaces may be available through multiple channels to meet users where they already communicate. The chatbot may be accessible through web-based chat widgets embedded in dashboard or portal interfaces. The chatbot may be accessible through integration with enterprise messaging platforms used for internal communication. The chatbot may be accessible through integration with external messaging applications used by partners or customers. The multi-channel availability may enable stakeholders to access system capabilities through their preferred communication channels.

Automated report generation may produce periodic summaries for management review. Automated report generation may compile device data, analytical results, and performance metrics into formatted reports that are generated on scheduled intervals without requiring manual report creation. The automated reports may provide management with regular visibility into processing operations, market conditions, and portfolio performance.

Automated reports may be configured with report templates that define the content, structure, and formatting of generated reports. Report templates may specify which metrics, charts, and data tables to include in the report, how to organize the content into sections, and how to format the output for readability and presentation. Report templates may be created by analysts or administrators and may be customized for different audiences or purposes, such as executive summaries for senior management, detailed operational reports for processing managers, or financial reports for accounting and finance teams.

Automated reports may be generated on configurable schedules such as daily, weekly, monthly, or quarterly intervals. The report generation system may execute report templates at scheduled times, retrieving current data from the consolidated device data repository and populating the report content based on the template specifications. The generated reports may be distributed automatically to designated recipients through email, file sharing systems, or report portals where recipients may access and download reports.

Automated reports may include comparative analysis that highlights changes from previous reporting periods. The reports may display current metrics alongside metrics from the previous period, with calculated changes and percentage differences that indicate whether performance has improved or declined. The comparative analysis may help management identify trends and assess whether operational changes or market conditions are affecting performance in expected or unexpected ways.

Automated reports may include exception highlighting that draws attention to metrics or conditions that fall outside expected ranges. The report generation system may evaluate metrics against configured thresholds and may highlight metrics that exceed upper thresholds or fall below lower thresholds. Exception highlighting may enable management to quickly identify areas requiring attention without reviewing all metrics in detail. The exception thresholds may be configured based on historical performance, targets, or industry benchmarks.

Automated reports may include narrative summaries generated using natural language generation techniques. The narrative summaries may describe the content of the report in natural language prose, highlighting notable findings, explaining trends, and providing context for the presented data. Natural language generation may transform structured data and analytical results into readable text that complements the charts and tables in the report. The narrative summaries may help readers who prefer textual explanations to quickly understand the content of the report.

Automated reports may support parameterized generation that produces multiple report variants from a single template. Parameters may specify filters such as device model, processing facility, or sales channel that determine which subset of data is included in each report variant. Parameterized generation may enable production of facility-specific reports for each processing location, model-specific reports for each device model, or channel-specific reports for each sales channel, all generated from a common template with different parameter values.

Alert and notification systems may proactively communicate critical insights or required actions to stakeholders. Rather than requiring stakeholders to actively query the system or review reports to discover important information, alert and notification systems may push notifications to stakeholders when conditions warrant attention. Proactive notification may enable faster response to emerging issues, time-sensitive opportunities, or conditions requiring immediate action.

Alert and notification systems may monitor device data and analytical outputs for conditions that trigger alerts. Alert triggers may be configured based on threshold conditions, such as when a metric exceeds or falls below a specified value. Alert triggers may be configured based on trend conditions, such as when a metric changes by more than a specified amount over a specified time period. Alert triggers may be configured based on pattern conditions, such as when predictive models identify emerging failure trends or market shifts. The alert monitoring may execute continuously or at scheduled intervals to detect trigger conditions in a timely manner.

Alert and notification systems may deliver notifications through multiple channels to reach stakeholders through their preferred communication methods. Notifications may be delivered through email messages that provide detailed alert information and links to relevant system views. Notifications may be delivered through push notifications to mobile applications that provide immediate alerts on mobile devices. Notifications may be delivered through messaging platform integrations that post alerts to team channels or direct messages. Notifications may be delivered through SMS text messages for urgent alerts that require immediate attention regardless of application or email access.

Alert and notification systems may include escalation logic that routes alerts to different recipients based on alert severity, response time, or acknowledgment status. Initial alerts may be delivered to front-line personnel responsible for routine monitoring and response. If alerts are not acknowledged or resolved within specified time periods, escalation logic may deliver notifications to supervisors or managers. Further escalation may notify senior management or on-call personnel for alerts that remain unresolved or that indicate severe conditions requiring executive attention.

Alert and notification systems may support alert acknowledgment and resolution tracking. When stakeholders receive alerts, they may acknowledge receipt of the alert to indicate that they are aware of the condition and are taking action. The acknowledgment may stop further escalation and may record the acknowledging user and timestamp for audit purposes. When the underlying condition is resolved, stakeholders may mark the alert as resolved, recording the resolution action and outcome. The acknowledgment and resolution tracking may provide visibility into alert response and may enable analysis of alert handling performance.

Alert and notification systems may include alert suppression and aggregation logic to prevent alert fatigue from excessive notifications. Alert suppression may prevent repeated notifications for the same condition within a specified time window, delivering only the initial alert and suppressing subsequent alerts until the condition changes or the suppression window expires. Alert aggregation may combine multiple related alerts into a single notification that summarizes the related conditions, reducing the number of individual notifications while still conveying the relevant information. The suppression and aggregation logic may be configured based on alert types and stakeholder preferences.

Alert and notification systems may provide alert history and analytics that enable review of past alerts and analysis of alert patterns. The alert history may record all generated alerts, including trigger conditions, delivery timestamps, recipients, acknowledgments, and resolutions. Alert analytics may summarize alert volumes, response times, and resolution rates across different alert types, time periods, or organizational units. The alert analytics may identify recurring alert patterns that may indicate systematic issues warranting investigation or alert configuration adjustments that may improve alert effectiveness.

Alert and notification systems may integrate with workflow and task management systems to automatically create tasks or work items when alerts are generated. The integration may create tasks assigned to appropriate personnel with relevant context from the alert, enabling tracking of alert response through established workflow processes. The task integration may ensure that alerts result in documented actions and may provide visibility into the status of alert response through workflow dashboards and reports.

The system may employ various approaches for protecting sensitive device and user data collected and processed throughout the mobile device aftermarket lifecycle. Device data may include telemetry readings, diagnostic results, usage patterns, and location histories that may be associated with individual devices or users. User data may include demographic information, behavioral data, and identifying information that may be subject to privacy regulations or organizational data protection policies. Different privacy and security approaches may address different aspects of data protection, including preventing identification of individual devices or users from aggregated data, enabling collaborative analysis without exposing raw data, protecting data during computation, removing or obscuring identifying information, controlling access based on authorization levels, and maintaining audit trails for compliance verification.

Differential privacy techniques may be employed to add calibrated noise to training data or model outputs to prevent individual device identification. Differential privacy is a mathematical framework for quantifying and limiting the privacy risk associated with data analysis and machine learning. Differential privacy provides formal guarantees that the output of an analysis or model does not reveal whether any particular individual or device was included in the input data, even to an adversary with substantial auxiliary information about the data.

Differential privacy may be achieved by adding carefully calibrated random noise to data or computations. The noise may be calibrated based on the sensitivity of the computation, which measures how much the output can change when a single record is added or removed from the input data. Computations with higher sensitivity may require more noise to achieve a given level of privacy protection, while computations with lower sensitivity may achieve the same privacy level with less noise. The amount of noise added may be controlled by a privacy parameter, commonly denoted epsilon, that quantifies the privacy guarantee. Smaller epsilon values may provide stronger privacy protection but may require more noise that reduces the accuracy or utility of the output.

Differential privacy techniques may be applied to training data used to train machine learning models for device decision-making. When training data includes records for individual devices, differential privacy may prevent the trained model from memorizing or revealing information about specific devices in the training set. Differentially private training algorithms may add noise during the training process, such as by adding noise to gradients computed during stochastic gradient descent. The noise may prevent the model parameters from encoding information that could be used to identify whether a particular device was in the training set or to infer sensitive attributes of devices in the training set.

Differential privacy techniques may also be applied to model outputs to prevent identification of individual devices from query responses. When users query the system for aggregate statistics or predictions about device populations, differential privacy may add noise to the query responses to prevent inference about individual devices. For example, if a user queries the average battery health of devices of a particular model, differential privacy may add noise to the reported average to prevent the user from inferring the battery health of a specific device by comparing query results with and without that device included.

Differential privacy techniques may employ various noise mechanisms depending on the type of computation being protected. The Laplace mechanism may add noise drawn from a Laplace distribution to numerical outputs, with the scale of the noise determined by the sensitivity of the computation and the desired privacy parameter. The Gaussian mechanism may add noise drawn from a Gaussian distribution, which may provide tighter privacy guarantees for certain types of computations. The exponential mechanism may be used for non-numerical outputs by selecting outputs with probability proportional to a quality score, with the selection process providing differential privacy guarantees.

Differential privacy techniques may be configured with privacy budgets that limit the total amount of information that can be revealed about the data through multiple queries or analyses. Each query or analysis may consume a portion of the privacy budget based on the privacy parameter used for that operation. When the privacy budget is exhausted, further queries may be denied or may require additional noise to maintain privacy guarantees. Privacy budget management may enable organizations to balance the utility of data analysis against privacy protection by allocating budget to the analyses that provide the greatest value.

Secure multi-party computation may be employed to enable collaborative model training across organizations without sharing raw data. Secure multi-party computation is a cryptographic technique that enables multiple parties to jointly compute a function over their combined inputs while keeping each party's input private from the other parties. In the context of mobile device aftermarket operations, secure multi-party computation may enable multiple organizations such as processing facilities, repair vendors, or aftermarket channel partners to collaboratively train machine learning models using their combined data without any party revealing their raw data to the other parties.

Secure multi-party computation may enable collaborative model training by distributing the computation of training algorithms across multiple parties. Each party may hold a portion of the training data locally and may participate in a protocol that computes model updates based on the combined data without revealing individual data records. The protocol may involve cryptographic operations such as secret sharing, where data values are split into shares distributed among parties such that no party can reconstruct the original value from their share alone, but the parties can jointly compute functions of the original values by operating on their shares.

Secure multi-party computation protocols may be designed for specific machine learning algorithms or may be general-purpose protocols that can compute arbitrary functions. Protocols designed for specific algorithms may be more efficient by exploiting the structure of the algorithm, while general-purpose protocols may provide flexibility to compute different types of models. The protocols may involve multiple rounds of communication between parties, with each round involving computation on local data and exchange of intermediate results that do not reveal the underlying data.

Secure multi-party computation may enable organizations to benefit from collaborative model training without the legal, regulatory, or competitive concerns associated with sharing raw data. Organizations may be unwilling or unable to share raw device data due to privacy regulations that restrict data transfers, contractual obligations that prohibit data sharing, or competitive concerns about revealing proprietary information. Secure multi-party computation may enable these organizations to participate in collaborative model training while maintaining control over their data and complying with data protection requirements.

Secure multi-party computation may involve tradeoffs between security, efficiency, and functionality. Protocols with stronger security guarantees may require more computation and communication, increasing the time and resources required for collaborative training. Protocols that support more complex computations may be less efficient than protocols designed for simpler operations. Organizations may select secure multi-party computation protocols based on their security requirements, computational resources, and the complexity of the models they wish to train collaboratively.

Homomorphic encryption may be employed to allow computation on encrypted device data. Homomorphic encryption is a form of encryption that enables computation on ciphertext, producing an encrypted result that, when decrypted, matches the result of operations performed on the plaintext. Homomorphic encryption may enable the system to process device data while the data remains encrypted, preventing exposure of the plaintext data even to the systems performing the computation.

Homomorphic encryption may enable privacy-preserving analysis of device data by allowing computations to be performed on encrypted data without decryption. Device data may be encrypted by the data owner using a homomorphic encryption scheme before being transmitted to the system for analysis. The system may perform computations on the encrypted data, such as computing aggregate statistics, evaluating machine learning models, or performing diagnostic analyses. The encrypted results may be returned to the data owner, who may decrypt the results using their private key. Throughout this process, the system performing the computation may not have access to the plaintext device data or the plaintext results.

Homomorphic encryption schemes may support different types of operations on encrypted data. Partially homomorphic encryption schemes may support either addition or multiplication operations on encrypted data, but not both. Somewhat homomorphic encryption schemes may support both addition and multiplication operations, but only for a limited number of operations before the ciphertext becomes too noisy to decrypt correctly. Fully homomorphic encryption schemes may support arbitrary computations on encrypted data by enabling both addition and multiplication operations without limit on the number of operations.

Homomorphic encryption may involve computational overhead compared to operations on plaintext data. Operations on encrypted data may require more computation time and may produce larger ciphertext sizes compared to the corresponding plaintext operations. The computational overhead may vary depending on the homomorphic encryption scheme used and the complexity of the operations being performed. Organizations may evaluate the tradeoff between the privacy benefits of homomorphic encryption and the computational costs when determining whether to employ homomorphic encryption for particular data processing tasks.

Homomorphic encryption may be combined with other privacy-preserving techniques to provide layered protection for sensitive device data. For example, homomorphic encryption may be used in conjunction with secure multi-party computation to enable collaborative computation on encrypted data distributed across multiple parties. Homomorphic encryption may also be used in conjunction with differential privacy to add noise to encrypted computations, providing both cryptographic protection of individual data values and statistical protection against inference from aggregate results.

Data anonymization and pseudonymization techniques may be employed to remove or obscure identifying information while preserving analytical utility. Anonymization and pseudonymization may transform device and user data to reduce the risk of identifying individuals or specific devices while maintaining the ability to perform useful analysis on the transformed data. The selection of anonymization or pseudonymization techniques may depend on the nature of the data, the intended analyses, and the level of privacy protection required.

Data anonymization techniques may remove or generalize identifying information to prevent re-identification of individuals or devices. Direct identifiers such as device serial numbers, IMEI numbers, user names, and contact information may be removed from datasets used for analysis. Quasi-identifiers such as device model, purchase date, and geographic location may be generalized to broader categories that reduce the risk of re-identification through combination with external information. For example, precise geographic coordinates may be generalized to city or region level, and precise timestamps may be generalized to date or week level.

Data anonymization techniques may employ k-anonymity, which ensures that each record in a dataset is indistinguishable from at least k-1 other records with respect to quasi-identifiers. K-anonymity may be achieved through generalization of quasi-identifier values or through suppression of records that cannot be made indistinguishable from sufficient other records. Higher values of k may provide stronger protection against re-identification but may require more generalization that reduces the precision and utility of the data.

Data anonymization techniques may employ l-diversity, which extends k-anonymity by requiring that each group of indistinguishable records contains at least l distinct values for sensitive attributes. L-diversity may protect against attribute disclosure attacks where an adversary infers sensitive information about an individual by observing that all records matching the individual's quasi-identifiers share the same sensitive attribute value. L-diversity may require additional generalization or suppression beyond what is required for k-anonymity alone.

Data anonymization techniques may employ t-closeness, which extends l-diversity by requiring that the distribution of sensitive attribute values within each group of indistinguishable records is close to the distribution in the overall dataset. T-closeness may protect against attacks that exploit skewed distributions of sensitive attributes within groups, where an adversary may infer information about an individual even when the group contains diverse sensitive attribute values.

Data pseudonymization techniques may replace identifying information with pseudonyms that do not directly identify individuals or devices but that enable linking of records belonging to the same individual or device. Pseudonymization may preserve the ability to perform longitudinal analysis that tracks devices or users over time while reducing the risk of identification. Pseudonyms may be generated through cryptographic hash functions, random identifier assignment, or other techniques that produce consistent pseudonyms for the same underlying identifier.

Data pseudonymization may be reversible or irreversible depending on whether a mapping between pseudonyms and original identifiers is maintained. Reversible pseudonymization may maintain a mapping table that enables recovery of original identifiers when authorized, such as for responding to data subject access requests or for linking pseudonymized data with other data sources. Irreversible pseudonymization may destroy the mapping after pseudonym assignment, preventing recovery of original identifiers and providing stronger protection against re-identification.

Data anonymization and pseudonymization techniques may be applied at different stages of data processing. Anonymization or pseudonymization may be applied at data collection to prevent storage of identifying information. Anonymization or pseudonymization may be applied before data sharing to protect identifying information when data is transferred to other parties. Anonymization or pseudonymization may be applied before analysis to enable privacy-preserving analysis of data that was collected with identifying information. The timing of anonymization or pseudonymization may affect the types of analyses that can be performed and the level of privacy protection achieved.

Access control policies may be employed to restrict data visibility based on stakeholder roles and data sensitivity classifications. Access control policies may define which users or systems are authorized to access which data, ensuring that sensitive device and user data is accessible only to parties with legitimate need for access. Access control may be implemented through authentication mechanisms that verify user identity and authorization mechanisms that evaluate access requests against defined policies.

Access control policies may implement role-based access control, where access permissions are assigned to roles and users are assigned to roles based on their job functions or organizational positions. Roles may be defined for different stakeholder types such as repair technicians, warehouse operators, quality assurance personnel, managers, analysts, and administrators. Each role may be granted permissions to access specific data types, perform specific operations, and view specific system features. Users may be assigned to one or more roles, and their effective permissions may be the combination of permissions granted to their assigned roles.

Access control policies may implement attribute-based access control, where access decisions are based on attributes of the user, the resource being accessed, and the context of the access request. User attributes may include role, department, location, and clearance level. Resource attributes may include data type, sensitivity classification, and ownership. Context attributes may include time of access, location of access, and device used for access. Access policies may specify conditions based on combinations of attributes that must be satisfied for access to be granted.

Access control policies may classify data based on sensitivity levels that reflect the privacy implications and protection requirements of different data types. Sensitivity classifications may include categories such as public data that may be freely accessed, internal data that may be accessed by authorized employees, confidential data that may be accessed only by personnel with specific need-to-know, and restricted data that may be accessed only under specific conditions with additional controls. The sensitivity classification of data may determine which roles or attributes are required for access and what additional controls such as logging or approval may be required.

Access control policies may implement the principle of least privilege, which grants users only the minimum permissions required to perform their job functions. Least privilege may reduce the risk of unauthorized access by limiting the data and operations available to each user. Least privilege may also reduce the impact of compromised accounts by limiting the data that can be accessed if an account is compromised. Implementation of least privilege may require careful analysis of job functions and data access requirements to define roles and permissions that are sufficient for legitimate work while minimizing unnecessary access.

Access control policies may implement segregation of duties, which requires that certain sensitive operations be performed by multiple users rather than a single user. Segregation of duties may prevent any single user from having sufficient access to perform unauthorized actions without detection. For example, segregation of duties may require that data exports be approved by a supervisor before execution, or that changes to access control policies be reviewed by a security administrator before taking effect.

Access control policies may be enforced at multiple layers of the system architecture. Application-level access control may evaluate permissions when users interact with system interfaces. Database-level access control may restrict which tables, columns, or rows users can query. Network-level access control may restrict which systems can communicate with data storage systems. Multi-layer enforcement may provide defense in depth, ensuring that access control is maintained even if one layer is bypassed or misconfigured.

Audit logging may be employed to track all data access and model queries for compliance and security monitoring. Audit logging may record information about who accessed what data, when the access occurred, and what operations were performed. The audit logs may provide an evidentiary record that can be used to detect unauthorized access, investigate security incidents, demonstrate compliance with regulations, and support forensic analysis.

Audit logging may record data access events including the identity of the user or system that performed the access, the data resources that were accessed, the type of operation performed such as read, write, or delete, the timestamp of the access, and the outcome of the access such as success or failure. The audit logs may capture sufficient detail to reconstruct the sequence of data access events and to identify patterns of access that may indicate unauthorized activity or policy violations.

Audit logging may record model queries including the identity of the user or system that submitted the query, the model that was queried, the input data provided to the model, the output produced by the model, and the timestamp of the query. Model query logging may enable tracking of how predictive models are being used and may support investigation of model outputs that are questioned or disputed. Model query logging may also support analysis of model usage patterns to identify opportunities for model improvement or to detect anomalous usage that may indicate misuse.

Audit logging may record administrative events including changes to access control policies, user account management operations, system configuration changes, and security-relevant events such as authentication failures or privilege escalations. Administrative event logging may enable detection of unauthorized changes to system security controls and may support investigation of how security incidents occurred.

Audit logs may be protected against tampering to ensure the integrity of the evidentiary record. Protection mechanisms may include write-once storage that prevents modification or deletion of log entries after they are written, cryptographic signing of log entries to detect tampering, and replication of logs to separate systems that would need to be compromised independently to alter the log record. Tamper protection may ensure that audit logs can be relied upon for compliance demonstration and forensic investigation.

Audit logs may be retained for periods specified by regulatory requirements, organizational policies, or contractual obligations. Retention periods may vary based on the type of data or event being logged and the applicable compliance requirements. Log retention policies may specify minimum retention periods during which logs must be preserved and maximum retention periods after which logs must be deleted to comply with data minimization requirements. Log archival mechanisms may move older logs to lower-cost storage while maintaining accessibility for compliance and investigation purposes.

Audit logs may be monitored in real time or near real time to detect security events that require immediate response. Security information and event management systems may collect audit logs from multiple system components, correlate events across sources, and apply detection rules that identify patterns indicative of security threats or policy violations. Alerts may be generated when detection rules are triggered, enabling security personnel to investigate and respond to potential incidents. Real-time monitoring may enable faster detection and response to security events compared to periodic review of historical logs.

Audit logs may be analyzed periodically to identify trends, assess compliance, and support security improvement. Periodic analysis may include review of access patterns to identify users with excessive permissions or unusual access behavior, review of authentication events to identify accounts that may be compromised or misused, and review of administrative events to verify that changes were authorized and appropriate. The periodic analysis may generate reports that document compliance status and identify areas for security improvement.

Audit logging may support compliance with privacy regulations that require organizations to demonstrate accountability for data processing activities. Regulations may require organizations to maintain records of processing activities, to be able to demonstrate that data access was authorized and appropriate, and to provide audit trails that support investigation of data breaches or complaints. Audit logs may provide the evidentiary foundation for demonstrating compliance with these requirements and for responding to regulatory inquiries or audits.

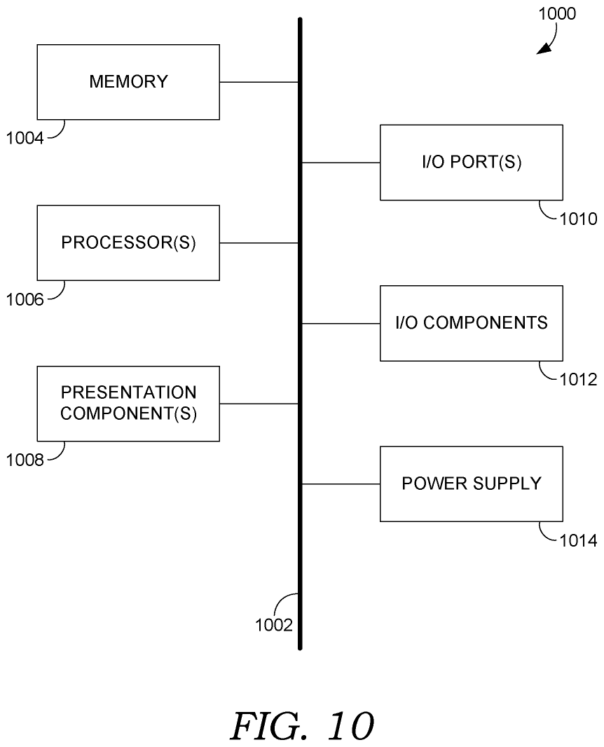

Referring now to FIG. 10, a computing device 1000 suitable for implementing aspects of the technology is illustrated. The computing device 1000 is an example of a computing environment and is not intended to suggest any limitation as to the scope of use or functionality of the technology. The computing device 1000 should not be interpreted as having any dependency or requirement relating to any one or combination of components illustrated. The computing device 1000 may be employed as the server 102, the client device 104, or other computing devices described with reference to the operating environment 100 of FIG. 1.

The technology may be described in the general context of computer code or machine-useable instructions, including computer-executable instructions, such as program modules, being executed by a computer or other machine, such as a cellular telephone, personal data assistant, or other handheld device. Program modules, including routines, programs, objects, components, and data structures, may refer to code that performs particular tasks or implements particular abstract data types. The technology may be practiced in a variety of system configurations, including handheld devices, consumer electronics, general-purpose computers, and specialty computing devices. The technology may also be practiced in distributed computing environments where tasks are performed by remote-processing devices that are linked through a communications network.

With continued reference to FIG. 10, the computing device 1000 includes a bus 1002 that directly or indirectly couples several components together. The bus 1002 may represent one or more buses, such as an address bus, a data bus, or a combination thereof. Although the various blocks of FIG. 10 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The diagram of FIG. 10 is illustrative of an example computing device that can be used in connection with embodiments of the present technology. Distinction is not made between such categories as workstation, server, laptop, or handheld device, as all are contemplated within the scope of FIG. 10 and with reference to the computing device 1000.

The computing device 1000 includes a memory 1004 coupled to the bus 1002. The memory 1004 may include computer storage media in the form of volatile or non-volatile memory. The memory 1004 may be removable, non-removable, or a combination thereof. Example hardware devices that may serve as the memory 1004 include solid-state memory, hard drives, and optical-disc drives. The memory 1004 may store data, computer instructions such as software program instructions, routines, or services, and machine learning models used in embodiments of the described technologies. The memory 1004 may store the training data 116, the device decision model 126, the device passport 612, and other data and models described with reference to the operating environment 100.

The computing device 1000 includes a processor 1006 coupled to the bus 1002. The processor 1006 may read data from various entities, such as the memory 1004 or I/O components. The computing device 1000 may include one or more processors 1006 that execute instructions to perform the methods and operations described herein. The processor 1006 may execute computer-executable instructions stored in the memory 1004 to implement the AI engine 110, the device state determiner 112, the device decision engine 114, the LSTM network 604, the survival analysis model 606, the LLM-driven intelligence layer 904, the LLM agents 908, the cross-modal reasoning engine 910, and other processing components described with reference to the operating environment 100.

At a low level, hardware processors execute instructions selected from a machine language, also referred to as machine code or native instruction set, for a given processor. The processor 1006 may recognize native instructions and perform corresponding low-level functions relating to logic, control, and memory operations. Low-level software written in machine code can provide more complex functionality to higher levels of software. Computer-executable instructions may include any software, including low-level software written in machine code, higher-level software such as application software, and any combination thereof.

The computing device 1000 includes a presentation component 1008 coupled to the bus 1002. The presentation component 1008 may present data indications to a user or other device. Example presentation components include a display device, a speaker, a printing component, and a vibrating component. The presentation component 1008 may display user interfaces through which stakeholders interact with the natural language interrogation interface 906, dashboard visualizations, mobile applications, and other interface modalities described herein. The presentation component 1008 may render visual representations of device data, analytical outputs, and decision recommendations generated by the AI engine 110.

The computing device 1000 includes an I/O port 1010 coupled to the bus 1002. The I/O port 1010 may allow the computing device 1000 to be logically coupled to other devices, including I/O components, some of which may be built-in. The I/O port 1010 may enable communication with external devices such as mobile devices being processed in the aftermarket pipeline, diagnostic equipment at inspection stations, and peripheral devices used for data collection and device interaction.

The computing device 1000 includes an I/O component 1012 coupled to the bus 1002 through the I/O port 1010. Illustrative I/O components include a microphone, joystick, game pad, satellite dish, scanner, printer, and wireless device. The I/O component 1012 may provide a natural user interface that processes air gestures, voice, or other physiological inputs generated by a user. In some cases, inputs may be transmitted to an appropriate network element for further processing. A natural user interface may implement any combination of speech recognition, stylus recognition, facial recognition, biometric recognition, gesture recognition both on screen and adjacent to the screen, air gestures, head and eye tracking, or touch recognition associated with a display of the computing device 1000.

The computing device 1000 may be equipped with depth cameras, such as stereoscopic camera systems, infrared camera systems, RGB camera systems, touchscreen technology, or combinations of these, for gesture detection and recognition. The computing device 1000 may be equipped with accelerometers or gyroscopes that enable detection of motion. The output of the accelerometers or gyroscopes may be provided to the display of the computing device 1000 to render immersive augmented reality or virtual reality. The I/O component 1012 may support the augmented reality overlays and voice-based interfaces described herein for stakeholder interaction with device data and decision support capabilities.

The computing device 1000 includes a power supply 1014 coupled to the bus 1002. The power supply 1014 may supply power to the computing device 1000 or components thereof. The power supply 1014 may include batteries, power adapters, or other power delivery mechanisms suitable for the form factor and deployment environment of the computing device 1000. For mobile implementations of the computing device 1000, such as tablets or smartphones used by field personnel, the power supply 1014 may include rechargeable batteries that enable portable operation.

The computing device 1000 may include a variety of computer-readable media. Computer-readable media can be any available media that can be accessed by the computing device 1000 and includes both volatile and non-volatile media, and removable and non-removable media. By way of example and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data.

Computer storage media includes, but is not limited to, RAM (random access memory), ROM (read-only memory), EEPROM (electronically erasable programmable read-only memory), flash memory, or other memory technology. Computer storage media may also include CD-ROM (compact disc read-only memory), digital versatile disks (DVDs), or other optical disk storage. Computer storage media may further include magnetic cassettes, magnetic tape, magnetic disk storage, or other magnetic storage devices. Computer storage media may include any other medium that can be used to store the desired information and that can be accessed by the computing device 1000. Computer storage media does not comprise signals per se.

Communication media may embody computer-readable instructions, data structures, program modules, or other data in a modulated data signal, such as a carrier wave or other transport mechanism, and includes any information delivery media. The term modulated data signal means a signal that has one or more of its characteristics set or changed in such a manner as to encode information in the signal. By way of example and not limitation, communication media includes wired media, such as a wired network or direct-wired connection, and wireless media, such as acoustic, radio frequency, infrared, and other wireless media. Combinations of any of the above should also be included within the scope of computer-readable media.

The computing device 1000 may communicate with other computing devices via the network 108 using communication media. The computing device 1000 may transmit and receive data, instructions, and model parameters through network interfaces that connect to the bus 1002. The network interfaces may support wired connections such as Ethernet or fiber optic connections, or wireless connections such as Wi-Fi, cellular, or satellite connections. The computing device 1000 may communicate with the database 106 to store and retrieve the training data 116, the device decision model 126, the device passport 612, and data stored in the consolidated device data repository 902.

The components of the computing device 1000 may interact to perform the methods and operations described herein. The processor 1006 may execute instructions stored in the memory 1004 to implement the device state determiner 112 and the device decision engine 114. The processor 1006 may process input data received through the I/O component 1012 or through network interfaces, apply the device decision model 126 to generate predictions or classifications, and output results through the presentation component 1008 or through network interfaces for transmission to other computing devices. The bus 1002 may facilitate data transfer between the processor 1006, the memory 1004, the I/O port 1010, and other components during execution of the methods 200, 300, 400, 500, 700, and 800 described with reference to FIGS. 2 through 8.

The computing device 1000 may be configured to perform the functions of the server 102 in server deployments, where the computing device 1000 hosts the AI engine 110 and provides services to remote client devices via the network 108. The computing device 1000 may be configured to perform the functions of the client device 104 in client deployments, where the computing device 1000 provides user interfaces for stakeholder interaction and communicates with server-based services for data processing and decision support. The computing device 1000 may also be configured for edge deployments where lightweight models execute locally on the computing device 1000 to provide low-latency inference for device processing operations.

The various components of the system may interact in coordinated workflows to perform comprehensive mobile device lifecycle management. The interaction between data collection mechanisms, model training pipelines, inference engines, and decision output systems may enable end-to-end processing of mobile devices from initial intake through final disposition. The following description explains how the system components work together to achieve intelligent device routing, valuation, and lifecycle optimization.

Data collection may serve as the foundation for all subsequent processing and decision-making operations. Remote data collecting agents installed on mobile devices may continuously monitor device subsystems and transmit telemetry data to centralized storage systems via network connections. The telemetry data may include processing subsystem metrics, display subsystem characteristics, power management readings, communication subsystem performance indicators, and sensor subsystem outputs. The remote data collection may occur throughout the operational lifetime of a device, accumulating historical records that characterize device usage patterns and degradation trajectories.

Physical access data collection may complement remote data collection when devices enter processing facilities for aftermarket handling. Upon physical connection to diagnostic equipment, devices may yield low-level hardware diagnostics, storage access data, debugging logs, and proprietary device information that is not accessible through remote monitoring. The physical access data collection may provide deeper insight into device condition than remote telemetry alone, enabling more accurate assessment of devices that have experienced hardware faults, physical damage, or other conditions that affect internal components.

Downstream data collection may aggregate information from various contact points throughout the aftermarket device lifecycle. Application programming interfaces may receive data submissions from secondary market platforms, repair vendors, warranty and insurance providers, disposal facilities, trade-in programs, and other downstream partners. The downstream data may include sales records, condition reports, repair histories, claim data, and inspection results that characterize device condition and market performance at different stages of the lifecycle. The downstream data collection may enable the system to learn from outcomes observed across the aftermarket ecosystem, improving predictions about device value, repair success, and failure likelihood.

The collected data may flow into training data repositories where the data is organized, labeled, and prepared for model training. The training data preparation may involve associating device records with end-state decision labels that indicate the outcomes observed for those devices. For repair or dispose decision models, the labels may indicate whether devices were ultimately repaired and returned to service or disposed through recycling, resale, or other channels. For insurance decision models, the labels may indicate whether devices were approved for insurance coverage and the subsequent claim outcomes. The labeling process may be performed manually by human reviewers who examine device records and assign appropriate labels, or may be performed through automated processes that derive labels from observed outcomes recorded in downstream data.

Model training may consume the labeled training data to generate trained device decision models capable of predicting outcomes for new devices. The training process may employ supervised learning techniques where models learn to map input device features to output decision labels by minimizing prediction error on the labeled training data. The training may involve iterative optimization of model parameters through gradient descent or other optimization algorithms, with the model progressively improving its ability to predict correct labels for training examples. The trained models may be validated on held-out data that was not used during training to assess generalization performance and detect overfitting.

The trained device decision models may be deployed for inference operations where new device data is processed to generate predictions and decisions. When a device enters the processing pipeline, device data may be collected through remote monitoring, physical access diagnostics, or a combination of collection methods. The collected device data may be formatted as input features and provided to the trained device decision model. The model may process the input features through its learned architecture to generate output predictions indicating recommended decisions such as repair, dispose, or insure.

The inference outputs may be consumed by decision engines that translate model predictions into actionable instructions. The decision engines may evaluate model outputs in conjunction with business rules, threshold criteria, and contextual factors to determine appropriate actions for each device. The decision engines may generate instructions that specify processing pathways, repair actions, disposal channels, or insurance determinations based on the model predictions and applicable decision logic. The instructions may be communicated to client devices or downstream systems that execute the specified actions.

The device passport system may interact with the data collection and inference components to maintain persistent health records for individual devices. As telemetry data is collected from a device over its operational lifetime, the telemetry may be processed through time-series analysis models that compute cumulative stress scores and estimated remaining life predictions. The computed health metrics may be stored in device passport records linked to device identifiers, creating persistent health certificates that accompany devices through the aftermarket lifecycle. The device passport records may be updated as new telemetry data becomes available, maintaining current assessments that reflect the most recent device condition.

The device passport information may inform downstream decision-making by providing health metrics that characterize device longevity and reliability. When devices are evaluated for routing, valuation, or insurance decisions, the device passport data may be retrieved and incorporated into the decision inputs. Devices with favorable health metrics such as low cumulative stress scores and long estimated remaining life may be routed to channels that command premium prices for high-quality devices. Devices with unfavorable health metrics may be routed to channels appropriate for devices with limited remaining useful life, or may be flagged for component harvesting or recycling.

The skip-logic predictive routing system may interact with the intake and diagnostic components to optimize processing efficiency. Upon device intake, initial telemetry extraction may provide data that is processed through probabilistic classifiers to assess fault likelihood. The classifiers may generate predictions about whether devices have faults requiring repair, along with uncertainty scores that characterize prediction confidence. Devices with high-confidence predictions of no faults may be routed through bypass pathways that skip manual testing and proceed directly to data wiping and shipping. Devices with lower-confidence predictions or predicted faults may be routed through standard processing pipelines that include comprehensive testing and repair stages.

The skip-logic routing may reduce processing time and costs by identifying devices that do not require full diagnostic workups. The routing decisions may be informed by the uncertainty quantification provided by Bayesian neural network classifiers, ensuring that bypass routing is applied only to devices where the no-fault prediction is sufficiently confident. The interaction between the probabilistic classifiers and the routing logic may balance processing efficiency against quality assurance by adapting the processing pathway based on the reliability of automated predictions for each individual device.

The dynamic channel selection system may interact with market data feeds and reinforcement learning agents to optimize exit channel decisions. Market price data may be received from direct-to-consumer and wholesale platforms, providing current information about pricing conditions across available sales channels. Reinforcement learning agents may continuously monitor the market data to track price trends and identify favorable selling conditions. Price forecasting models may generate predictions of future prices across channels, enabling the system to anticipate market movements when making channel selection decisions.

The channel selection process may evaluate multiple factors including forecasted prices, expected time to sale, depreciation rates, and carrying costs. The evaluation may balance the higher margins available through direct-to-consumer channels against the faster sales and lower depreciation risk offered by wholesale channels. Deep Q-network models may learn effective channel selection strategies from experience, identifying patterns in device characteristics and market conditions that predict favorable outcomes in different channels. The selected channels may be communicated to downstream systems that execute the routing decisions, directing devices to the channels expected to maximize net recovery value.

The LLM intelligence layer may interact with the consolidated device data repository to provide natural language access and autonomous action capabilities. The consolidated data repository may aggregate device data from all collection sources, providing a unified data foundation for intelligence operations. The LLM-driven intelligence layer may process natural language queries submitted through the interrogation interface, interpreting query intent and retrieving relevant information from the repository. The query results may be formatted as natural language responses that convey insights to stakeholders in accessible form.

The LLM agents may monitor device data and analytical outputs to identify conditions that warrant autonomous action. When predictive models identify trends such as elevated failure rates for specific device batches, the LLM agents may initiate autonomous workflows that respond to the identified trends. The autonomous actions may include updating pricing models to account for anticipated repair costs, drafting purchase orders for replacement components, and adjusting device passport templates to highlight relevant health metrics. The LLM agents may coordinate with other system components through application programming interfaces that enable the agents to read data, invoke services, and update records across the system.

The cross-modal reasoning capabilities of the LLM intelligence layer may enable integrated analysis across different data types. Diagnostic logs containing structured telemetry data may be analyzed in conjunction with device photographs containing visual evidence of cosmetic condition. The multimodal analysis may correlate functional issues indicated in diagnostic data with physical damage visible in images, producing unified assessments that integrate multiple perspectives on device condition. The cross-modal reasoning may support more comprehensive device evaluation than analysis of individual data modalities in isolation.

The cosmetic enhancement modeling may interact with image analysis and value prediction components to identify value-add opportunities. Convolutional neural networks may process device images to detect surface defects such as micro-abrasions and scratches. The detected defects may be evaluated to predict whether cosmetic restoration services would successfully improve device appearance and grade. When the cosmetic enhancement model predicts favorable outcomes from restoration, the system may trigger value-add workflows that route devices to buffing and polishing services before final disposition.

The value-add workflow triggering may be informed by economic analysis that compares expected value improvement against restoration costs. The expected value improvement may be computed based on price differentials between device grades and the predicted probability of achieving grade improvement through restoration. The cost analysis may incorporate labor costs, materials costs, and time costs associated with the restoration process. The workflow may be triggered when the expected net benefit exceeds threshold criteria, ensuring that restoration services are applied to devices where the economic return justifies the investment.

The various system components may share data and coordinate actions through integration mechanisms that enable information flow across the system. Device identifiers may serve as keys that link records across different data stores and processing stages, enabling retrieval of all information associated with a particular device. Application programming interfaces may enable components to invoke services provided by other components, such as requesting model inference, retrieving device passport data, or submitting data updates. Message queues may enable asynchronous communication between components, allowing data producers to submit information without waiting for consumers to process the data immediately.

The integration mechanisms may support both real-time and batch processing workflows depending on the requirements of different operations. Real-time processing may be employed for operations that require immediate response, such as generating routing decisions for devices at intake stations or responding to natural language queries from stakeholders. Batch processing may be employed for operations that can tolerate latency, such as model training on accumulated data, periodic report generation, or bulk updates to device passport records. The system may coordinate real-time and batch workflows to maintain current decision-making capabilities while efficiently processing large volumes of historical data.

The system integration may enable feedback loops that improve system performance over time. Outcomes observed for devices that have been processed through the system may be recorded and used to update training data for model retraining. Devices that were routed based on model predictions may be tracked through their subsequent lifecycle stages, with actual outcomes compared against predicted outcomes. Discrepancies between predictions and outcomes may inform model refinement, threshold adjustment, or identification of factors that were not adequately captured in the original models. The feedback loops may enable continuous improvement of prediction accuracy and decision quality as the system accumulates experience with diverse device populations and market conditions.

The system integration may also enable coordination across organizational boundaries when multiple parties participate in the aftermarket ecosystem. Federated learning mechanisms may enable collaborative model training across organizations without requiring raw data sharing. Secure multi-party computation may enable joint analysis of data held by different parties while maintaining data privacy. Blockchain-based data sharing may provide tamper-evident records of device history that can be verified by multiple parties. The cross-organizational integration may enable ecosystem-wide optimization that leverages data and insights from across the aftermarket value chain.

The interaction between system components may be configured and customized based on organizational requirements, regulatory constraints, and operational priorities. Configuration parameters may control threshold values for routing decisions, confidence requirements for automated actions, and authorization levels for different types of operations. The configuration may be adjusted over time based on operational experience, changing market conditions, or evolving organizational priorities. The configurability may enable the system to adapt to different deployment contexts while maintaining the core capabilities for intelligent device lifecycle management.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As further used herein, the term “train,” when referring to training a machine learning model, may mean training an untrained model, further training a previously trained model, fine-tuning a pre-trained model, or the like. “Train” is intended to broadly cover methods of machine learning using a dataset.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

1. A system for processing mobile device telemetry data, the system comprising:
a processor; and
a memory storing instructions that, when executed by the processor, cause the processor to:
receive device telemetry data collected over a lifecycle of a mobile device;
process the device telemetry data using a time-series analysis model configured to perform time-series telemetry analysis to generate a cumulative stress score representing an aggregated measure of device wear;
process the device telemetry data using a survival analysis model to generate an estimated remaining life prediction indicating a probability of hardware failure over time; and
store the cumulative stress score and the estimated remaining life prediction in a device passport data structure linked to a device identifier of the mobile device.

2. The system of claim 1, wherein the device identifier comprises an International Mobile Equipment Identity (IMEI) identifier.

3. The system of claim 1, wherein the device telemetry data comprises one or more of flash storage wear-leveling data, thermal cycle data, or battery impedance history.

4. The system of claim 1, wherein the time-series analysis model comprises a Long Short-Term Memory (LSTM) network, and wherein the survival analysis model implements Cox Proportional Hazards modeling.

5. The system of claim 1, wherein the instructions further cause the processor to:
process device photographs of the mobile device using a convolutional neural network (CNN) configured to detect surface defects comprising micro-abrasions and scratches; and
generate a cosmetic condition assessment based on the detected surface defects.

6. The system of claim 5, wherein the CNN is configured to predict a probability that cosmetic restoration will elevate a device grade classification from a first grade to a second grade higher than the first grade.

7. The system of claim 1, wherein the device telemetry data is received from a remote data collecting agent stored in local memory of the mobile device.

8. A computer-implemented method for predictive routing of mobile devices, the method comprising:
extracting, upon intake of a mobile device, initial telemetry data from the mobile device, the initial telemetry data comprising low-level telemetry including kernel panic logs and voltage fluctuation data;
applying a probabilistic classifier to the initial telemetry data, the probabilistic classifier configured to generate uncertainty scores for fault predictions;
determining, based on the uncertainty scores, whether the mobile device has a high confidence classification of no fault found;
responsive to determining that the mobile device has the high confidence classification of no fault found, routing the mobile device to a bypass processing pathway that bypasses a standard testing pipeline; and
responsive to determining that the mobile device does not have the high confidence classification of no fault found, routing the mobile device to the standard testing pipeline comprising triage, testing, and repair stages.

9. The method of claim 8, wherein the bypass processing pathway comprises a data wipe operation followed by a shipping operation, bypassing manual testing operations.

10. The method of claim 8, wherein determining whether the mobile device has the high confidence classification comprises comparing the uncertainty scores against a confidence threshold.

11. The method of claim 8, wherein the probabilistic classifier comprises a Bayesian Neural Network that generates the uncertainty scores by performing multiple forward passes with different weight samples to estimate prediction variance.

12. The method of claim 8, wherein the initial telemetry data further comprises chipset-level input/output registry data from device subsystem boards.

13. The method of claim 8, further comprising:
processing the initial telemetry data using an LSTM network to generate a cumulative stress score; and
storing the cumulative stress score in a device passport data structure associated with the mobile device.

14. The method of claim 8, wherein the standard testing pipeline comprises sequential stages of triaging the mobile device, wiping data from the mobile device, testing the mobile device, and repairing the mobile device.

15. A computer-implemented method for multi-modal device data analysis, the method comprising:
receiving multi-modal device data for a mobile device, the multi-modal device data comprising structured telemetry data, diagnostic logs, and device photographs;
processing the multi-modal device data using an LLM-driven intelligence layer comprising a cross-modal reasoning engine;
correlating, using a multimodal large language model of the cross-modal reasoning engine, the diagnostic logs with the device photographs to identify relationships between functional issues indicated in the diagnostic logs and physical conditions visible in the device photographs; and
generating a unified device condition assessment based on the correlating.

16. The method of claim 15, further comprising:
receiving a natural language query through a natural language interrogation interface; and
retrieving, based on the natural language query, a subset of device data from a consolidated device data repository.

17. The method of claim 15, wherein the LLM-driven intelligence layer comprises LLM agents implementing a ReAct framework configured to perform autonomous actions based on data insights derived from the multi-modal device data.

18. The method of claim 17, wherein the autonomous actions comprise one or more of updating a predictive model based on an identified trend in device failure data, generating a component procurement request based on predicted component failure rates, or modifying a device passport data structure template to adjust presentation of device health metrics for a subset of devices associated with the identified trend.

19. The method of claim 15, further comprising:
applying a Gradient Boosted Decision Trees model to device characteristic data and historical outcome data to generate device disposition forecasts for a plurality of downstream processing pathways; and
applying a Deep Q-Network to the device disposition forecasts to generate a processing pathway classification for the mobile device.

20. The method of claim 15, further comprising:
processing the device photographs using a convolutional neural network to detect cosmetic defects; and
generating a cosmetic condition score based on the detected cosmetic defects.
